(19) United States
(12) Patent Application Publication
(10) Pub. No.: US 2017/0373789 A1
(43) Pub. Date: Dec. 28, 2017

(54) COMMUNICATION MODE SELECTION

(71) Applicant: QUALCOMM Incorporated, San Diego, CA (US)

(72) Inventors: Xiaolong HUANG, San Diego, CA (US); Hao ZHU, Milpitas, CA (US); Srinivas KATAR, Fremont, CA (US); Naveen GANGADHARAN, San Diego, CA (US); Madhan JAGANATHAN, Cupertino, CA (US); Nathaniel David HOUGHTON, San Jose, CA (US); Sabita NAHATA, Newark, CA (US); Raja BANERJEA, San Jose, CA (US); Alireza RAISSINIA, Monte Sereno, CA (US); James CHO, Mountain View, CA (US); Chao CHENG, Santa Clara, CA (US)

(21) Appl. No.: 15/594,430

(22) Filed: May 12, 2017

Related U.S. Application Data
(60) Provisional application No. 62/356,293, filed on Jun. 29, 2016.
(60) Provisional application No. 62/355,045, filed on Jun. 27, 2016.
(60) Provisional application No. 62/355,652, filed on Jun. 28, 2016.

(51) Int. Cl. H04L 1/00; H04B 7/06; H04B 1/38; H04L 27/26; H04B 7/0452

(52) U.S. Cl. CPC H04L 1/0003; H04B 7/0632; H04B 1/38; H04B 7/0452; H04L 27/2601

(57) ABSTRACT

A device includes a memory, a processor, and a transceiver. The memory is configured to store capability data corresponding to a set of stations. The processor is configured to select, based at least in part on the capability data, one of a multi-user multiple-input multiple-output (MU-MIMO) mode or an orthogonal frequency-division multiple access (OFDMA) mode for wireless communication with a subset of the set of stations. The transceiver is configured to wirelessly communicate with the subset in the selected one of the MU-MIMO mode or the OFDMA mode.

### I. CROSS-REFERENCE TO RELATED APPLICATIONS

The present application claims priority from U.S. Provisional Patent Application No. 62/356,293 entitled “COMMUNICATION MODE SELECTION,” filed Jun. 29, 2016, U.S. Provisional Patent Application No. 62/355,045 entitled “RESOURCE UNIT ALLOCATION,” filed Jun. 27, 2016, and U.S. Provisional Patent Application No. 62/355,652 entitled “ORTHOGONAL FREQUENCY-DIVISION MULTIPLE ACCESS (OFDMA) GROUPING,” filed Jun. 28, 2016, the contents of each of which are incorporated by reference herein in their entirety.

### II. FIELD

The present disclosure is generally related to communication mode selection.

### III. DESCRIPTION OF RELATED ART

Advances in technology have resulted in smaller and more powerful computing devices. For example, there are a variety of portable personal computing devices, including wireless computing devices, such as portable wireless telephones, personal digital assistants (PDAs), tablet computers, and paging devices that are small, lightweight, and easily carried by users. Many such computing devices include other devices that are incorporated therein. For example, a wireless telephone can also include a digital still camera, a digital video camera, a digital recorder, and an audio file player. Also, such computing devices can process executable instructions, including software applications, such as a web browser application that can be used to access the Internet and multimedia applications that utilize a still or video camera and provide multimedia playback functionality.

Electronic devices, such as wireless telephones, may use wireless connections to access networks in order to transmit and receive data or to exchange information. An electronic device may access networks via an access point. The access point may be configured to communicate with a plurality of electronic devices (e.g., “stations”) using one or more communication modes. A first communication mode may have lower latency and lower communication overhead as compared to a second communication mode, while the second communication mode may have a higher data rate. Selecting the first communication mode to exchange large amounts of data or selecting the second communication mode to exchange small amounts of data may result in communication inefficiencies. In addition, although some stations may be limited to communicating using the first communication mode or communicating using the second communication mode, some stations may support both communication modes. Selecting the first communication mode or the second communication mode without considering the communication abilities of the stations may result in a failure to communicate with some of the stations.

### IV. SUMMARY

In a particular aspect, a device includes a memory, a processor, and a transceiver. The memory is configured to store capability data corresponding to a set of stations. The processor is configured to select, based at least in part on the capability data, one of a multi-user multiple-input multiple-output (MU-MIMO) mode or an orthogonal frequency-division multiple access (OFDMA) mode for wireless communication with a subset of the set of stations. The transceiver is configured to wirelessly communicate with the subset in the selected mode.

In another particular aspect, a method of communication includes determining, at a device, a set of stations. The method also includes determining, at the device, capability data corresponding to the set of stations. The method further includes selecting, based at least in part on the capability data, one of a multi-user multiple-input multiple-output (MU-MIMO) mode or an orthogonal frequency-division multiple access (OFDMA) mode for wireless communication with a subset of the set of stations. The method also includes wirelessly communicating with the subset in the selected mode.

In another particular aspect, a computer-readable storage device stores instructions that, when executed by a processor, cause the processor to perform operations including determining a set of stations. The operations also include determining capability data corresponding to the set of stations. The operations further include selecting, based at least in part on the capability data, one of a multi-user multiple-input multiple-output (MU-MIMO) mode or an orthogonal frequency-division multiple access (OFDMA) mode for wireless communication with a subset of the set of stations. The method also includes wirelessly communicating with the subset in the selected mode.

In another particular aspect, a device includes a receiver and a transmitter. The receiver is configured to receive a mode identifier from a second device. The mode identifier indicates one of a multi-user multiple-input multiple-output (MU-MIMO) mode or an orthogonal frequency-division multiple access (OFDMA) mode. The transmitter is configured to transmit data to the second device in the one of the MU-MIMO mode or the OFDMA mode in response to receipt the mode identifier.

In another particular aspect, a method of communication includes receiving, at a device, a mode identifier from a second device. The method also includes selecting, at the device, one of a multi-user multiple-input multiple-output (MU-MIMO) mode or an orthogonal frequency-division multiple access (OFDMA) mode in response to determining that the mode identifier indicates the one of the MU-MIMO mode or the OFDMA mode. The method further includes, in response to selecting the one of the MU-MIMO mode or the OFDMA mode, transmitting data from the device to the second device in the one of the MU-MIMO mode or the OFDMA mode.

In another particular aspect, a computer-readable storage device stores instructions that, when executed by a processor, cause the processor to perform operations including receiving a mode identifier from a device. The operations also include selecting one of a multi-user multiple-input multiple-output (MU-MIMO) mode or an orthogonal frequency-division multiple access (OFDMA) mode in response to determining that the mode identifier indicates the one of the MU-MIMO mode or the OFDMA mode. The operations further include, in response to selecting the one of the MU-MIMO mode or the OFDMA mode, transmitting data to the device in the one of the MU-MIMO mode or the OFDMA mode.

In another particular aspect, a method of allocating resources includes receiving, at a device, channel quality indicators (CQIs) from a plurality of stations. The CQIs include a CQI of a station of the plurality of stations. The CQI indicates a plurality of channel quality values associated with a plurality of resource units (RUs). For example, the CQI indicates a first channel quality value associated with a first RU of the plurality of RUs and a second channel quality value associated with a second RU of the plurality of RUs. The method also includes allocating, at the device, a RU of the plurality of RUs to the station based at least in part on a channel quality variation across the plurality of RUs. The channel quality variation is based at least in part on the first channel quality value and the second channel quality value.

In another particular aspect, a computer-readable storage device stores instructions that, when executed by a processor, cause the processor to perform operations including receiving channel quality indicators (CQIs) from a plurality of stations. The CQIs include a CQI of a station of the plurality of stations. The CQI indicates a plurality of channel quality values associated with a plurality of resource units (RUs). For example, the CQI indicates a first channel quality value associated with a first resource unit (RU) of the plurality of RUs and a second channel quality value associated with a second RU of the plurality of RUs. The operations also include allocating a RU of the plurality of RUs to the station based at least in part on a channel quality variation across the plurality of RUs. The channel quality variation is based at least in part on the first channel quality value and the second channel quality value.

In another particular aspect, a method of grouping stations includes grouping one or more stations of a set of candidate stations into an orthogonal frequency-division multiple access (OFDMA) station group based on data rate gains that different power spectrum density boosts provide for each station of the set of candidate stations using different resource unit (RU) sizes, a power imbalance tolerance of an access point, and a power imbalance of the set of candidate stations. The method further includes generating an OFDMA trigger frame to transmit to each station of the OFDMA station group.

In another particular aspect, a device includes a memory configured to store data indicative of a power imbalance threshold based on a power imbalance tolerance of an access point and configured to store data indicative of a power imbalance of a set of candidate stations. The device further includes a processor configured to group one or more stations of the set of candidate stations into an OFDMA station group based on data rate gains that different power spectrum density boosts provide for each station of the set of candidate stations using different resource unit (RU) sizes, the power imbalance threshold, and the power imbalance of the set of candidate stations.

In another particular aspect, a computer-readable storage device stores instructions that, when executed, cause a processor to perform operations. The operations include grouping one or more stations of a set of candidate stations into an OFDMA station group based on data rate gains that different power spectrum density boosts provide for each station of the set of candidate stations using different resource unit (RU) sizes, a power imbalance tolerance of an access point, and a power imbalance of the set of candidate stations. The operations further include generating an OFDMA trigger frame to transmit to each station of the OFDMA station group.

In another particular aspect, an apparatus includes means for storing data configured to store data indicative of a power imbalance threshold based on a power imbalance tolerance of an access point and configured to store data indicative of a power imbalance of a set of candidate stations. The apparatus further includes means for grouping one or more stations of the set of candidate stations into an orthogonal frequency-division multiple access (OFDMA) station group based on data rate gains that different power spectrum density boosts provide for each station of the set of candidate stations using different resource unit (RU) sizes, the power imbalance threshold, and the power imbalance of the set of candidate stations.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of a particular illustrative aspect of a system including a device operable to select a communication mode;

FIG. 2 is a diagram of a particular illustrative aspect of a method of operation of the device of FIG. 1;

FIG. 3 is a flowchart to illustrate an aspect of a method of communication mode selection;

FIG. 4 is a flowchart to illustrate an aspect of a method of communication mode selection;

FIG. 5 is a flowchart to illustrate an aspect of a method of communication mode selection;

FIG. 6 is a flowchart to illustrate an aspect of a method of communication mode selection; and

FIG. 7 is a block diagram of a particular illustrative aspect of a system operable to allocate resource units;

FIG. 8 is a diagram of a particular illustrative aspect of an access point of FIG. 1;

FIG. 9 is a diagram of a particular illustrative aspect of an access point of FIG. 1;

FIG. 10 is a flowchart to illustrate an aspect of a method of resource unit allocation;

FIG. 11 is a flowchart to illustrate an aspect of a method of resource unit allocation;

FIG. 12 is a flowchart to illustrate an aspect of a method of resource unit allocation;

FIG. 13 is a flowchart to illustrate an aspect of a method of resource unit allocation;

FIG. 14 is a block diagram of a particular illustrative aspect of a system operable to group stations into an OFDMA station group;

FIG. 15 is a flowchart to illustrate an aspect of a method of grouping stations into an OFDMA station group using a first technique or a second technique;

FIG. 16 is a flowchart to illustrate aspects of a first technique of grouping stations into an OFDMA station group;

FIG. 17 is a flowchart to illustrate aspects of a first technique of grouping stations into an OFDMA station group;

FIG. 18 is a flowchart to illustrate aspects of a first technique of grouping stations into an OFDMA station group;

FIG. 19 is a flowchart to illustrate aspects of a second technique of grouping stations into an OFDMA station group;

FIG. 20 is a flowchart to illustrate aspects of a method of communication; and

FIG. 21 is a block diagram of a device operable to perform communication mode selection in accordance with the systems and methods of FIGS. 1-20.

### VI. DETAILED DESCRIPTION

According to the techniques described herein, a device such as an access point may have access to capability data corresponding to a set of wireless communication devices (“stations”). The capability data may indicate a communication mode supported by a station, a modulation and coding scheme (MCS) supported by the station, a payload size of data to be exchanged with the station, or a combination thereof. The access point may select a communication mode based on the capability data. For example, the access point determines a plurality of candidate groups of the set of stations based on the capability data. Each of the plurality of candidate groups may correspond to a communication mode. A communication mode corresponding to a candidate group may be suitable for communicating with stations of the candidate group. For example, a first candidate group corresponds to a group of stations that is suited for communication in an orthogonal frequency-division multiple access (OFDMA) mode, a second candidate group corresponds to a group of stations that is suited for communication in a first multi-user multiple-input multiple-output (MU-MIMO) mode, and a third candidate group corresponds to a group of stations that is suited for communication in a second MU-MIMO mode.

The access point may determine whether to include individual stations into each of the candidate groups based on whether the station is suited for communication in a corresponding communication mode. The station may be included in one or more candidate groups. The access point may determine whether a station is suited for communication in a communication mode based on a capability of the station to operate in the communication mode, a payload size of data buffered for communication with the station, a MCS level associated with the station, or a combination thereof. For example, the access point includes the station in the first candidate group (corresponding to the OFDMA mode) in response to determining that the station is capable of operating in the OFDMA mode, and that the payload size is less than a threshold payload size or that the MCS is less than a MCS threshold. An improvement in data rate resulting from exchanging the payload in the MU-MIMO mode may be limited by the payload size. A lower than threshold payload size may indicate that the improvement in data rate may be insufficient to compensate for communication overhead associated with MU-MIMO communication. The MCS may indicate a particular data rate (e.g., a maximum data rate) at which the station is available to communicate. A station that is available to communicate at a low data rate (e.g., corresponding to a MCS that is lower than the threshold MCS) may be unable to take advantage of the improvement in data rate corresponding to MU-MIMO communication. The access point may thus determine that the station is suited for OFDMA communication in response to determining that the payload size is lower than the threshold payload size or that the MCS is lower than the threshold MCS.

The access point may, in response to determining that the station is capable of operating in a MU-MIMO mode, that the payload size is greater than or equal to the threshold payload size, and that the MCS is greater than or equal to the MCS threshold, include the station in one or more MU-MIMO candidate groups. For example, the capability data indicates a MU-MIMO level associated with the station and the access point selects one or more MU-MIMO candidate groups for the station based on the MU-MIMO level.

Inclusion of a station in a candidate group may indicate that the station supports a corresponding communication mode and that a payload size of data buffered for exchange with the station is suited for communication in the selected communication mode. The candidate groups may thus identify stations that are suited for communication in corresponding communication modes.

During a scheduling phase, the access point may select the candidate group that includes the most stations, the highest priority stations, or based on other selection criteria. The access point may select a communication mode associated with the selected candidate group. The access point may notify stations of the selected candidate group of the selected communication mode and initiate data exchange. The access point may thus use a communication mode that is suited for communicating the buffered data with the stations of the selected candidate group.

In a particular example, the selected communication mode corresponds to an OFDMA communication mode. The access point may allocate a first resource unit (RU) to exchange data with a first station. In a particular aspect, a RU corresponds to frequency subcarriers of the OFDMA wireless channel. The first station may detect a first channel quality (e.g., signal strength) associated with the first RU and a second channel quality associated with a second RU. Allocating a lower channel quality RU to a station when a higher channel quality RU is available may reduce performance. For example, the first station experiences a higher error rate associated with receiving data via the first RU as compared to the second RU if the first RU has a lower channel quality than the second RU.

In a particular aspect, a device (e.g., the access point) includes a memory and a processor. The memory is configured to store channel quality indicators (CQIs) of a plurality of stations. The CQIs include a CQI of a station. The CQI indicates a plurality of channel quality values associated with a plurality of resource units (RUs). For example, the CQI indicates a first channel quality value associated with a first resource unit (RU) of the plurality of RUs and a second channel quality value associated with a second RU of the plurality of RUs. A channel quality value may indicate a channel quality (e.g., signal strength) detected by the station. The processor is configured to allocate a RU of the plurality of RUs to the station based at least in part on a channel quality variation across the plurality of RUs. The channel quality variation is based at least in part on the first channel quality value and the second channel quality value. For example, the first channel quality value is a lowest channel quality value of the plurality of channel quality values, the second channel quality value is a highest channel quality value of the plurality of channel quality values, and the channel quality variation includes a difference between the first channel quality value and the second channel quality value. As another example, the channel quality variation includes a standard deviation of the plurality of channel quality values.

A channel quality gain corresponding to a RU allocation may include a difference between a channel quality value associated with the RU and an average channel quality variation associated with the plurality of channel quality values. A lower channel quality variation (e.g., less than or equal to a variation threshold) may indicate that channel quality values are substantially similar across the plurality of RUs. Allocation of any of the plurality of RUs to the station may result in substantially similar channel quality gains at the station. A higher channel quality variation (e.g., greater than the variation threshold) may indicate that allocation of some RUs to the station may result in higher channel quality gains than allocation of other RUs to the station.

The processor may, during a RU allocation phase of operation, allocate RUs to stations based on channel quality gains in response to determining that the channel quality variation is greater than or equal to a variation threshold. For example, the processor determines candidate allocations of one or more RUs to the plurality of stations. The candidate allocations may include a candidate allocation of the first RU to the station. The processor may determine channel quality gains corresponding to the candidate allocations. The processor may allocate the first RU to the station in response to determining that the first RU corresponds to a channel quality gain that is highest among the channel quality gains. The processor may iteratively allocate one or more of the remaining RUs to the remaining stations based on channel quality gains. The RU allocation phase of operation may be prior to or during an initial portion of a transmit opportunity (TXOP).

Alternatively, the processor may, in response to determining that the channel quality variation is less than the variation threshold, allocate a RU to the station based on determining that a channel quality value of the RU received from the station is greater than a threshold channel quality. The processor may allocate the RU independently of determining channel quality gains associated with candidate allocations. The processor may iteratively allocate one or more of the remaining RUs to the remaining stations based on channel quality values. The processor may thus perform RU allocation to increase channel gain while channel variation is high across the RUs or to reduce resource (e.g., time, processing cycles, or both) utilization associated with determining channel quality gains while channel variation is low across the RUs.

Operation of the access point during uplink communication with a group of stations may be subject to various constraints. To illustrate, when an access point receives uplink data simultaneously from multiple stations, the access point may not be able to decode uplink data from one or more of the stations if there is a large power disparity between the stations.

The present disclosure presents various heuristics (e.g., algorithms) for grouping stations into a group (e.g., an OFDMA station group) for uplink (UL) transmissions. Institute of Electrical and Electronics Engineers (IEEE) 802.11ax, also known as the “High Efficiency WLAN,” is an in-progress industry standard that is expected to use OFDMA for multi-user operation, including in indoor and outdoor scenarios that are impacted by interfering signal sources, dense heterogeneous networks, and heavily loaded access points. Thus, in some examples, the described techniques are used in an IEEE 802.11ax wireless network.

The algorithms may be employed by an access point to group one or more stations of a set of candidate stations into an OFDMA station group based on a power imbalance tolerance of the access point and based on a power imbalance of the set of candidate stations. One advantage of using OFDMA for uplink transmission is the ability to apply uplink power boosting. According to uplink power boosting, each station in an uplink OFDMA group can focus its transmit power on a narrow frequency band to boost the signal-to-interference-plus-noise ratio (SINR) of its packet reception at the access point. However, arbitrarily boosting each station's uplink signal by allocating small frequency bands to the station may not be possible. For example, if a station has a large and/or delay-sensitive payload (e.g., video, voice, or interactive traffic), then allocating a small frequency band to the station results in the station being unable to serve its uplink payload in a timely fashion. As another example, the boosted power spectrum density (PSD) from each station results in an overall receive power imbalance that is outside of tolerance bounds of the access point.

Particular implementations of the present disclosure are described below with reference to the drawings. In the description, common features are designated by common reference numbers throughout the drawings. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term).

As used herein, various terminology is for the purpose of describing particular implementations only and is not intended to be limiting of implementations. For example, the singular forms “a,” “an,” and “the” are intended to include the plural forms as well, unless the context clearly indicates otherwise. It may be further understood that the terms “comprises” and “comprising” may be used interchangeably with “includes” or “including.” Additionally, it will be understood that the term “wherein” may be used interchangeably with “where.”

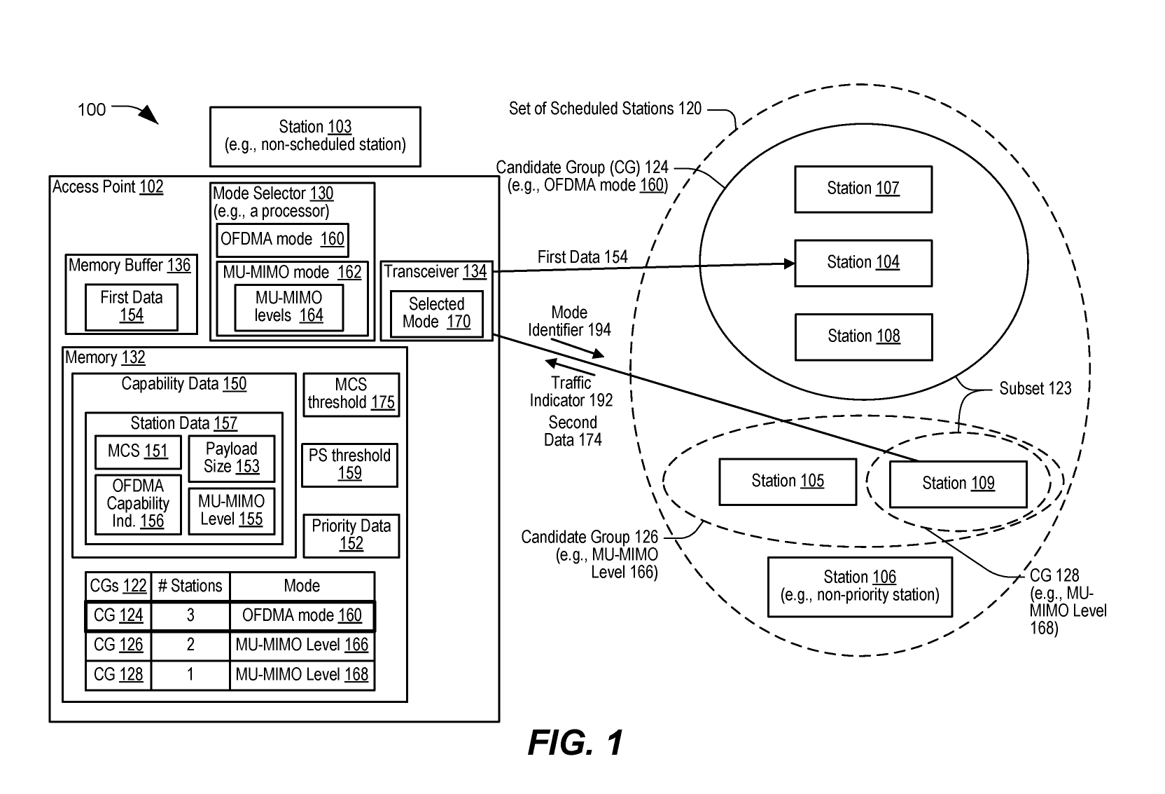

Referring to FIG. 1, a particular illustrative aspect of a system is disclosed and generally designated 100. The system 100 includes a plurality of devices configured to communicate with each other. For example, the system 100 includes an access point 102, a station 103, a station 104, a station 105, a station 106, a station 107, a station 108, a station 109, or a combination thereof. One or more of the stations 103-109 may be installed within, or roam within, a coverage area of the access point 102, and one or more of the stations 103-109 may enter or leave the coverage area of the access point 102 at various times. The access point 102 is configured to select a communication mode that is suitable for (e.g., a greatest number of) the stations 103-109 and to wirelessly communicate (e.g., exchange data) with at least one of the stations 103-109 using the communication mode, as described herein.

Each of the stations 103-109 may include an electronic device that may be used for voice and/or data communication over a wireless communication network. One or more of the stations 103-109 may include a communication device, such as a cellular phone, a personal digital assistant (PDA), a handheld device, a headset, a wireless modem, a laptop computer, a personal computer, etc. At least one of the stations 103-109 may be compatible with one or more mobile telecommunication technologies. For example, at least one of the stations 103-109 is compatible with third generation (3G) mobile telecommunication technologies, fourth generation (4G) mobile telecommunication technologies, and/or fifth generation (5G) mobile telecommunication technologies. Additionally, or in the alternative, at least one of the stations 103-109 may be compatible with different communication specifications (e.g., a Long-Term Evolution (LTE) wireless communication specification, a LTE-advanced (LTE-A) wireless communication specification, a Worldwide Interoperability for Microwave Access (WiMAX) wireless communication specification, an Enhanced Voice Services (EVS) specification, an Adaptive Multi-Rate Wideband (AMR-WB) specification, a LTE-direct (LTE-D) wireless communication specification, etc.).

The access point 102 (e.g., an electronic device) may provide access to one or more services (e.g., network connectivity) to the stations 103-109. The access point 102 may enable the stations 103-109 to wireless communicate (e.g., exchange data) with one or more networks, with each other, or a combination thereof. The access point 102 may be configured to concurrently receive data from a plurality of stations, to concurrently transmit data to a plurality of stations, or both. The access point 102 may be configured to communicate in an orthogonal frequency-division multiple access (OFDMA) mode 160 and in a multi-user multiple-input multiple-output (MU-MIMO) mode 162. The access point 102 may be configured to communicate in one or more of MU-MIMO levels 164 of the MU-MIMO mode 162. For example, a MU-MIMO level 166 (e.g., MU-MIMO level 2) corresponds to concurrent communication in the MU-MIMO mode 162 with a first number of stations (e.g., 2 stations), and a MU-MIMO level 168 (e.g., MU-MIMO level 3) corresponds to concurrent communication in the MU-MIMO mode 162 with a second number of station (e.g., 3 stations).

The access point 102 may include a mode selector 130 (e.g., a processor), a memory 132, a transceiver 134, and a memory buffer 136. The mode selector 130 may be configured to select one of the OFDMA mode 160 or the MU-MIMO mode 162 as a selected mode 170 for communication with one or more of the stations 103-109 based on capability data 150 associated with at least one of the stations 103-109, as described herein. For example, the mode selector 130 selects the OFDMA mode 160 as the selected mode 170 during a scheduling phase in response to determining that at least one (e.g., a greatest number) of the stations 103-109 is suited to communicate in the OFDMA mode 160. As another example, the selected mode 170 corresponds to the MU-MIMO level 166, the MU-MIMO level 168, or another MU-MIMO level of the MU-MIMO levels 164. To illustrate, the mode selector 130 selects the MU-MIMO level 166 as the selected mode 170 during the scheduling phase in response to determining that at least one (e.g., a greatest number) of the stations 103-109 is suited to communicate in the MU-MIMO level 166 of the MU-MIMO mode 162

The transceiver 134 is configured to enable communication with the stations 103-109. The transceiver 134 may be configurable to communicate with the stations 103-109 according to the selected mode 170. For example, the transceiver 134 receives an indication of the selected mode 170 from the mode selector 130. The transceiver 134 may be configured, in response to receiving the indication of the selected mode 170, to concurrently exchange (e.g., transmit or receive) data in the selected mode 170 with a plurality of the stations 103-109.

The memory buffer 136 is configured to store data (e.g., packet data) that is available to transmit to one or more of the stations 103-109. For example, the memory buffer 136 is configured to store first data 154 that is available to transmit to the station 104.

The memory 132 may be coupled to the mode selector 130. The memory 132 may be configured to store the capability data 150. For example, the capability data 150 includes station data indicating a MCS, a MU-MIMO level, an OFDMA capability, a payload size, or a combination thereof, associated with one or more of the station 103-109. To illustrate, the capability data 150 includes station data 157 associated with the station 109, and the station data 157 includes a MCS 151, a MU-MIMO level 155, a payload size 153, an OFDMA capability indicator 156, or a combination thereof. Similarly, the capability data 150 may include station data associated with one or more of the stations 103-108.

The memory 132 may include a MCS threshold 175, a payload size threshold (PS threshold) 159, or both. The MCS threshold 175, the PS threshold 159, or both, may correspond to default values, values determined via user input, or both. The MCS threshold 175, the PS threshold 159, or both, may be accessible by the mode selector 130 for determination of whether to include a station in the candidate group 124 associated with the OFDMA mode 160 or in at least one of the candidate groups associated with the MU-MIMO mode 162, as described herein.

The memory 132 may include priority data 152. The priority data 152 may indicate a priority associated with at least one of the stations 103-109. For example, the priority data 152 indicates that the station 106 is associated with a first priority and that each of the stations 104-105 and 107-109 is associated with a second priority that is higher than the first priority.

During operation, the mode selector 130 may compile at least a portion of the capability data 150 based on information received from the stations 103-109. For example, the access point 102 receives a message from the station 109 indicating that the station 109 supports the MU-MIMO level 155, that the station 109 is OFDMA capable, that the station 109 is associated with the MCS 151, that the station 109 has data (e.g., second data 174) available to transmit to the access point 102 (e.g., the transceiver 134), that the second data 174 corresponds to the payload size 153, or a combination thereof. The mode selector 130 may update the station data 157 to indicate the MU-MIMO level 155 in response to receiving a message indicating that the station 109 supports the MU-MIMO level 155. The mode selector 130 may update the station data 157 to indicate the MCS 151 in response to receiving a message indicating that the MCS 151 is associated with the station 109. The mode selector 130 may update the station data 157 to include the OFDMA capability indicator 156 in response to receiving a message indicating that the station 109 supports OFDMA.

The mode selector 130 may also update the station data 157 to indicate the payload size 153. The mode selector 130 may determine a payload size associated with a station based on data buffered for communication with the station. For example, the mode selector 130 receives a traffic indicator 192 from the station 109 indicating availability of uplink data (e.g., the second data 174) to be sent from the station 109 to the access point 102 (e.g., the transceiver 134). The traffic indicator 192 may indicate a size of the second data 174. The mode selector 130 may determine the payload size 153 based on the size of the second data 174. In a particular aspect, the mode selector 130 determines a payload size associated with a station based on a size of downlink data included in the memory buffer 136 to transmit to the station. For example, the mode selector 130 determines a payload size associated with the station 104 based on a size of the first data 154 stored in the memory buffer 136 to transmit to the station 104.

In a particular aspect, the mode selector 130 determines a priority associated with a station based on a quality of service (QoS) level associated with the station. For example, the mode selector 130 determines that the station 106 is associated with the first priority based on determining that data buffered for communication with the station 106 is associated with a first QoS level (e.g., a background access category or a best effort access category). The mode selector 130 may determine that the station 104 is associated with the second priority in response to determining that the first data 154 is associated with a second QoS level (e.g., a voice access category or a video access category). The mode selector 130 may determine that the station 109 is associated with the second priority in response to determining that the second data 174 is associated with the second QoS level (e.g., the voice access category or the video access category). Similarly, the mode selector 130 may determine that each of the stations 105 and 107-108 is associated with the second priority. The mode selector 130 may update (or generate) the priority data 152 to indicate that the station 106 is associated with the first priority and that each of stations 104-105 and 107-109 is associated with the second priority. It should be understood that two priority levels are described for ease of illustration. In other aspects, the stations 104-109 are associated with any number of priority levels, such as a single priority level or more than two priority levels.

During a scheduling phase of operation, the mode selector 130 may determine a set of scheduled stations 120 for which data is buffered for communication. For example, the mode selector 130 determines that the station 104 is included in the set of scheduled stations 120 in response to determining that the memory buffer 136 includes the first data 154 to transmit to the station 104. The mode selector 130 may determine that the set of scheduled stations 120 includes the station 109 in response to determining that the station 109 has data (e.g., the second data 174) to transmit to the access point 102 (e.g., the transceiver 134). For example, the station 109 transmits the traffic indicator 192, via a transceiver, to the access point 102. The traffic indicator 192 may indicate availability of data (e.g., the second data 174) at the station 109 to transmit to the access point 102, the transceiver 134, or both. The mode selector 130 may, in response to receipt of the traffic indicator 192, determine that the station 109 has data (e.g., the second data 174) to transmit to the access point 102, the transceiver 134, or both. Similarly, the mode selector 130 may determine that the set of scheduled stations 120 includes each of the stations 105-108 in response to determining that the memory buffer 136 includes data to be sent to the station, that the station has data to be sent to the access point 102, or both.

The mode selector 130 may determine that the station 103 is not included in the set of scheduled stations 120 in response to determining that that there is no data to be sent from the access point 102 to the station 103 and that there is no data to be sent from the station 103 to the access point 102. The mode selector 130 may determine that there is no data to be sent from the access point 102 to the station 103 in response to determining that there is no data in the memory buffer 136 to transmit to the station 103. The mode selector 130 may determine that there is no data to be sent from the station 103 to the access point 102 in response to determining that no traffic indicator has been received from the station 103 during a time interval, that a traffic indicator has been received from the station 103 that indicates that there is no data available at the station 103 to transmit to the access point 102, or both.

The mode selector 130 may determine priority stations of the set of scheduled stations 120 based on the priority data 152. Determining priority stations based on the priority data 152 may include determining that each of the priority stations is associated with a higher priority. For example, the mode selector 130 determines that the stations 104-105 and 107-109 are priority stations in response to determining that each of the stations 104-105 and 107-109 is associated with a higher priority (e.g., the second priority). The mode selector 130 may determine that the station 106 is not included in the priority stations in response to determining that the station 106 is associated with a lower priority (e.g., the first priority).

In a particular aspect, the stations 104-109 are associated with a single priority. For example, the priority data 152 indicates that the stations 104-109 are associated with the same priority (e.g., no priority). As another example, the mode selector 130 does not have access to the priority data 152 or disregards the priority data 152 based on a configuration setting. In this aspect, the mode selector 130 identifies each of the stations 104-109 as priority stations.

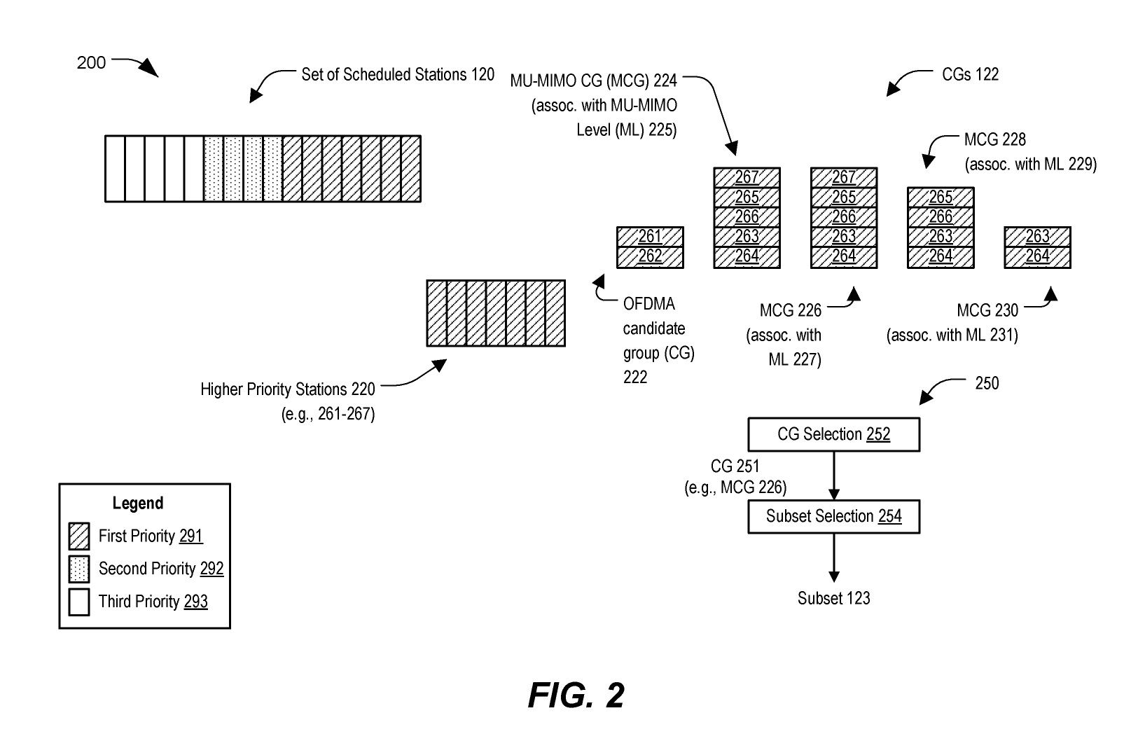

The mode selector 130 may determine the CGs 122 of the priority stations based on the capability data 150, as further described with reference to FIG. 2. For example, the mode selector 130 determines a candidate group (CG) 124 of OFDMA suitable stations and a set of MU-MIMO suitable stations based on the capability data 150. In a particular aspect, the CG 124 and the set of MU-MIMO suitable stations are mutually exclusive. For example, a station that is included in the CG 124 is not included in the set of MU-MIMO suitable stations, while a station that is included in the set of MU-MIMO suitable stations is not included in the CG 124.

The mode selector 130 may determine whether the station 104 is suitable for OFDMA communication. For example, the mode selector 130 determines whether the station 104 is OFDMA capable based on a first OFDMA capability indicator associated with the station 104. The mode selector 130 may, in response to determining that the first OFDMA capability indicator indicates that the station 104 is OFDMA capable, determine whether a first MCS fails to satisfy (e.g., is less than) the MCS threshold 175 or that a first payload size fails to satisfy (e.g., is less than) the PS threshold 159. The first MCS and the first payload size may be associated with the station 104. The mode selector 130 may determine that the station 104 is suitable for OFDMA communication in response to determining that the first MCS fails to satisfy the MCS threshold 175 or that the first payload size fails to satisfy the PS threshold 159. The mode selector 130 may select the station 104 to include in the CG 124 in response to determining that the station 104 is suitable for OFDMA communication. Similarly, the mode selector 130 may select each of the station 107 and the station 108 to include in the CG 124 based on determining that the station 107 and the station 108 are suitable for OFDMA communication. A station that is suitable for OFDMA communication may be suitable for communication in the OFDMA mode 160.

The mode selector 130 may determine whether the station 109 is suitable for MU-MIMO communication. For example, the mode selector 130 determines whether to the station 109 is MU-MIMO capable based on the MU-MIMO level 155. To illustrate, the mode selector 130 determines that the station 109 is MU-MIMO capable in response to determining that the station data 157 indicates that the station 109 supports at least one MU-MIMO level (e.g., the MU-MIMO level 155). The mode selector 130 may, in response to determining that the station 109 is MU-MIMO capable, determine whether the payload size 153 satisfies (e.g., is greater than or equal to) the PS threshold 159 and that the MCS 151 satisfies (e.g., is greater than or equal to) the MCS threshold 175. The mode selector 130 may, in response to determining that the payload size 153 satisfies the PS threshold 159 and that the MCS 151 satisfies the MCS threshold 175, determine that the station 109 is suitable for MU-MIMO communication. The mode selector 130 may select the station 105 to include in the set of MU-MIMO suitable stations in response to determining that the station 109 is suitable for MU-MIMO communication. Similarly, the mode selector 130 may select to include the station 105 in the set of MU-MIMO suitable stations in response to determining that the station 109 is suitable for MU-MIMO communication. A station that is suitable for MU-MIMO communication may be suitable for communication in the MU-MIMO mode 162.

The mode selector 130 may determine one or more CGs of the set of MU-MIMO suitable stations based on the capability data 150. The one or more CGs may include a CG 126 of stations suitable for communication in the MU-MIMO level 166, a CG 128 of stations suitable for communication in the MU-MIMO level 168, and so on. As used herein, a “MU-MIMO candidate group” includes a CG of stations suitable for MU-MIMO communication. The mode selector 130 may select the station 105 to include in the CG 126 (associated with the MU-MIMO level 166) in response to determining that a first MU-MIMO level (e.g., MU-MIMO level 2) is equal to the MU-MIMO level 166 (e.g., MU-MIMO level 2) associated with the CG 126. Similarly, the mode selector 130 may select the station 109 to include in the CG 128 in response to determining that the MU-MIMO level 155 (e.g., MU-MIMO level 3) associated with the station 109 is equal to the MU-MIMO level 168 (e.g., MU-MIMO level 3) associated with the CG 128.

In a particular aspect, a station that is configured to support a first MU-MIMO level is also configured to support one or more MU-MIMO levels that are lower than the first MU-MIMO level. In this aspect, a first MU-MIMO CG overlaps a second MU-MIMO CG. For example, a station included in a first CG corresponding to a first MU-MIMO level is also included in one or more CGs corresponding to MU-MIMO levels that are lower than the first MU-MIMO level. To illustrate, the mode selector 130 may select the station 109 to include in the CG 126 in response to determining that the MU-MIMO level 166 (e.g., MU-MIMO level 2) associated with the CG 126 is less than the MU-MIMO level 155 (e.g., MU-MIMO level 3) associated with the station 109.

The mode selector 130 may determine a count of stations of each of the CGs 122. For example, the mode selector 130 determines that the CG 124 (associated with the OFDMA mode 160) includes a first number of stations (e.g., 3 stations), that the CG 126 (associated with the MU-MIMO level 166) includes a second number of stations (e.g., 2 stations), that the CG 128 (associated with the MU-MIMO level 168) includes a third number of stations (e.g., 1 station), or a combination thereof.

The mode selector 130 may identify one or more valid MU-MIMO CGs of the CGs 122. The mode selector 130 may determine whether a MU-MIMO CG is valid or invalid based on a count of stations of the MU-MIMO CG and a MU-MIMO level associated with the MU-MIMO CG. For example, the mode selector 130 determines that the CG 128 is invalid in response to determining that the third number of stations (e.g., 1 station) fails to satisfy (e.g., is less than) a threshold number of stations (e.g., 3) associated with the MU-MIMO level 168 (e.g., MU-MIMO level 3). The mode selector 130 may thus identify a MU-MIMO CG that includes too few stations to communicate in the corresponding MU-MIMO level. As another example, the mode selector 130 determines that the CG 126 is invalid in response to determining that the second number of stations (e.g., 2 stations) satisfies (e.g., is greater than or equal to) a threshold number of stations (e.g., 2) associated with the MU-MIMO level 166 (e.g., MU-MIMO level 2). The mode selector 130 may thus identify a MU-MIMO CG that includes at least a threshold number of stations to communicate in the corresponding MU-MIMO level.

The mode selector 130 may select a candidate group from the CG 124 and valid MU-MIMO CGs that includes the most stations. For example, the mode selector 130 selects the CG 124 in response to determining that the first number of stations (e.g., 3 stations) of the CG 124 is higher than the second number of stations (e.g., 2 stations) of the CG 126. In a particular aspect, multiple CGs of the CG 124 and the valid MU-MIMO CGs have a highest number of stations. The mode selector 130 may select a MU-MIMO CG corresponding to a highest MU-MIMO level from the multiple CGs. The mode selector 130 may determine the selected mode 170 corresponding to the selected CG. For example, the mode selector 130, in response to determining that the CG 124 is selected, determines that the selected mode 170 is the OFDMA mode 160 corresponding to the CG 124. In an alternate aspect, the mode selector 130, in response to determining that the CG 126 is selected, determines that the selected mode 170 is the MU-MIMO mode 162, the MU-MIMO level 166, or both.

The mode selector 130 may include stations of the selected CG include in a subset 123 for communication in the selected mode 170. For example, the mode selector 130, in response to determining that the CG 124 is selected, includes the station 104, the station 107, and the station 108 of the CG 124 in the subset 123. In a particular aspect, the mode selector 130, in response to determining that the selected CG is a MU-MIMO CG, determines that the subset 123 is the same as the selected CG. A MU-MIMO CG may refer to a CG associated with the MU-MIMO mode 162 (e.g., a MU-MIMO level of the MU-MIMO levels 164). Alternatively, the mode selector 130 may, in response to determining that the selected CG is an OFDMA CG and that the transceiver 134 is capable of exchanging traffic in the OFDMA mode 160 with a higher count of stations than a count of stations of the selected CG, include at least one additional station of one or more MU-MIMO candidate groups (e.g., the MU-MIMO CGs) in the subset 123. For example, the mode selector 130, in response to determining that the selected CG is the CG 124 and that the transceiver 134 is capable of exchanging traffic in the OFDMA mode 160 with a higher count of station than the first number of stations (e.g., 3 stations), selects the station 109 of the CG 128 to include in the subset 123. An OFDMA CG (e.g., the CG 124) may be associated with the OFDMA mode 160. The mode selector 130 may determine a count of stations with which the transceiver 134 is capable of exchanging traffic in the OFDMA mode 160 based on default data, a user input, a configuration setting, or a combination thereof. The subset 123 may correspond to a proper subset of the set of scheduled stations 120 or may include the entire set of scheduled stations 120. For example, the subset 123 includes all or fewer than all stations of the set of scheduled stations 120.

In a particular aspect, the mode selector 130 selects the at least one additional station from a MU-MIMO CG corresponding to a particular MU-MIMO level (e.g., a highest MU-MIMO level or a lowest MU-MIMO level), a MU-MIMO CG including a particular number of stations (e.g., a highest number of stations or a lowest number of stations), or a combination thereof. Including the at least one additional station in the subset 123 for communication in the OFDMA mode 160 may reduce a communication latency associated with the at least one additional station as compared to delaying communication with the at least one additional station until the MU-MIMO mode 162 is selected.

The mode selector 130 may transmit, via the transceiver 134, a mode identifier 194 to one or more stations of the subset 123. For example, the mode selector 130 transmits to each of the stations of the subset 123. In an alternate aspect, the mode selector 130 transmits the mode identifier 194 to a station in response to determining that a traffic indicator has been received from the station during a threshold time interval. For example, the mode selector 130 transmits the mode identifier 194 to the station 109 in response to determining, at a first time, that the traffic indicator 192 has been received from the station 109 within a threshold time interval (e.g., 10 minutes) of the first time. The mode selector 130 may refrain from transmitting the mode identifier 194 to the station 104 in response to determining, at a second time, that no traffic indicator has been received from the station 104 within the threshold time interval of the second time. The mode identifier 194 may indicate the selected mode 170. In a particular aspect, the scheduling phase corresponds to a traffic indication window. The mode selector 130 may transmit a traffic indicator during the traffic indication window. The traffic indicator may include the mode identifier 194 that indicates that the access point is available to exchange data with the station 104 using the selected mode 170.

During a data communication phase, the mode selector 130 may exchange data, via the transceiver 134, with stations of the subset 123 in the selected mode 170. In a particular aspect, the data communication phase corresponds to a data window that is subsequent to the traffic indication window. During the data communication phase, the transceiver 134 may transmit the first data 154 to the station 104 in the selected mode 170. The station 109 may transition to one of the OFDMA mode 160 or the MU-MIMO mode 162 in response to receiving the mode identifier 194 and determining that the mode identifier 194 indicates the selected mode 170. For example, the station 109 selects the OFDMA mode 160 in response to determining that the mode identifier 194 indicates that the selected mode 170 corresponds to the OFDMA mode 160. As another example, the station 109 selects the MU-MIMO mode 162, the MU-MIMO level 166, or both, in response to determining that the mode identifier 194 indicates that the selected mode 170 corresponds to the MU-MIMO level 166, the MU-MIMO mode 162, or both. The station 109 may transmit, via a transceiver of the station 109, the second data 174 to the access point 102 in the selected mode 170, such as the OFDMA mode 160 or the MU-MIMO mode 162 (e.g., the MU-MIMO level 166). The mode selector 130 may receive, via the transceiver 134, the second data 174 in the selected mode 170. The access point 102 may thus use a communication mode (e.g., the selected mode 170) that is supported by stations of the CG 124 and that is suited to exchange data buffered for communication with the stations of the CG 124.

For illustration purposes, various aspects of the disclosure are described in the context of one or more stations and the access point 102. It should be appreciated that the operations described herein may be performed by other types of devices or other similar devices that are referred to using other terminology. For example, in various implementations, an access point is referred to or implemented as a base station, NodeB, eNodeB, a small cell, a femto cell, and so on, while a station is referred to as an access terminal, user equipment, a mobile station, and so on. As another example, one or more of the operations described herein are performed by peer-to-peer devices.

Referring to FIG. 2, a diagram is shown and generally designated 200. The diagram 200 illustrates a method 250. The method 250 may be performed by the mode selector 130, the access point 102, the system 100 of FIG. 1, or a combination thereof.

The method 250 includes candidate group selection, at 252. For example, the mode selector 130 of FIG. 1 selects a CG 251. In a particular aspect, the CG 251 corresponds to the CG 124 of FIG. 1. In another aspect, the CG 251 corresponds to a MU-MIMO CG (MCG) 226, as described herein.

The method 250 also includes subset selection, at 254. For example, the mode selector 130 of FIG. 1 selects the subset 123. In a particular aspect, the subset 123 corresponds to the CG 124 and the station 109, as described with reference to FIG. 1. In an alternate aspect, the subset 123 corresponds to the MCG 226, as described herein.

The diagram 200 illustrates an example of a selection of a MCG by the mode selector 130. The set of scheduled stations 120 may include stations having one or more priorities. For example, a first subset of the set of scheduled stations 120 is associated with a first priority 291, a second subset of the set of scheduled stations 120 is associated with a second priority 292, a third subset of the set of scheduled stations 120 is associated with a third priority 293, and so on. The mode selector 130 may determine a priority of a station based on a priority (e.g., access category) associated with data to be communicated with the station, as described with reference to FIG. 1. It should be understood that three priorities are shown for illustration. In another aspect, the set of scheduled stations 120 includes fewer than or more than three priority subsets.

The mode selector 130 may select higher priority stations 220 of the set of scheduled stations 120. For example, the mode selector 130 selects the first subset as the higher priority stations 220 in response to determining that the first priority 291 is higher than the second priority 292 and the third priority 293. The higher priority stations 220 may include stations 261-267.

The mode selector 130 may determine the CGs 122 of the higher priority stations 220. For example, the mode selector 130 selects one or more of the higher priority stations 220 to include in an OFDMA CG 222 as suitable for communication in the OFDMA mode 160. To illustrate, the mode selector 130 selects the stations 261-262 to include in the OFDMA CG 222 in response to determining that the stations 261-262 are suitable for OFDMA communication, as described with reference to FIG. 1.

The mode selector 130 may select one or more of the higher priority stations 220 to include in at least one MCG as suitable for communication in the MU-MIMO mode 162. For example, the mode selector 130 selects the stations 263-267 to include in the at least one MCG in response to determining that the stations 261-267 are suitable for MU-MIMO communication, as described with reference to FIG. 1. The mode selector 130 may select a station of the stations 263 to include in a MCG in response to determining that a ML associated with the station is greater than or equal to a ML associated with the MCG. For example, the mode selector 130 selects the stations 263-264 to include in a MCG 224 (associated with a ML 225), a MCG 226 (associated with a ML 227), a MCG 228 (associated with a ML 229), a MCG 230 (associated with a ML 231), or a combination thereof, in response to determining that each of the stations 263-264 is associated with the ML 231 and that each of the ML 225, the ML 227, and the ML 229 is less than the ML 231. The mode selector 130 may select the stations 265-266 to include in the MCG 224 (associated with the ML 225), the MCG 226 (associated with the ML 227), the MCG 228 (associated with the ML 229), or a combination thereof, in response to determining that each of the stations 265-266 is associated with the ML 229 and that each of the ML 225 and the ML 227 is less than the ML 229. The mode selector 130 may select the station 267 to include in the MCG 224 (associated with the ML 225), the MCG 226 (associated with the ML 227), or both, in response to determining that the station 267 is associated with the ML 227 and that the ML 225 is less than the ML 227.

The ML 225 may be associated with concurrent communication with a first number of stations (e.g., 2 stations). The ML 227 may be associated with concurrent communication with a second number of stations (e.g., 3 stations). The ML 229 may be associated with concurrent communication with a third number of stations (e.g., 4 stations). The ML 231 may be associated with concurrent communication with a fourth number of stations (e.g., 5 stations).

The mode selector 130 may select one or more valid MCGs of the MCG 224, the MCG 226, the MCG 228, the MCG 230, or a combination thereof. For example, the mode selector 130 determines that the MCG 230 is invalid in response to determining that a count of stations (e.g., 2 stations) of the MCG 230 is less than a number of stations (e.g., 5 stations) associated with the ML 231. The mode selector 130 may determine that the MCG 228 is valid in response to determining that a count of stations (e.g., 4 stations) of the MCG 228 is greater than or equal to a number of stations (e.g., 4 stations) associated with the ML 229. The mode selector 130 may determine that the MCG 226 is valid in response to determining that a count of stations (e.g., 5 stations) of the MCG 226 is greater than or equal to a number of stations (e.g., 5 stations) associated with the ML 227. The mode selector 130 may determine that the MCG 224 is valid in response to determining that a count of stations (e.g., 5 stations) of the MCG 224 is greater than or equal to a number of stations (e.g., 5 stations) associated with the ML 225.

The mode selector 130 may select a candidate group 251 from the OFDMA CG 222 and valid MU-MIMO CGs (e.g., the MCG 224, the MCG 226, and the MCG 228) that includes the most stations. For example, the mode selector 130 determines that the CG 251 corresponds to an OFDMA CG (e.g., the OFDMA CG 222) in response to determining that the OFDMA CG 222 includes the most stations of the OFDMA CG 222 and the valid MU-MIMO CGs, as described with reference to FIG. 1. As another example, the mode selector 130 determines that multiple CGs (e.g., the MCG 224 and the MCG 226) of the OFDMA CG 222 and the valid MU-MIMO CGs have a highest number of stations (e.g., 5 stations). The mode selector 130 may determine that the CG 251 corresponds to a CG (e.g., the MCG 226) corresponding to a highest MU-MIMO level (e.g., the ML 227) among the MU-MIMO levels (e.g., the ML 225 and the ML 227) of the multiple CGs (e.g., the MCG 224 and the MCG 226). The mode selector 130 may determine the selected mode 170 corresponding to the CG 251. For example, the mode selector 130, in response to determining that the MCG 226 is selected, determines that the selected mode 170 includes the MU-MIMO mode 162, the ML 227, or both.

The mode selector 130 may include stations of the CG 251 (e.g., the MCG 226) in the subset 123 for communication in the selected mode 170. For example, the mode selector 130, in response to determining that the MCG 226 is selected, includes the stations 263-267 of the MCG 226 in the subset 123. The mode selector 130 may, in response to determining that the CG 251 is a MU-MIMO CG (e.g., the MCG 226), determine that the subset 123 is the same as the CG 251 (e.g., the MCG 226).

The mode selector 130 may transmit, via the transceiver 134 of FIG. 1, the mode identifier 194 to one or more stations of the subset 123 (e.g., the stations 263-267), as described with respect to FIG. 1. The mode identifier 194 may indicate the selected mode 170 (e.g., the MU-MIMO mode 162, the ML 227, or both). During a data communication phase, the mode selector 130 may exchange data, via the transceiver 134, with one or more of the stations 263-267 of the subset 123 in the selected mode 170 (e.g., the MU-MIMO mode 162, the ML 227, or both), as described with reference to FIG. 1. The access point 102 may thus use a communication mode (e.g., the selected mode 170) that is supported by stations of the CG 251 and that is suited to exchange data buffered for communication with the stations of the CG 251.

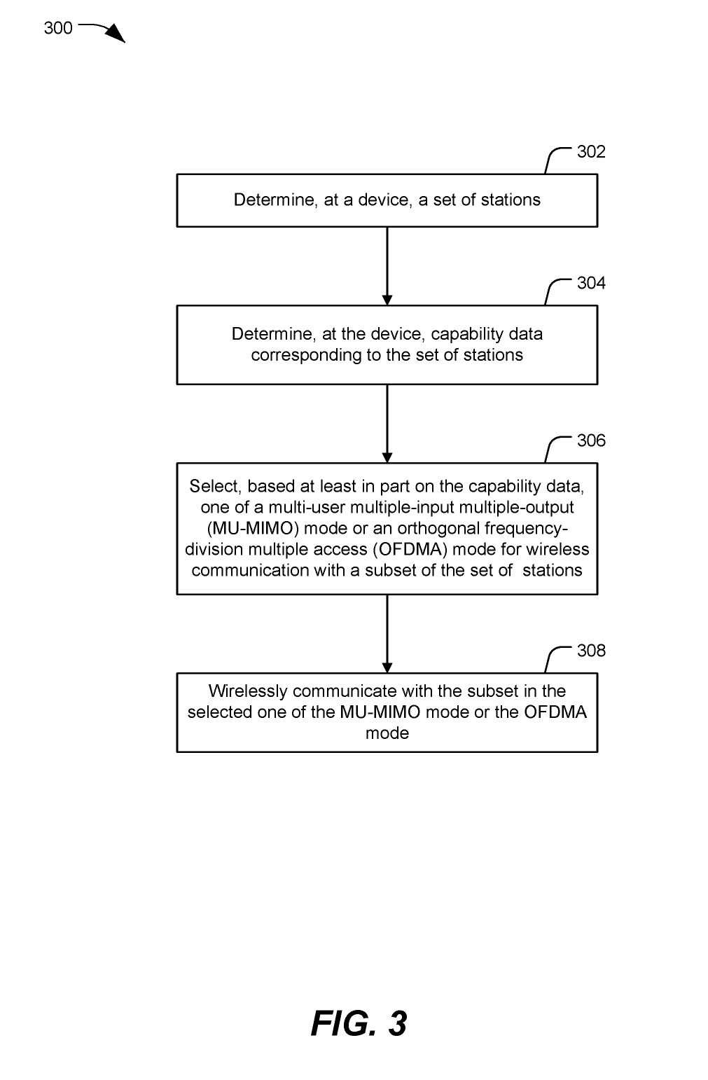

Referring to FIG. 3, a method of operation is shown and generally designated 300. The method 300 may be performed by the mode selector 130, the transceiver 134, the access point 102, the system 100 of FIG. 1, or a combination thereof.

The method 300 includes determining, at a device, a set of stations, at 302. For example, the mode selector 130 of FIG. 1 determines the set of scheduled stations 120, as described with reference to FIG. 1.

The method 300 also includes determining, at the device, capability data corresponding to the set of stations, at 304. For example, the mode selector 130 of FIG. 1 determines the capability data 150 corresponding to the set of scheduled stations 120, as described with reference to FIG. 1.

The method 300 further includes selecting, based at least in part on the capability data, one of a multi-user multiple-input multiple-output (MU-MIMO) mode or an orthogonal frequency-division multiple access (OFDMA) mode for wireless communication with a subset of the set of stations, at 306. For example, the mode selector 130 of FIG. 1 selects, based at least in part on the capability data 150, one of the MU-MIMO mode 162 or the OFDMA mode 160 as the selected mode 170 for wireless communication with the subset 123 of the set of scheduled stations 120, as described with reference to FIG. 1.

The method 300 also includes wirelessly communicating with the subset in the selected one of the MU-MIMO mode or the OFDMA mode, at 308. For example, the transceiver 134 of FIG. 1 exchanges at least one of the first data 154 or the second data 174 with the subset 123 in the selected mode 170, as described with reference to FIG. 1.

The method 300 thus enables selection of one of the MU-MIMO mode 162 or the OFDMA mode 160 as the selected mode 170 based on the capability data 150. The method 300 may enable use of a communication mode (e.g., the selected mode 170) that is supported by stations of the subset 123 and that is suited for exchanging data buffered for communication with at least one of the stations of the subset 123.

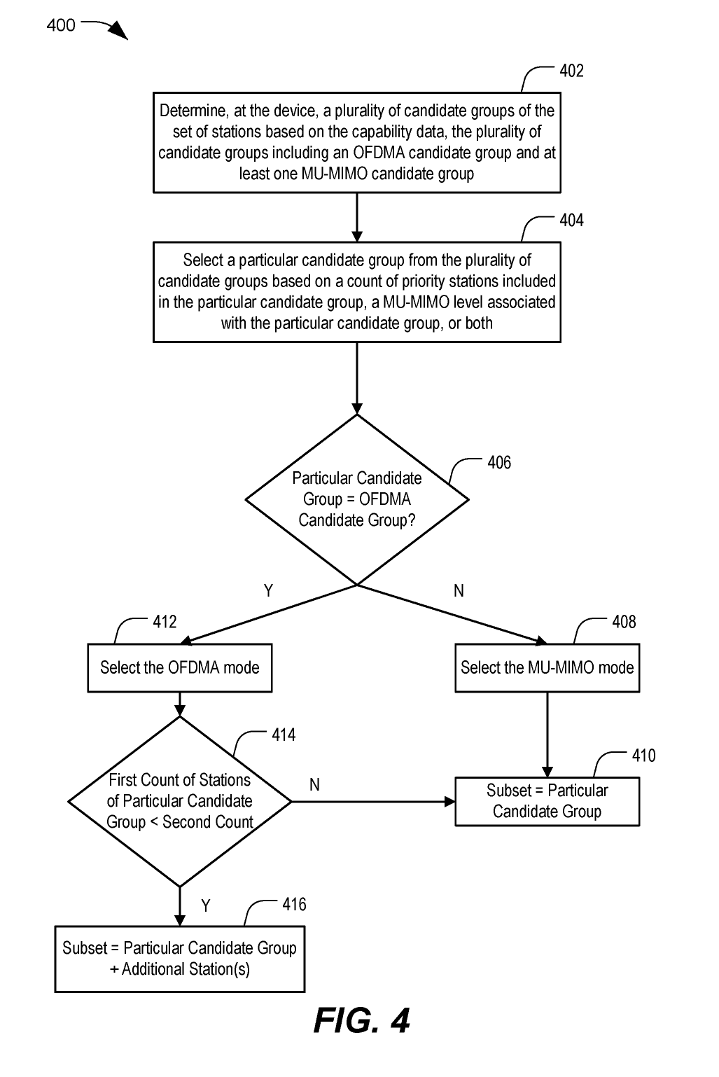

Referring to FIG. 4, a method of operation is shown and generally designated 400. The method 400 may be performed by the mode selector 130, the transceiver 134, the access point 102, the system 100 of FIG. 1, or a combination thereof.

The method 400 includes determining, at the device, a plurality of candidate groups of the set of stations based on the capability data, at 402. For example, the mode selector 130 of FIG. 1 determines the CG 124, the CG 126, and the CG 128, as described with reference to FIG. 1. The CG 124 may correspond to an OFDMA candidate group. The CG 126 and the CG 128 may correspond to MU-MIMO candidate groups.

The method 400 also includes selecting a particular candidate group from the plurality of candidate groups based on a count of priority stations included in the particular candidate group, a MU-MIMO level associated with the particular candidate group, or both, at 404. For example, the mode selector 130 of FIG. 1 selects the CG 124 from the CG 124, the CG 126, and the CG 128 based on a count of priority stations included in the CG 124, as described with reference to FIG. 1.

The method 400 further includes determining whether the particular candidate group is an OFDMA group, at 406. For example, the mode selector 130 of FIG. 1 determines whether the CG 124 is an OFDMA group, as described with reference to FIG. 1.

The method 400 includes, in response to determining that the particular candidate group is not an OFDMA group, at 406, select the MU-MIMO mode, at 408. For example, the mode selector 130 of FIG. 1 selects the MU-MIMO mode 162 in response to determining that the CG 124 is not an OFDMA group, as described with reference to FIG. 1.

The method 400 includes determining that a subset is the same as the particular candidate group, at 410. For example, the mode selector 130 of FIG. 1 determines that the subset 123 is the same as the CG 124, as described with reference to FIG. 1.

The method 400 includes, in response to determining that the particular candidate group is an OFDMA group, at 406, select the OFDMA mode, at 412. For example, the mode selector 130 of FIG. 1 selects the OFDMA mode 160 in response to determining that the CG 124 is an OFDMA group, as described with reference to FIG. 1.

The method 400 includes determining whether the first count of stations of the particular candidate group is less than a second count, at 414. For example, the mode selector 130 of FIG. 1 determines whether a first count of stations (e.g., 3 stations) of the CG 124 is less than a second count, as described with reference to FIG. 1. To illustrate, the second count corresponds to a count (e.g., a highest number) of stations that the transceiver 134 of FIG. 1 is capable of exchanging traffic with in the OFDMA mode 160. The method 400 proceeds to 410 in response to determining that the first count is greater than or equal to the second count.

The method 400 includes, in response to determining that the first count is less than the second, at 414, determining that the subset includes the particular candidate group and at least one additional station, at 416. For example, the mode selector 130 of FIG. 1, in response to determining that the first count is less than the second count, determines that the subset 123 includes the CG 124 and at least the station 109, as described with reference to FIG. 1.

The method 400 may thus reduce a communication latency associated with the station 109 by including the station 109 in the subset 123 for communication in the OFDMA mode 160 as compared to delaying communication with the station 109 until the MU-MIMO mode 162 is selected.

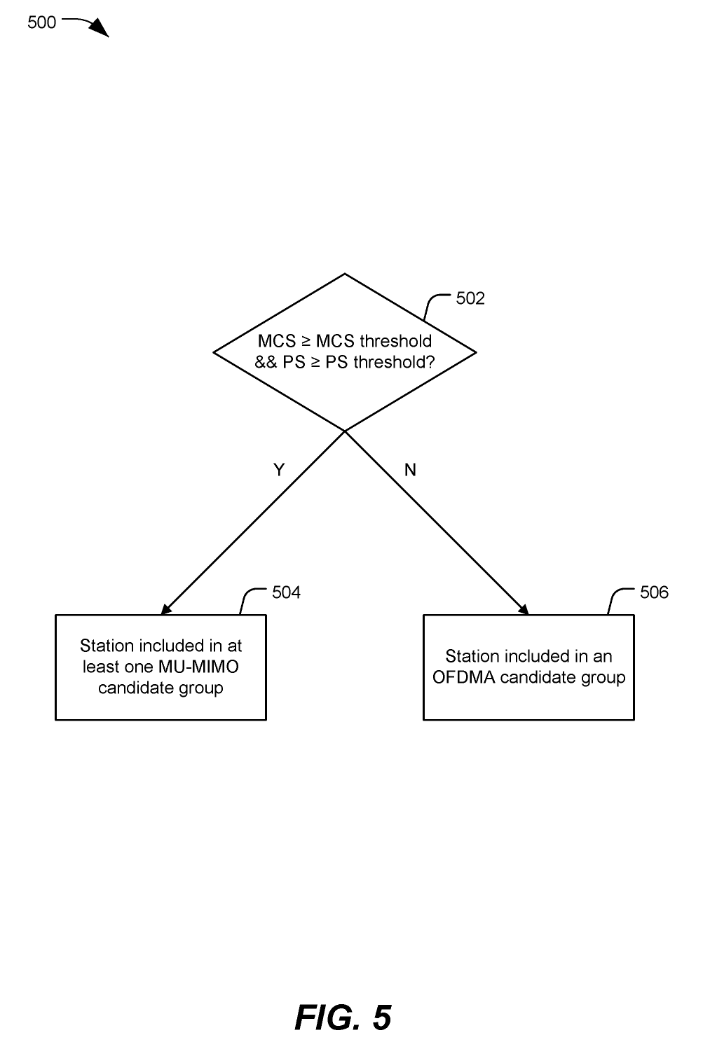

Referring to FIG. 5, a method of operation is shown and generally designated 500. The method 500 may be performed by the mode selector 130, the transceiver 134, the access point 102, the system 100 of FIG. 1, or a combination thereof.

The method 500 includes determining whether a MCS is greater than or equal to a MCS threshold and a PS is greater than or equal to a PS threshold, at 502. For example, the mode selector 130 of FIG. 1 determines whether the MCS 151 is greater than or equal to the MCS threshold 175 and the payload size (PS) 153 is greater than or equal to the PS threshold 159, as described with reference to FIG. 1.

The method 500 includes, in response to determining that MCS is greater than or equal to the MCS threshold and that the PS is greater than or equal to the PS threshold, at 502, determine that a station is included in at least one MU-MIMO candidate group, at 504. For example, the mode selector 130 of FIG. 1 determines that the station 109 is included in the CG 126 and the CG 128 in response to determining that the MCS 151 is greater than or equal to the MCS threshold 175 and the payload size (PS) 153 is greater than or equal to the PS threshold 159, as described with reference to FIG. 1. The CG 126 may be a MU-MIMO group associated with the MU-MIMO level 166, whereas the CG 128 may be a MU-MIMO group associated with the MU-MIMO level 168.

The method 500 includes, in response to determining that MCS is less than the MCS threshold or that the PS is less than the PS threshold, at 502, determine that a station is included in an OFDMA candidate group, at 506. For example, the mode selector 130 of FIG. 1 determines that the station 109 is included in the CG 124 in response to determining that the MCS 151 is less than the MCS threshold 175 or that the PS 153 is less than the PS threshold 159, as described with reference to FIG. 1. The CG 124 may be an OFDMA.

The method 500 may thus enable determining whether the station 109 is more suitable for OFDMA communication or MU-MIMO communication. The determination may be based on the MCS 151 and the PS 153.

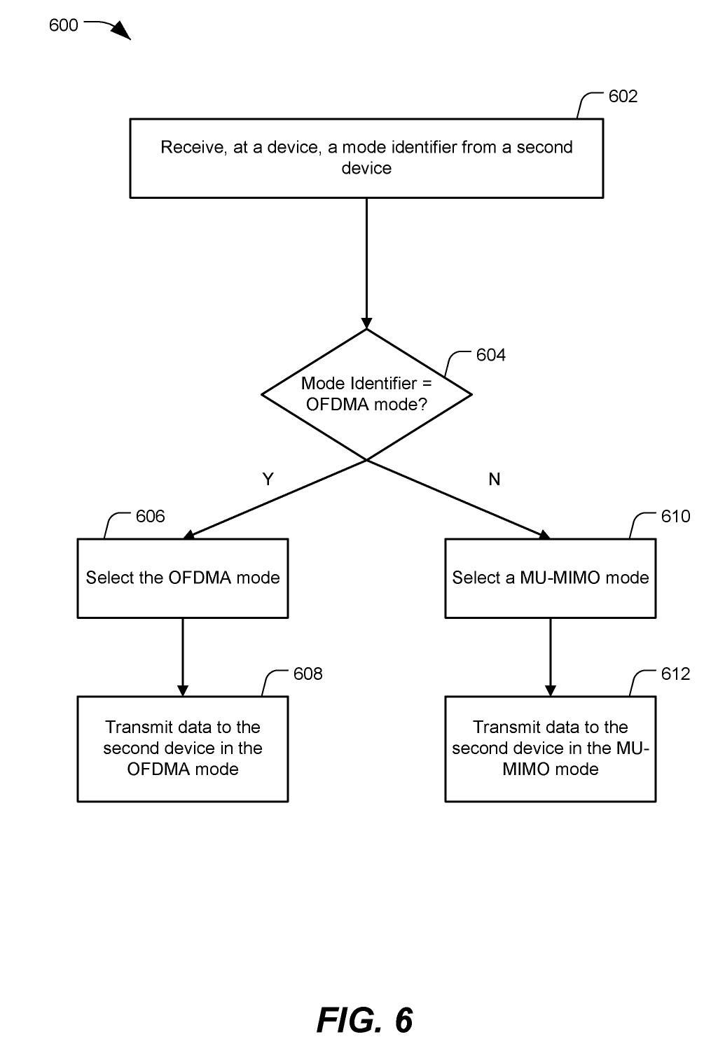

Referring to FIG. 6, a method of operation is shown and generally designated 600. The method 600 may be performed by the stations 104-109, the system 100 of FIG. 1, the stations 261-267 of FIG. 2, or a combination thereof.

The method 600 includes receiving, at a device, a mode identifier from a second device, at 602. For example, the station 109 of FIG. 1 receives the mode identifier 194 of FIG. 1 from the access point 102.

The method 600 also includes determining whether the mode identifier indicates an OFDMA mode, at 604. For example, the station 109 of FIG. 1 determines whether the mode identifier 194 indicates the OFDMA mode 160, as described with reference to FIG. 1.

The method 600 includes, in response to determining that the mode identifier indicates the OFDMA mode, at 604, selecting the OFDMA mode, at 606. For example, the station 109 of FIG. 1 selects the OFDMA mode 160 in response to determining that the mode identifier 194 indicates the OFDMA mode 160, as described with reference to FIG. 1.

The method 600 also includes transmitting data to the second device in the OFDMA mode, at 608. For example, the station 109 of FIG. 1 transmits the second data 174 in response to determining that the mode identifier 194 indicates the OFDMA mode 160, as described with reference to FIG. 1.

The method 600 includes, in response to determining that the mode identifier does not indicate the OFDMA mode, at 604, selecting a MU-MIMO mode, at 610. For example, the station 109 of FIG. 1 selects the MU-MIMO mode 162 in response to determining that the mode identifier 194 does not indicate the OFDMA mode 160, as described with reference to FIG. 1.

The method 600 also includes transmitting data to the second device in the MU-MIMO mode, at 612. For example, the station 109 of FIG. 1 transmits the second data 174 to the access point 102 in the MU-MIMO mode 162, as described with reference to FIG. 1.

The method 600 may thus enable the station 109 to select a communication mode (e.g., the OFDMA mode 160 or the MU-MIMO mode 162) based on the mode identifier 194 received from the access point 102. The station 109 may transmit data to the access point 102 using the selected communication mode.

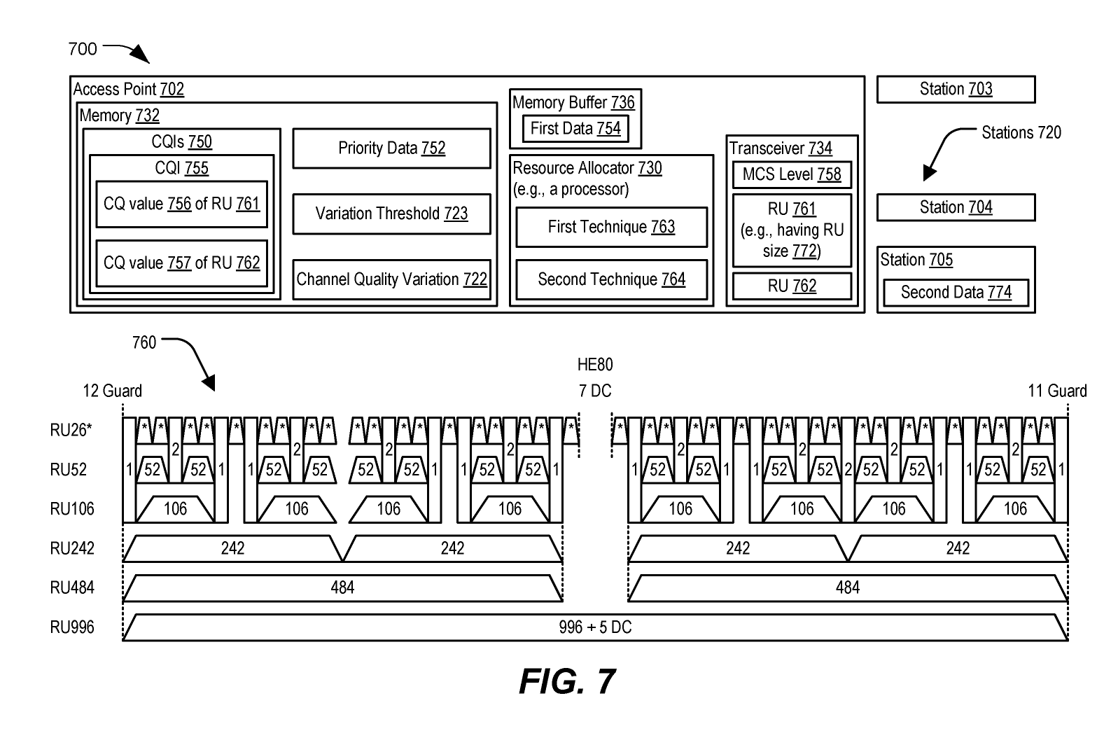

FIGS. 7-13 illustrate RU allocation for communication using an OFDMA mode. RUs may be allocated to stations based on channel quality detected at the stations. In a particular example, the RU allocation is performed subsequent to selection of the OFDMA mode from a plurality of communication modes. In a particular aspect, the plurality of communication modes includes the OFDMA mode 160 and the MU-MIMO mode 162, as described with reference to FIGS. 1-6. In an alternative aspect, the plurality of communication modes includes the OFDMA mode 160, the MU-MIMO mode 162, another communication mode, or a combination thereof. In a particular example, the RU allocation is performed independently of a selection of the OFDMA mode. For example, the OFDMA mode corresponds to a configuration setting, a user input, a default setting, or a combination thereof.

FIG. 7 depicts a particular illustrative aspect of a system 700 that includes a plurality of devices configured to communicate with each other. For example, the system 700 includes an access point 702, a station 703, a station 704, and a station 705. One or more of the stations 703-705 may be installed within, or roam within, a coverage area of the access point 702, and one or more of the stations 703-705 may enter or leave the coverage area of the access point 702 at various times. The access point 702 may be configured to allocate resource units (RUs) to one or more of the stations 703-705 based on channel quality indicators (CQIs) associated with the stations 703-705, as described herein. The access point 702 may be configured to exchange data with one or more of the stations 703-705 based on the allocated RUs. For example, a RU allocated to the station 704 corresponds to frequency subcarriers. The access point 702 may exchange data with the station 704 over the frequency subcarriers corresponding to the RU.

Each of the stations 703-705 may be an electronic device that may be used for voice communication and/or data communication over a wireless communication network. One or more of the stations 703-705 may be a communication device, such as a cellular phone, a personal digital assistant (PDA), a handheld device, a headset, a wireless modem, a laptop computer, a personal computer, etc. At least one of the stations 703-705 may be compatible with one or more mobile telecommunication technologies. For example, at least one of the stations 703-705 is compatible with third generation (3G) mobile telecommunication technologies, fourth generation (4G) mobile telecommunication technologies, and/or fifth generation (5G) mobile telecommunication technologies. Additionally, or in the alternative, at least one of the stations 703-705 may be compatible with different communication specifications (e.g., a Long-Term Evolution (LTE) wireless communication specification, a LTE-advanced (LTE-A) wireless communication specification, a Worldwide Interoperability for Microwave Access (WiMAX) wireless communication specification, an Enhanced Voice Services (EVS) specification, an Adaptive Multi-Rate Wideband (AMR-WB) specification, a LTE-direct (LTE-D) wireless communication specification, an Institute of Electrical and Electronics Engineers (IEEE) 802.11 specification, etc.).

The access point 702 (e.g., an electronic device) may provide the stations 703-705 access to one or more services (e.g., network connectivity). The access point 702 may enable the stations 703-705 to exchange data between the stations 703-705, with one or more networks, or a combination thereof. The access point 702 may be configured to concurrently receive data from a plurality of stations, to concurrently transmit data to a plurality of stations, or both.

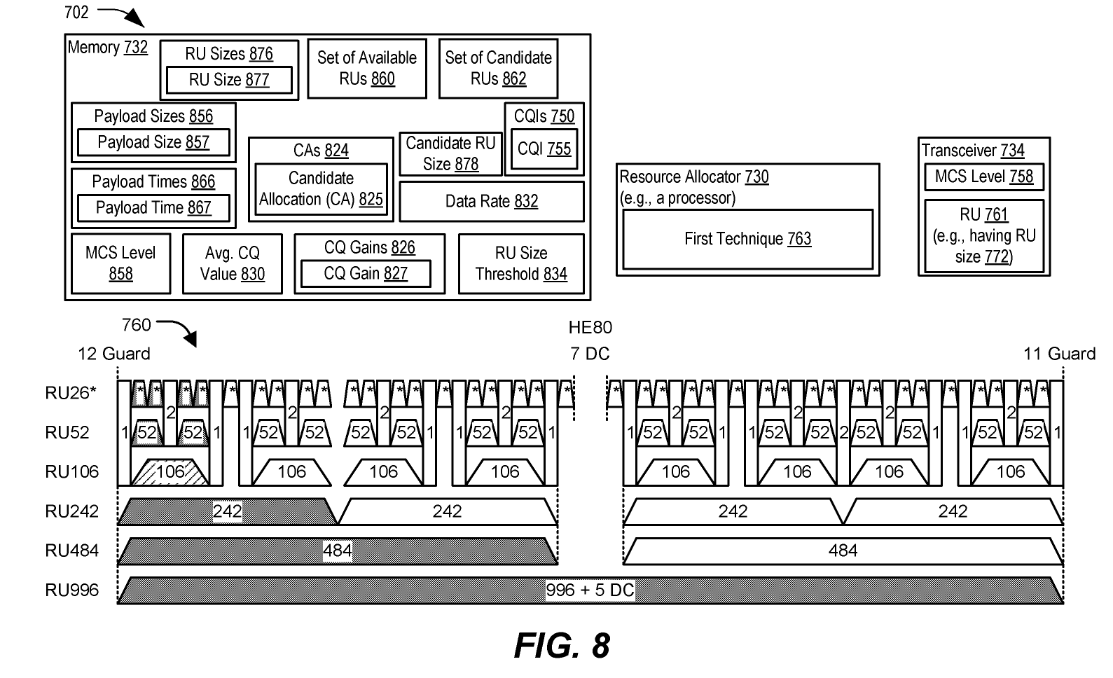

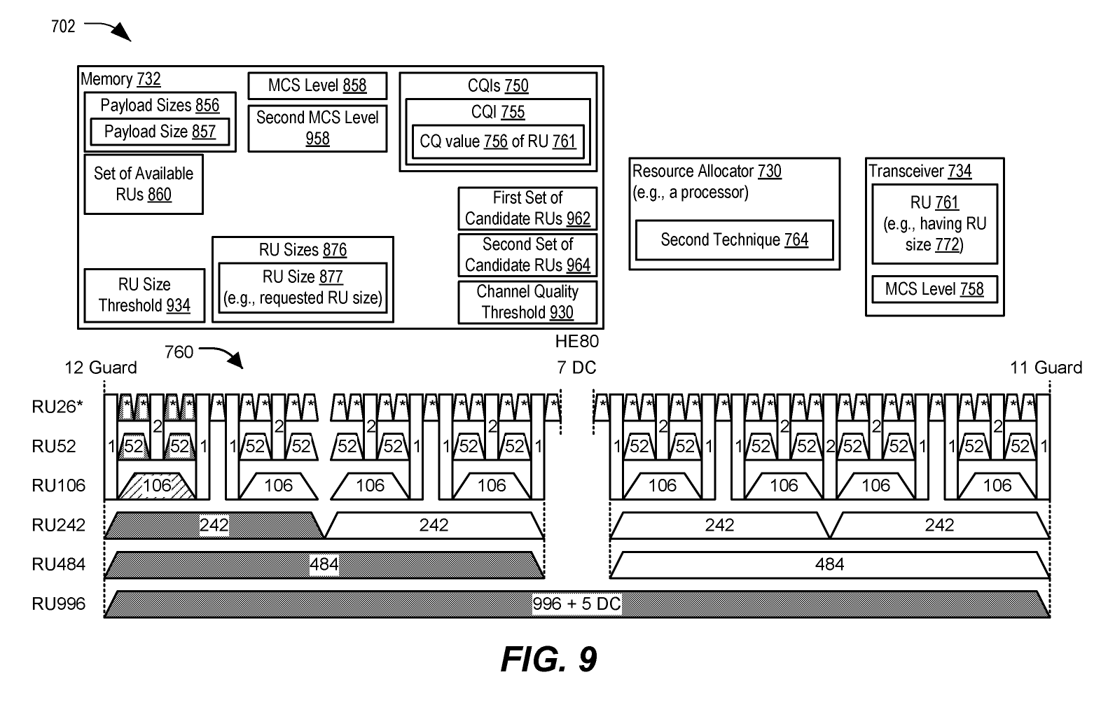

The access point 702 includes a resource allocator 730, a memory buffer 736, a memory 732, and a transceiver 734. The transceiver 734 may include at least one of a receiver or a transmitter. The memory 732 may be configured to store priority data 752. The priority data 752 indicates a priority associated with at least one of the stations 703-705. For example, the priority data 752 indicates that the station 703 is associated with a first priority and that each of the stations 704-705 is associated with a second priority that is higher than the first priority. The memory 732 may be configured to store CQIs 750 associated with one or more of the stations 703-705. The resource allocator 730 may be configured to allocate RUs to one or more of the stations 703-705 based on the CQIs 750. For example, the resource allocator 730 allocates the RUs using a first technique 763 based on channel quality gains, as further described with reference to FIG. 8. As another example, the resource allocator 730 allocates the RUs using a second technique 764 based on a channel quality threshold, as further described with reference to FIG. 9.

FIG. 7 depicts an illustrative arrangement 760 of frequency subcarriers. In the arrangement 760, the horizontal direction corresponds to the frequency domain. The arrangement 760 illustrates a plurality of available RU sizes: 26 frequency subcarriers (RU-26), 52 frequency subcarriers (RU-52), 106 frequency subcarriers (RU-106), 242 frequency subcarriers (RU-242), 484 frequency subcarriers (RU-484), or 996 frequency subcarriers (RU-996).

A 20 megahertz (MHz) OFDMA wireless channel may accommodate up to one RU-242, two RU-106s, four RU-52s, or 9 RU-26s. A 40 MHz OFDMA wireless channel may accommodate up to one RU-484, two RU-242s, four RU-106s, eight RU-52s, or eighteen RU-26s. An 80 MHz OFDMA wireless channel may accommodate up to one RR-996, two RU-484s, four RU-242s, eight RU-106s, sixteen RU-52s, or thirty-seven RU-26s.

The memory buffer 736 is configured to store data (e.g., packet data) that is available for transmission to the stations 703-705. For example, the memory buffer 736 is configured to store first data 754 that is available for transmission to the station 704.

The transceiver 734 may be configured to exchange data with one or more of the stations 703-705.

During operation, the access point 702 may receive, via the transceiver 734, a CQI 755 from the station 704. The access point 702 may store the CQI 755 in the memory 732. The CQI 755 may indicate channel quality detected by the station 704 across a plurality of RUs. The channel quality may be detected based on one or more pilot signals. To illustrate, the access point 702 may transmit, via the transceiver 734, one or more pilot signals corresponding to a plurality of RUs. At least one of the stations 703-705 may receive the one or more pilot signals and determine a CQI across the plurality of RUs based on the one or more pilot signals. As an example, the station 704 receives a first signal (e.g., a first pilot signal) transmitted over first frequency subcarriers of a resource unit (RU) 761 and may determine a CQ value 756 associated with the RU 761 based on a detected channel quality of the first signal. The detected channel quality of the first signal may be based on a first signal strength of the first signal, one or more additional indicators of channel quality of the first signal, or a combination thereof. For example, the CQ value 756 includes a measurement of energy of the first signal, a signal-to-noise ratio, or another indicator of channel quality. The station 704 may receive a second signal (e.g., a second pilot signal) transmitted over second frequency subcarriers of a RU 762 and may determine a CQ value 757 associated with the RU 762 based on a detected channel quality of the second signal. The detected channel quality of the second signal may be based on a second signal strength of the second signal, one or more additional indicators of channel quality of the second signal, or a combination thereof.

The station 704 may generate the CQI 755 indicating the CQ value 756, the CQ value 757, one or more additional CQ values corresponding to one or more additional RUs, or a combination thereof. For example, the CQI 755 includes (or represents) a plurality of CQ values associated with different RUs. Each CQ value may be within a designated range and may correspond to a metric of channel quality. The range and metrics may be defined in one or more industry specifications. The station 704 may transmit the CQI 755 to the access point 702 responsive to receiving a request from the access point 702. Similarly, the access point 702 may receive CQIs from other stations (e.g., the stations 703, 705).

The first frequency subcarriers of the RU 761 and the second frequency subcarriers of the RU 762 may be associated with a first OFDMA wireless channel and a second OFDMA wireless channel, respectively. In a particular implementation, the first frequency subcarriers (or the second frequency subcarriers) include 26 frequency subcarriers, 52 frequency subcarriers, 106 frequency subcarriers, 242 frequency subcarriers, 484 frequency subcarriers, or 996 frequency subcarriers. An OFDMA wireless channel may include a 20 MHz wireless channel, a 40 MHz wireless channel, or an 80 MHz wireless channel. In a particular aspect, an OFDMA wireless channel supports communication in accordance with an IEEE 802.11ax specification.

The resource allocator 730 may determine that the station 705 has second data 774 available (e.g., buffered) for transmission to the access point 702 in response to receiving a traffic indicator from the station 705 that indicates availability of the second data 774. The traffic indicator may indicate a payload size of the second data 774. The traffic indicator may indicate a priority (e.g., a quality of service (QoS) level) associated with the second data 774, the station 705, or both.

In a particular aspect, the resource allocator 730 determines a priority associated with a station based on a QoS level associated with the station. For example, the resource allocator 730 determines that the station 703 is associated with the first priority based on determining that data buffered for communication with the station 703 is associated with a first QoS level (e.g., a background access category or a best effort access category). The resource allocator 730 may determine that the station 704 is associated with the second priority in response to determining that the first data 754 is associated with a second QoS level (e.g., a voice access category or a video access category). The resource allocator 730 may determine that the station 705 is associated with the second priority in response to determining that the second data 774 is associated with the second QoS level (e.g., the voice access category or the video access category). The resource allocator 730 may update (or generate) the priority data 752 to indicate that the station 703 is associated with the first priority and that each of stations 704-705 is associated with the second priority. It should be understood that two priority levels are described for ease of illustration. In other aspects, the stations 703-705 are associated with any number of priority levels, such as a single priority level or more than two priority levels.

In a particular aspect, the resource allocator 730 determines that each of the stations 703-705 that has a particular priority (e.g., a highest priority) is a priority station. For example, the resource allocator 730 determines that the station 704 (or the station 705) is a priority station in response to determining that the priority data 752 indicates that the station 704 (or the station 705) has a particular priority (e.g., a highest priority) among priorities of the stations 703-705. The resource allocator 730 may determine that the station 703 is not a priority station in response to determining that the priority data 752 indicates that the station 703 has a priority (e.g., the first priority) that is lower than a particular priority (e.g., a highest priority) associated with at least one of the stations 703-705.

In an alternative aspect, the resource allocator 730 determines that each of the stations 703-705 that has a priority greater than or equal to a threshold priority is a priority station. For example, the resource allocator 730 determines that the station 703 is not a priority station in response to determining that the priority data 752 indicates that the station 703 has a first priority and that the first priority does not exceed the threshold priority. As another example, the resource allocator 730 determines that the station 704 (or the station 705) is a priority station in response to determining that the priority data 752 indicates that the station 704 (or the station 705) has a second priority and that the second priority is equal to or exceeds the threshold priority.

The resource allocator 730 may, during a resource allocation phase of operation, determine that at least one RU is to be allocated to one or more stations 720. The resource allocator 730 may determine that a station is included in the stations 720 in response to determining that data is available to exchange with the station, that the station is a priority station, or both. For example, the resource allocator 730 determines that the station 704 is included in the stations 720 in response to determining that the memory buffer 736 includes the first data 754 available for transmission to the station 704, that the priority data 752 indicates that the station 704 is a priority station, or both. As another example, the resource allocator 730 determines that the station 705 is included in the stations 720 in response to determining that the station 705 has second data 774 available for transmission to the access point 702, that the priority data 752 indicates that the station 705 is a priority station, or both.

The resource allocator 730 may determine that the station 703 is excluded from the stations 720 in response to determining that priority data 752 indicates that the station 703 is not a priority station, that the memory buffer 736 does not include any data that is available for transmission to the station 703, that the station 703 does not have any data available for transmission to the access point 702, or a combination thereof. In a particular aspect, the resource allocator 730 determines that the station 703 does not have any data available for transmission to the access point 702 in response to determining, at a first time, that no traffic indicator has been received from the station 703 within a time interval prior to the first time. For example, the time interval is designated for exchange of traffic indicators and a failure to receive a traffic indicator during the time interval indicates that the station 703 does not have data available to transmit to the access point 702. Alternatively, the resource allocator 730 may determine that the station 703 does not have any data available for transmission to the access point 702 in response to receiving a traffic indicator from the station 703 indicating that the station 703 does not have data to transmit to the access point 702.

The resource allocator 730 may, in response to determining that the stations 720 include at least one station, determine a channel quality variation 722 across a plurality of RUs. For example, the resource allocator 730 determines the channel quality variation 722 based on the CQI 755. In a particular aspect, the channel quality variation 722 represents signal strength variation. For example, the channel quality variation 722 represents a difference between the CQ value 756 and the CQ value 757 or a standard deviation of CQ values. In a particular aspect, the resource allocator 730 determines the channel quality variation 722 based on a difference between the CQ value 756 and the CQ value 757. In this aspect, the CQ value 756 corresponds to a first particular CQ value (e.g., a highest CQ value) indicated by the CQI 755, whereas the CQ value 757 corresponds to a second particular CQ value (e.g., a lowest CQ value) indicated by the CQI 755. In an alternative aspect, the resource allocator 730 determines the channel quality variation 722 based on a standard deviation of CQ values indicated by the CQI 755. The CQ values indicated by the CQI 755 may include the CQ value 756, the CQ value 757, or both.

The resource allocator 730 may, in response to determining that the channel quality variation 722 satisfies (e.g., is greater than or equal to) a variation threshold 723, perform the first technique 763 to allocate RUs to the stations 704-705 based on channel quality gains, as further described with reference to FIG. 8. For example, the resource allocator 730 allocates the RU 761 to the station 704, the RU 762 to the station 705, or both. The RU 761 may have a RU size 772. The resource allocator 730 may, in response to determining that the channel quality variation 722 fails to satisfy (e.g., is less than) the variation threshold 723, perform the second technique 764 to allocate RUs to the stations 704-705 based on a channel quality threshold, as further described with reference to FIG. 9. For example, the resource allocator 730 allocates the RU 761 to the station 704, the RU 762 to the station 705, or both. The variation threshold 723 may correspond to a default value, a value indicated by a user input, or both. The transceiver 734 may transmit a first notification to the station 704 indicating that the RU 761 is allocated to the station 704, a second notification to the station 705 indicating that the RU 762 is allocated to the station 705, or both.

The transceiver 734 may, during a data exchange phase of operation, transmit buffered data over one or more allocated RUs to the stations 720 during one or more downlink transmissions. For example, the transceiver 734 transmits the first data 754 over the first frequency subcarriers of the RU 761 to the station 704. The transceiver 734 may use one or more allocated RUs during a single uplink transmission. The station 705 may transmit the second data 774 over the second frequency subcarriers of the RU 762 to the access point 702. The transceiver 734 may receive data buffered data at the stations 720 over one or more allocated RUs during one or more uplink transmissions. For example, the transceiver 734 receives the second data 774 over the second frequency subcarriers of the RU 762 from the station 705. The transceiver 734 may use one or more allocated RUs during a single uplink transmission.

In a particular aspect, the first notification to the station 704 (or the second notification to the station 705) indicates a MCS level 758. The transceiver 734 may exchange data with the station 704 (or the station 705) using a data rate that is based on the MCS level 758. In a particular aspect, a first MCS level assigned to the station 704 differs from a second MCS level assigned to the station 705. In this aspect, the first notification to the station 704 indicates the first MCS level, whereas the second notification to the station 705 indicates the second MCS level. The transceiver 734 may transmit at least a portion of the first data 754 to the station 704 based on the first MCS level. The transceiver 734 may receive at least a portion of the second data 774 from the station 705 based on the second MCS level. The data exchange phase of operation may correspond to a transmit opportunity (TXOP). The resource allocation phase may be prior to or during an initial portion of the TXOP.

In a particular aspect, the channel quality variation 722 is based on multiple CQIs of the CQIs 750. For example, the resource allocator 730 generates an average CQ value corresponding to each of the plurality of RUs based on the CQIs 750. The resource allocator 730 may determine the channel quality variation 722 based on a difference between a first CQ value (e.g., a highest CQ value) of the average CQ values and a second CQ value (e.g., a lowest CQ value) of the average CQ values. Alternatively, the resource allocator 730 may determine the channel quality variation 722 based on a standard deviation of the average CQ values.

The system 700 may thus enable RU allocation based on detected channel quality. The RUs may be allocated based at least in part on CQ variations. A lower channel quality variation (e.g., less than or equal to a variation threshold) may indicate that channel quality values are substantially similar across the plurality of RUs. Allocation of any of the plurality of RUs to the station may result in substantially similar channel quality gains. A higher channel quality variation (e.g., greater than the variation threshold) may indicate that allocation of some RUs to the station may result in higher channel quality gains than allocation of other RUs to the station.

The first technique 763 may be used for RU allocation based on channel quality gains in response to determining that the channel quality variation 722 is greater than or equal to the variation threshold 723. Alternatively, the second technique 764 may be used for RU allocation independent of the channel quality gains in response to determining that the channel quality variation 722 is less than the variation threshold 723. By allocating RUs based on channel gains while the channel quality variation is high and based on threshold channel quality value while the channel quality variation is low, the access point 702 may balance providing higher channel quality gains with reducing latency in allocating RUs.

Referring to FIG. 8, a particular illustrative aspect of the access point 702 is shown. The access point 702 includes the resource allocator 730. The access point 702 may also include the memory 732, the transceiver 734, or both. For example, at least one of the memory 732 or the transceiver 734 is integrated into the access point 702.

The memory 732 may be configured to store one or more payload sizes 856 of data buffered to be exchanged with the stations 720. For example, the payload sizes 856 indicates a payload size 857 of the first data 754 buffered for transmission to the station 704. As another example, the payload sizes 856 indicates a second payload size of the second data 774 buffered at the station 705 for transmission to the access point 702.

The memory 732 may be configured to store average channel quality (CQ) values associated with the stations 703-705. For example, the memory 732 stores an average CQ value 830 associated with the station 704.

During the resource allocation phase of operation, the resource allocator 730 may generate (or update) information to be used in performing the first technique 763. For example, the resource allocator 730 determines the average CQ value 830 of the station 704 based on the CQI 755. For example, the average CQ value 830 corresponds to a sum of CQ values indicated by the CQI 755. The CQ values indicated by the CQI 755 may include the CQ value 756 of FIG. 7, the CQ value 757 of FIG. 7, or both. As another example, the resource allocator 730 determines a second average CQ value based on a second CQI of the CQIs 750 corresponding to the station 705.

The resource allocator 730 may determine payload times 866 of the stations 720 based on the payload sizes 856. For example, the resource allocator 730 determines a payload time 867 of the station 704 based on the payload size 857 and a MCS level 858. To illustrate, the MCS level 858 may indicate a data rate 832 and the resource allocator 730 may determine the payload time 867 based on the payload size 857 and the data rate 832 (e.g., payload time 867=payload size 857/data rate 832). The payload times 866 may indicate estimated time intervals to exchange buffered data with the stations 703-705. For example, the payload time 867 indicates a first estimated time interval to transmit the first data 754 to the station 704. A second payload time of the payload times 866 may indicate a second estimated time interval to receive the second data 774 from the station 705.

The MCS level 858 may correspond to an estimated MCS level that may be used by the access point 702 to exchange data with one or more of the stations 720. The MCS level 858 may correspond to a default MCS level, a configuration setting, or both. In a particular aspect, the MCS level 858 is a particular MCS level (e.g., a second highest) supported by the access point 702. The resource allocator 730 may assign the MCS level 858 to the station 704, the station 705, or both. The MCS level 758 may correspond to the MCS level 858.

A particular RU size (e.g., 996 frequency subcarriers) may indicate an available RU size (e.g., a maximum available RU size). The resource allocator 730 may update (or generate) a RU size threshold 834 based on the payload sizes 856, a count of the stations 720 (e.g., 2), or both. In a particular aspect, the resource allocator 730 determines the same RU size threshold for each of the stations 720. For example, the resource allocator 730 determines the RU size threshold 834 based on the particular RU size (e.g., 996 frequency subcarriers) and a count of the stations 720 (e.g., RU size threshold 834=particular RU size/count of the stations 720). In this aspect, the resource allocator 730 assigns the RU size threshold 834 (e.g., 498 frequency subcarriers) to each of the stations 720.

In some aspects, the resource allocator 730 determines RU sizes thresholds for the stations 720 based on proportions of buffered data. For example, the resource allocator 730 determines the RU size threshold 834 of the station 704 based on the payload size 857, the payload sizes 856, and the particular RU size (e.g., RU size threshold 834=particular RU size*(payload size 857/payload sizes 856)). The resource allocator 730 may determine a second RU size threshold of the station 705 based on the second payload size of the second data 774, the payload sizes 856, and the particular RU size. As an example, the resource allocator 730, in response to determining that the payload size 857 of the first data 754 is two times the second payload size of the second data 774, assigns the RU size threshold 834 to the station 704 and the second RU size threshold to the station 705. In this example, the RU size threshold 834 is twice the second RU size threshold assigned to the station 705. In this example, the RU size threshold 834 is two-thirds of the particular RU size (e.g., a maximum available RU size) and the second RU size threshold may correspond to one-third of the particular RU size.

The resource allocator 730 may determine RU sizes 876 of the stations 720. For example, the resource allocator 730 determines a RU size 877 of the station 704 based on the payload time 867 and a subcarrier duration (e.g., RU size 877=payload time 867/subcarrier duration). The subcarrier duration may correspond to a default value, a configuration setting, a value based on a user input, or a combination thereof. A particular RU size of the RU sizes 876 may indicate a size of RUs to be allocated to a corresponding station to exchange an entirety of data buffered for exchange with the station. For example, the RU size 877 indicates a size (e.g., a minimum size) of RUs that are to be allocated to the station 704 to transmit the entire first data 754 to the station 704. The resource allocator 730 may identify a set of available RUs 860. For example, the set of available RUs 860 includes one RR-996, two RU-484s, four RU-242s, eight RU-106s, sixteen RU-52s, thirty-seven RU-26s, or a combination thereof. The set of available RUs 860 may include the RU 761 of FIG. 7, the RU 762 of FIG. 7, or both.

The resource allocator 730 may perform the first technique 763 to allocate one or more of the set of available RUs 860 to one or more of the stations 720. For example, the resource allocator 730 iteratively allocates one or more RUs of the set of available RUs 860 to one or more of the stations 720, as described herein. The resource allocator 730 may generate one or more candidate allocations 824 associated with the stations 720. For example, the resource allocator 730 generates one or more candidate allocations, such as a candidate allocation (CA) 825, associated with the station 704. The candidate allocations 824 may include the one or more candidate allocations associated with the station 704. The resource allocator 730 may initialize a set of candidate RUs 862 to include the set of available RUs 860. The resource allocator 730 may, in response to determining that the RU size 877 is greater than the RU size threshold 834, set the RU size 877 to the RU size threshold 834. In this aspect, a first portion of the first data 754 is transmitted to the station 704 during a first data exchange phase (e.g., a first TXOP) and a remaining portion of the first data 754 is buffered for transmission to the station 704 during one or more subsequent data exchange phases (e.g., subsequent TXOPs).

The resource allocator 730 may generate one or more of the candidate allocations 824, such as a candidate allocation (CA) 825, associated with the station 704 based on the set of candidate RUs 862. To illustrate, the resource allocator 730 may initialize a candidate RU size 878 to indicate the RU size 877. The resource allocator 730 may, in response to determining that the set of candidate RUs 862 is non-empty, determine whether the set of candidate RUs 862 includes at least one RU having a size that is greater than or equal to the candidate RU size 878. The resource allocator 730 may, in response to determining that the set of candidate RUs 862 does not include any RU having a size that is greater than or equal to the candidate RU size 878, identify a particular RU (e.g., the RU 761) of the set of candidate RUs 862 having a particular size (e.g., a greatest size). In a particular aspect, the resource allocator 730 determines that multiple RUs of the set of candidate RUs 862 have the particular size (e.g., the greatest size). The resource allocator 730 may select a particular RU (e.g., the RU 761) of the multiple RUs that has a particular CQ value (e.g., a highest CQ value). The resource allocator 730 may generate the CA 825 indicating allocation of the RU 761 to the station 704. The resource allocator 730 may remove the RU 761 from the set of candidate RUs 862 and may update the candidate RU size 878 based on the RU size 772 (e.g., candidate RU size 878=candidate RU size 878−RU size 772). In this manner, the resource allocator 730 may iteratively allocate RUs (e.g., contiguous RUs) to the station 704 until the candidate RU size 878 is equal to 0, the set of candidate RUs 862 is empty, or both.

The resource allocator 730 may, in response to determining that the set of candidate RUs 862 includes at least one RU having a size that is greater than or equal to the candidate RU size 878, identify a particular RU (e.g., a smallest RU, such as the RU-106) of the set of available RUs 860 that has a particular size (e.g., 106) that is greater than or equal to the candidate RU size 878 (e.g., 80). In a particular aspect, the resource allocator 730 determines that multiple RUs of the set of candidate RUs 862 have the particular size (e.g., the smallest RU size that is greater than or equal to the candidate RU size 878). The resource allocator 730 may select a particular RU (e.g., the RU 761) of the multiple RUs that has a particular CQ value (e.g., a highest CQ value). The resource allocator 730 may generate a CA (e.g., the CA 825) indicating allocation of the particular RU (e.g., the RU 761) to the station 704.

The resource allocator 730 may determine one or more candidate allocations associated with the other stations of the stations 720. The candidate allocations associated with one station (e.g., the station 704) may be independent of the candidate allocations associated with another station (e.g., the station 705). For example, the resource allocator 730 updates the set of candidate RUs 862 to indicate the set of available RUs 860 subsequent to determining the one or more candidate allocations associated with the station 704. The resource allocator 730 may determine one or more second candidate allocations of the station 705, such as a second candidate allocation of the RU 762, based on the set of candidate RUs 862 using the approaches described above. The resource allocator 730 may add the one or more second candidate allocations to the CAs 824. In a particular aspect, multiple candidate allocations of the CAs 824 include one or more of the same RUs. For example, an RU is included in the one or more candidate allocations of the station 704 and in the one or more second allocations of the station 705.

The resource allocator 730 may determine CQ gains 826 associated with the CAs 824. For example, the resource allocator 730 determines a CQ gain 827 corresponding to the CA 825. To illustrate, the resource allocator 730 determines the CQ gain 827 based on a difference between the CQ value 756 of FIG. 7 and the average CQ value 830 (e.g., CQ gain 827=CQ value 756−average CQ value 830). The resource allocator 730 may determine a second CQ gain corresponding to the second candidate allocation of the RU 762 to the station 705. The CQ gains 826 may include the CQ gain 827, the second CQ gain, or both.

The resource allocator 730 may allocate the RU 761 to the station 704 in response to determining that the CQ gain 827 is a particular CQ gain (e.g., a highest CQ gain) of the CQ gains 826. The resource allocator 730 may remove the RU 761 (e.g., the RU-106) from the set of available RUs 860 in response to allocating the RU 761 to the station 704. The resource allocator 730 may, in response to allocating the RU 761 to the station 704, also exclude one or more RUs from the set of available RUs 860 that overlap the RU 761. For example, the resource allocator 730 removes four RU-26s, two RU-52s, one RU-242, one RU-484, the RU-996, or a combination thereof, that overlap the RU 761 from the set of available RUs 860.

In a particular aspect, the CAs 824 include multiple CAs corresponding to a single station (e.g., the station 704). The multiple CAs may include the CA 825 and a second CA. The second CA may correspond to a second RU. The CQI 755 may indicate a second CQ value of the second RU. The resource allocator 730 may determine a group CQ value based on CQ values indicated by the CQI 755 that are associated with the RUs indicated by the multiple CAs. For example, the resource allocator 730 determines the group CQ value based on the CQ value 756 and the second CQ value (e.g., group CQ value=(CQ value 756+second CQ value)/2). The resource allocator 730 may determine the CQ gain 827 based on a difference between the average CQ value 830 and the group CQ value (e.g., CQ gain 827=group CQ value−average CQ value 830).

The resource allocator 730 may allocate multiple CAs (e.g., the RU 761 and the second RU) to the station 704 in response to determining that the CQ gain 827 is a particular CQ gain (e.g., a highest CQ gain) of the CQ gains 826. The resource allocator 730 may remove each of the RU 761 and the second RU from the set of available RUs 860 subsequent to the allocation of the RU 761 and the second RU to the station 704. The resource allocator 730 may, subsequent to the allocation of the RU 761 and the second RU to the station 704, also exclude one or more RUs from the set of available RUs 860 that overlap the RU 761, the second RU, or both. The resource allocator 730 may remove the station 704 from the stations 720 subsequent to the allocation of the RU 761 and the second RU to the station 704.

The resource allocator 730 may continue to iteratively allocate one or more RUs from the set of available RUs 860 to one or more of the stations 720, as described above, while the set of available RUs 860 is non-empty and the count of the stations 720 is greater than 0.

The resource allocator 730 may allocate RUs to stations in order to achieve highest channel quality gains. The resource allocator 730 may allocate RUs based on channel quality gains while channel quality variation is greater than a threshold variation. Higher channel quality gains may result in fewer transmission errors, less overhead due to re-transmission, etc.

Referring to FIG. 9, a particular illustrative aspect of the access point 702 is shown. The access point 702 includes the resource allocator 730. The access point 702 may also include the memory 732, the transceiver 734, or both.

The memory 732 may be configured to store the MCS level 858. The memory 732 may be configured to store the RU sizes 876 associated with the stations 720, as described with reference to FIG. 8. The RU sizes 876 may include the RU size 877 (e.g., a first requested RU size) of the station 704. The memory 732 may be configured to store a channel quality threshold 930. The channel quality threshold 930 may correspond to a default value, a configuration setting, a value associated with a user input, or a combination thereof.

During the resource allocation phase of operation, the resource allocator 730 may generate (or update) information to be used in performing the second technique 764. For example, the resource allocator 730 determines a RU size threshold 934 based on a count of the stations 720. To illustrate, the resource allocator 730 may determine the RU size threshold 934 based on the following Equation:

$$RU size threshold 934 = max ( k \frac{\# RU 26}{min ( N , \# RU 26 )} , RU 242 ) , \qquad Equation 1$$

where #RU26 indicates a count (e.g., 37) of particular RUs (e.g., RU-26) having a particular size (e.g., a smallest size), RU242 indicates a size (e.g., 242) of a particular RU (e.g., RU-242) having a particular size (e.g., a third largest size), N indicates a count of the stations 720, and k corresponds to a constant value. For example, k corresponds to a default value, a configuration setting, a value associated with a user input, or a combination thereof.

The resource allocator 730 may identify the set of available RUs 860. For example, the set of available RUs 860 includes one RU-996, two RU-484s, four RU-242s, eight RU-106s, sixteen RU-52s, thirty-seven RU-26s, or a combination thereof. The set of available RUs 860 may include the RU 761 of FIG. 7, the RU 762 of FIG. 7, or both.

During operation, the resource allocator 730 may perform the second technique 764 to allocate one or more of the set of available RUs 860 to one or more of the stations 720. The resource allocator 730 may, in response to determining that the RU size 877 is greater than the RU size threshold 934, set the RU size 877 to the RU size threshold 934. In this aspect, a first portion of the first data 754 is transmitted to the station 704 during a first data exchange phase (e.g., a first TXOP) and a remaining portion of the first data 754 is buffered for transmission to the station 704 during one or more subsequent data exchange phases (e.g., subsequent TXOPs).

The resource allocator 730 may order the stations 720 for allocating RUs based on the RU sizes 876. For example, a next station of the stations 720 corresponds to a particular station having a particular RU size (e.g., a largest size) among the stations 720 (as indicated by the RU sizes 876).

The resource allocator 730 may determine that the station 704 corresponds to a next station of the stations 720 in response to determining that the RU sizes 876 indicate that the RU size 877 is a particular size (e.g., a largest size) among RU sizes corresponding to the stations 720. The resource allocator 730 may determine a first set of candidate RUs 962 and a second set of candidate RUs 964 based on the set of available RUs 860 and the channel quality threshold 930. For example, the resource allocator 730 includes one or more RUs of the set of available RUs 860 in the first set of candidate RUs 962 in response to determining that each of the one or more RUs has a CQ value that satisfies (e.g., is greater than or equal to) the channel quality threshold 930. To illustrate, the resource allocator 730 may include the RU 761 in the first set of candidate RUs 962 in response to determining that the CQ value 756 is greater than or equal to the channel quality threshold 930. The resource allocator 730 may include the remaining RUs of the set of available RUs 860 in the second set of candidate RUs 964. For example, each RU of the second set of candidate RUs 964 has a CQ value that fails to satisfy (e.g., is less than or equal to) the channel quality threshold 930. The first set of candidate RUs 962 may include RUs that have higher channel quality for the station 704, as compared to RUs of the second set of candidate RUs 964.

The resource allocator 730 may order each of the first set of candidate RUs 962 and the second set of candidate RUs 964 based on size. For example, the resource allocator 730 orders the first set of candidate RUs 962 and the second set of candidate RUs 964 in descending order according to size of the candidate RUs.

The resource allocator 730 may, in response to determining that the first set of candidate RUs 962 is non-empty and that the RU 761 corresponds to a next RU of the first set of candidate RUs 962, allocate the RU 761 to the station 704. In a particular aspect, the resource allocator 730 determines that one or more RUs of the first set of candidate RUs 962 have RU sizes that are greater than or equal to the RU size 877. The one or more RUs may include the RU 761. In this aspect, the resource allocator 730 determines that the RU 761 is a next RU of the first set of candidate RUs 962 in response to determining that the RU 761 has a particular size (e.g., a smallest RU size) among the RU sizes of the one or more RUs. In an alternative aspect, the resource allocator 730 determines that none of the first set of candidate RUs 962 has an RU size that is greater than or equal to the RU size 877. In this aspect, the resource allocator 730 determines that the RU 761 is a next RU of the first set of candidate RUs 962 in response to determining that the RU 761 has a particular RU size (e.g., a largest RU size) among the RU sizes of the first set of candidate RUs 962. The resource allocator 730 may remove the RU 761 from the set of available RUs 860 subsequent to allocation of the RU 761 to the station 704. The resource allocator 730 may, subsequent to allocation of the RU 761 to the station 704, also remove one or more RUs that overlap the RU 761 from the set of available RUs 860, as described with reference to FIG. 8. The resource allocator 730 may assign the MCS level 858 to the station 704 in response to determining that an RU (e.g., the RU 761) of the first set of candidate RUs 962 is allocated to the station 704. For example, the MCS level 758 corresponds to the MCS level 858. The MCS level 858 may correspond to a higher data rate that is suited for RUs having channel quality values that satisfy the channel quality threshold 930. The transceiver 734 may transmit a first notification indicating the MCS level 858 to the station 704. The transceiver 734 may transmit at least a portion of the first data 754 based on the MCS level 858, as described with reference to FIG. 7.

The resource allocator 730 may, in response to determining that the first set of candidate RUs 962 is empty and that the second set of candidate RUs 964 is non-empty, assign a second MCS level 958 to the station 704. For example, the MCS level 758 corresponds to the second MCS level 958. The second MCS level 958 may be lower than the MCS level 858. For example, the second MCS level 958 corresponds to a second data rate that is lower than a first data rate associated with the MCS level 858. The second data rate may be suited for RUs having channel quality values that fail to satisfy the channel quality threshold 930. The resource allocator 730 may update the RU size 877 based on the payload size 857 and the second MCS level 958 (e.g., RU size 877=payload size 857/second data rate). The resource allocator 730 may, in response to determining that a second RU corresponds to a next RU of the second set of candidate RUs 964, allocate the second RU to the station 704.

In a particular aspect, the resource allocator 730 determines that one or more RUs of the second set of candidate RUs 964 have RU sizes that are greater than or equal to the RU size 877. The one or more RUs may include the second RU. In this aspect, the resource allocator 730 determines that the second RU is a next RU of the second set of candidate RUs 964 in response to determining that the second RU has a particular size (e.g., a smallest RU size) among the RU sizes of the one or more RUs. In an alternative aspect, the resource allocator 730 determines that none of the second set of candidate RUs 964 has an RU size that is greater than or equal to the RU size 877. In this aspect, the resource allocator 730 determines that the second RU is a next RU of the second set of candidate RUs 964 in response to determining that the second RU has a particular RU size (e.g., a largest RU size) among the RU sizes of the second set of candidate RUs 964.

The resource allocator 730 may remove the second RU from the set of available RUs 860 subsequent to the allocation of the second RU to the station 704. The resource allocator 730 may, subsequent to the allocation of the second RU to the station 704, remove one or more RUs that overlap the second RU from the set of available RUs 860. The transceiver 734 may transmit a first notification indicating the second MCS level 958 to the station 704. The transceiver 734 may transmit at least a portion of the first data 754 to the station 704 based on the second MCS level 958, as described with reference to FIG. 7. The resource allocator 730 may thus allocate an RU with a channel quality value that does not exceed the channel quality threshold 930 in response to determining that no RUs with channel quality values equal to or exceeding the channel quality threshold 930 are available. Using lower channel quality RUs may reduce latency associated with exchanging data with the station 704 as compared to waiting for higher channel quality RUs to be available.

In a particular aspect, the resource allocator 730, in response to determining that the RU size 772 is less than the RU size 877, allocates one or more particular RUs (e.g., contiguous RUs) from the set of available RUs 860 to the station 704 until the set of available RUs 860 is empty or a sum of sizes of RUs allocated to the station 704 is greater than or equal to the RU size 877. The transceiver 734 may transmit the first notification indicating allocation of the one or more particular RUs to the station 704.

The resource allocator 730 may continue to iteratively allocate one or more RUs from the set of available RUs 860 to one or more of the stations 720, as described above, while the set of available RUs 860 is non-empty and a count of the stations 720 is greater than 0. For example, the resource allocator 730 allocates one or more RUs from the set of available RUs 860 to the station 705, similar to as described above.

The resource allocator 730 may thus allocate RUs to stations independently of channel quality gains while channel quality variation is less than or equal to a threshold variation. Allocating RUs independently of the channel quality gains may reduce resource utilization associated with determining the channel quality gains and may reduce latency associated with determining RU allocations.

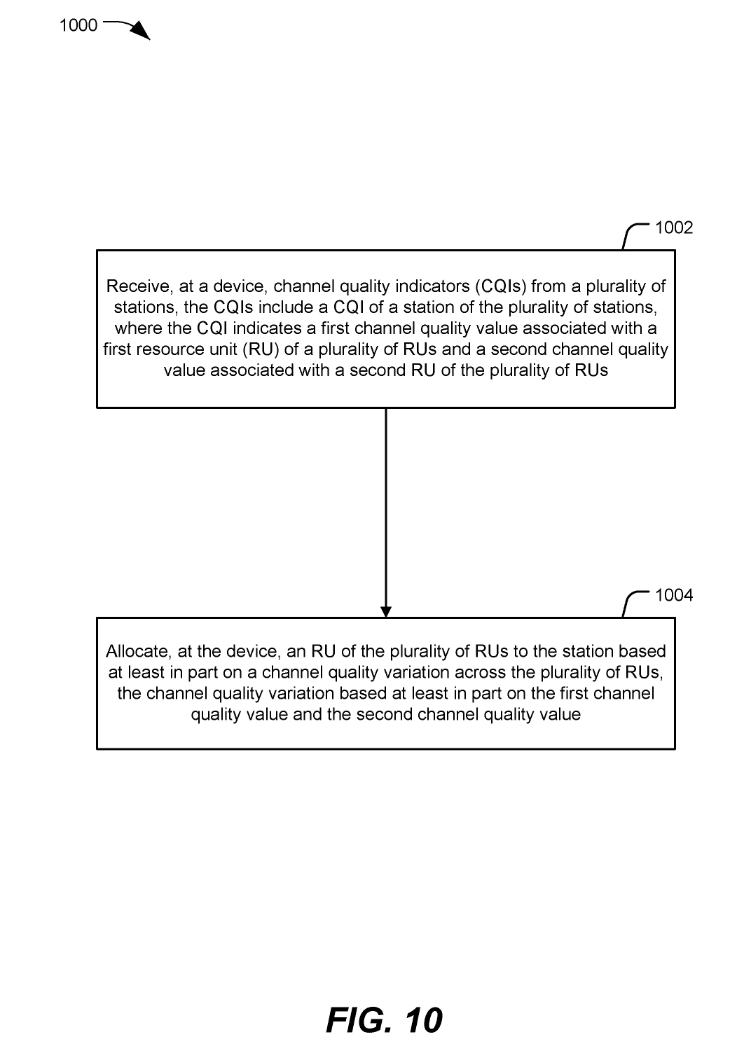

Referring to FIG. 10, a method of operation is shown and generally designated 1000. The method 1000 may be performed by the resource allocator 730, the transceiver 734, the access point 702, the system 700 of FIG. 7, or a combination thereof.

The method 1000 includes receiving, at a device, channel quality indicators (CQIs) from a plurality of stations, at 1002. For example, the access point 702 of FIG. 7 receives the CQIs 750 from the stations 703-705, as described with reference to FIG. 7. The CQIs 750 may include the CQI 755 of the station 704. The CQI 755 may indicate a plurality of channel quality values. For example, the CQI 755 indicates the channel quality value 756 associated with RU 761 and the channel quality value 757 associated with the RU 762, as described with reference to FIG. 7.

The method 1000 also includes allocating, at the device, an RU of the plurality of RUs to the station based at least in part on a channel quality variation across the plurality of RUs, at 1004. For example, the resource allocator 730 of FIG. 7 allocates the RU 761 to the station 704 based at least in part on the channel quality variation 722 across the plurality of RUs, as described with reference to FIG. 7. For example, the resource allocator 730 allocates the RU 761 to the station 704 using the first technique 763 (e.g., a channel quality gain technique) in response to determining that the channel quality variation 722 is greater than or equal to the variation threshold 723. As another example, the resource allocator 730 allocates the RU 761 to the station 704 using the second technique 764 (e.g., a channel quality threshold technique) in response to determining that the channel quality variation 722 is less than the variation threshold 723. The channel quality variation 722 may be based at least in part on the channel quality value 756 and the channel quality value 757.

The method 1000 may thus enable allocation of RUs based on the channel quality variation 722. A lower channel quality variation (e.g., less than or equal to a variation threshold) may indicate that channel quality values are substantially similar across the plurality of RUs. Allocation of any of the plurality of RUs to the station may result in substantially similar channel quality gains. A higher channel quality variation (e.g., greater than the variation threshold) may indicate that allocation of some RUs to the station may result in higher channel quality gains than allocation of other RUs to the station. RU allocation may be based on channel quality gains while the channel quality variation 722 is equal to or exceeds the variation threshold 723. Alternatively, RU allocation may be independent of the channel quality gains while the channel quality variation 722 does not exceed the variation threshold 723. By allocating RUs based on channel gains while the channel quality variation is high and based on threshold channel quality value while the channel quality variation is low, the access point may balance providing higher channel quality gains with reducing latency in allocating RUs.

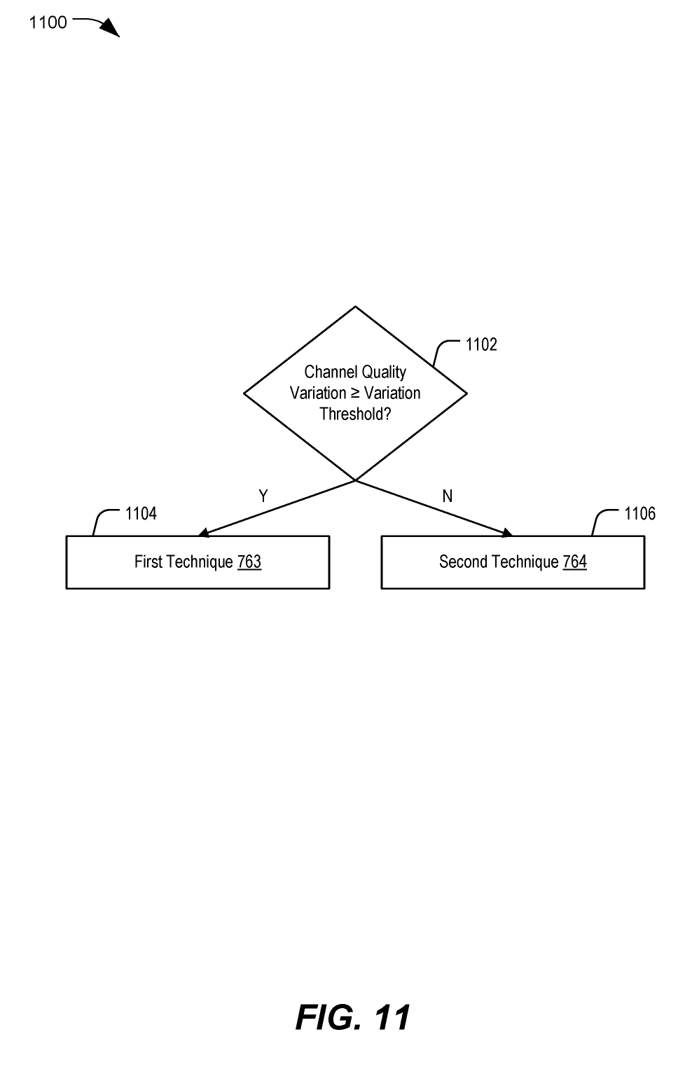

Referring to FIG. 11, a method of operation is shown and generally designated 1100. The method 1100 may be performed by the resource allocator 730, the transceiver 734, the access point 702, the system 700 of FIG. 7, or a combination thereof. In a particular aspect, the method 1100 corresponds to one or more operations performed at 1004 of FIG. 10.

The method 1100 includes determining whether a channel quality variation is greater than or equal to a variation threshold, at 1102. For example, the resource allocator 730 of FIG. 7 determines whether the channel quality variation 722 is greater than or equal to the variation threshold 723.

The method 1100 also includes, in response to determining that the channel quality variation is greater than or equal to the variation threshold, performing the first technique 763 (e.g., a channel quality gains technique), at 1104. For example, the resource allocator 730 of FIG. 7 performs the first technique 763 in response to determining that the channel quality variation 722 is greater than or equal to the variation threshold 723, as described with reference to FIGS. 7-8.

The method 1100 also includes, in response to determining that the channel quality variation is less than the variation threshold, performing the second technique 764, at 1106. For example, the resource allocator 730 of FIG. 7 performs the second technique 764 (e.g., a channel quality threshold technique) in response to determining that the channel quality variation 722 is less than the variation threshold 723, as described with reference to FIGS. 7 and 9.

The method 1100 may thus enable allocation of RUs based on the channel quality variation 722. RU allocation (corresponding to the first technique 763) may be based on channel quality gains while the channel quality variation 722 is equal to or exceeds the variation threshold 723. Alternatively, RU allocation (corresponding to the second technique 764) may be independent of the channel quality gains while the channel quality variation 722 does not exceed the variation threshold 723. By allocating RUs based on channel gains while the channel quality variation is high and based on threshold channel quality value while the channel quality variation is low, the access point may balance providing higher channel quality gains with reducing latency in allocating RUs.

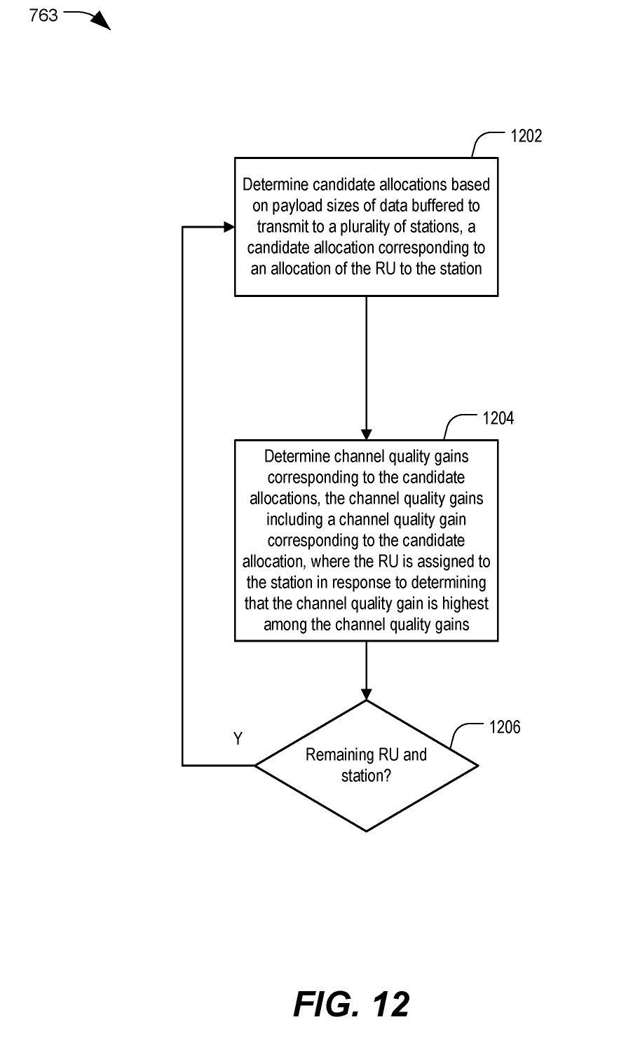

FIG. 12 depicts one or more illustrative aspects of the first technique 763. The first technique 763 may be performed by the resource allocator 730, the access point 702, the system 700 of FIG. 7, or a combination thereof.

The first technique 763 includes determining candidate allocations based on payload sizes of data buffered to transmit to a plurality of stations, at 1202. For example, the resource allocator 730 of FIG. 7 determines the CAs 824 based on the set of available RUs 860 and the payload sizes 856 of data buffered for transmission to the stations 720, as described with reference to FIG. 8. The CAs 824 may include the CA 825 indicating an allocation of the RU 761 to the station 704, as described with reference to FIG. 8.

The first technique 763 also includes determining channel quality gains corresponding to the candidate allocations, at 1204. For example, the resource allocator 730 of FIG. 7 determines the CQ gains 826 corresponding to the candidate allocations 824, as described with reference to FIG. 8. The CQ gains 826 may include the CQ gain 827 corresponding to the CA 825. The resource allocator 730 may assign the RU 761 to the station 704 in response to determining that the CQ gain 827 is highest among the CQ gains 826. The resource allocator 730 may, subsequent to assigning the RU 761 to the station 704, remove the RU 761 from the set of available RUs 860, remove one or more RUs overlapping the RU 761 from the set of available RUs 860, remove the station 704 from the stations 720, or a combination thereof, as described with reference to FIG. 8.

The first technique 763 further includes determining whether there is at least one RU and at least one station remaining, at 1206. For example, the resource allocator 730 of FIG. 7 determines whether the set of available RUs 860 is non-empty and whether the count of the stations 720 is greater than 0, as described with reference to FIG. 8. In response to determining that there is at least one RU and at least one station remaining, the first technique 763 proceeds to 1202. The first technique 763 ends responsive to determining that no RUs or no stations remain.

The first technique 763 may enable RU allocation based on channel quality gains. RU allocation based on higher channel quality gains may result in fewer transmission errors, less communication overhead associated with re-transmissions, etc.

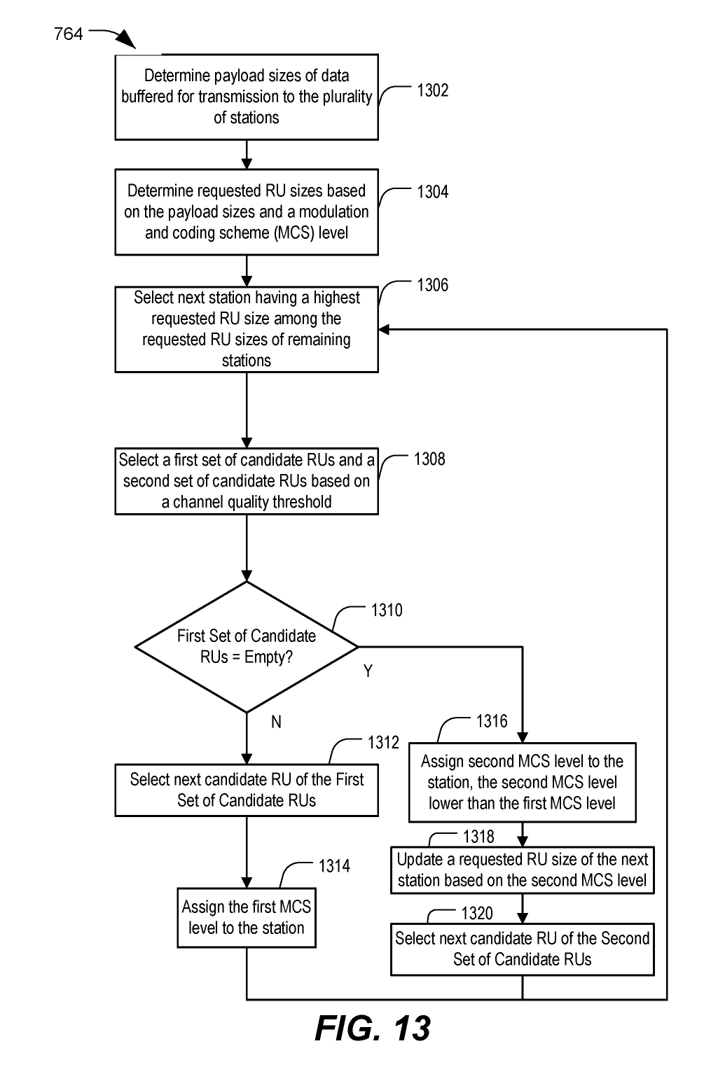

FIG. 13 depicts one or more illustrative aspects of the second technique 764. The second technique 764 may be performed by the resource allocator 730, the access point 702, the system 700 of FIG. 7, or a combination thereof.

The second technique 764 includes determining payload sizes of data buffered for transmission to the plurality of stations, at 1302. For example, the resource allocator 730 of FIG. 7 determines the payload sizes 856 of data buffered for transmission to the stations 720, as described with reference to FIGS. 8-9. Determining the payload sizes 856 may include determining payload sizes of particular data buffered for transmission to one or more of the stations 720. For example, the resource allocator 730 determines a first payload size of the first data 754 buffered for transmission to the station 704. The payload sizes 856 may indicate (e.g., include) the first payload size.

The second technique 764 also includes determining requested RU sizes based on the payload sizes and a modulation and coding scheme (MCS) level, at 1304. For example, the resource allocator 730 of FIG. 7 determines the RU sizes 876 (e.g., requested RU sizes) based on the payload sizes 856 and the MCS level 758, as described with reference to FIGS. 8-9.

The second technique 764 further includes selecting a next station having a highest requested RU size among the requested RU sizes of remaining stations, at 1306. For example, the resource allocator 730 of FIG. 7 selects a next station (e.g., the station 704) having a highest requested RU size (e.g., RU size 877) among requested RU sizes of the stations 720, as described with reference to FIG. 9. To illustrate, the resource allocator 730 may select the station 704 as a next station in response to determining that the RU size 877 is highest among the RU sizes 876 associated with the stations 720.

The second technique 764 also includes selecting a first set of candidate RUs and a second set of candidate RUs based on a channel quality threshold, at 1308. For example, the resource allocator 730 of FIG. 7 selects the first set of candidate RUs 962 and the second set of candidate RUs 964 based on the channel quality threshold 930, as described with reference to FIG. 9.

The second technique 764 further includes determining whether the first set of candidate RUs is empty, at 1310. For example, the resource allocator 730 of FIG. 7 determines whether the first set of candidate RUs 962 is empty.

The second technique 764 includes, in response to determining that the first set of candidate RUs is not empty, selecting a next candidate RU of the first set of candidate RUs, at 1312. For example, the resource allocator 730 of FIG. 7, in response to determining that the first set of candidate RUs 962 is not empty, selects a next candidate RU of the first set of candidate RUs 962, as described with reference to FIG. 9. To illustrate, the resource allocator 730 may select the RU 761 as the next candidate RU in response to determining that one or more RUs of the first set of candidate RUs 962 have a size that is greater than or equal to the RU size 877, that the one or more RUs include the RU 761, and that the RU 761 has the smallest size (e.g., the RU size 772) among the one or more RUs. Alternatively, the resource allocator 730 may select the RU 761 as the next candidate RU in response to determining that none of the first set of candidate RUs 962 have a size that is greater than or equal to the RU size 877 and that the RU 761 has a largest size (e.g., RU size 772) among the first set of candidate RUs 962. The resource allocator 730 may assign the next candidate RU (e.g., the RU 761) to the station 704. The resource allocator 730 may, subsequent to assigning the RU 761 to the station 704, remove the RU 761 from the set of available RUs 860, remove one or more RUs that overlap the RU 761 from the set of available RUs 860, remove the station 704 from the stations 720, or a combination thereof, as described with reference to FIG. 9.

The second technique 764 also includes assigning the first MCS level to the station, at 1314. For example, the resource allocator 730 of FIG. 7 assigns the MCS level 858 to the station 704, as described with reference to FIG. 9. After assigning the MCS level 858 to the station 704, the second technique 764 proceeds to 1306.

The second technique 764 includes, in response to determining that the first set of candidate RUs is empty, assigning a second MCS level to the station, at 1316. For example, the resource allocator 730 of FIG. 7 assigns the second MCS level 958 to the station 704, as described with reference to FIG. 9. The second MCS level 958 may be lower than the MCS level 858.

The second technique 764 also includes updating a requested RU size of the next station based on the second MCS level, at 1318. For example, the resource allocator 730 of FIG. 7 updates the RU size 877 associated with the station 704 based on the second MCS level 958, as described with reference to FIG. 9.

The second technique 764 further includes selecting a next candidate RU of the second set of candidate RUs, at 1320. For example, the resource allocator 730 of FIG. 7 selects a next candidate RU (e.g., the RU 761) of the second set of candidate RUs 964, as described with reference to FIG. 9. To illustrate, the resource allocator 730 may select the RU 761 as the next candidate RU in response to determining that one or more RUs of the second set of candidate RUs 964 have a size that is greater than or equal to the RU size 877, that the one or more RUs include the RU 761, and that the RU 761 has the smallest size (e.g., the RU size 772) among the one or more RUs. Alternatively, the resource allocator 730 may select the RU 761 as the next candidate RU in response to determining that none of the second set of candidate RUs 964 have a size that is greater than or equal to the RU size 877 and that the RU 761 has a largest size (e.g., RU size 772) among the second set of candidate RUs 964. The resource allocator 730 may assign the next candidate RU (e.g., the RU 761) to the station 704. The resource allocator 730 may, subsequent to assigning the RU 761 to the station 704, remove the RU 761 from the set of available RUs 860, remove one or more RUs that overlap the RU 761 from the set of available RUs 860, remove the station 704 from the stations 720, or a combination thereof, as described with reference to FIG. 9. After selecting the next candidate RU of the second set of candidate RUs 964, the second technique 764 proceeds to 1306. The second technique 764 may end responsive to determining that a count of stations 720 is equal to 0. The second technique 764 may end responsive to determining that each of the first set of candidate RUs 962 and the second set of candidate RUs 964 is empty.

The second technique 764 may enable RU allocation based on the channel quality threshold 930. RUs associated with channel quality values exceeding the channel quality threshold 930 may be assigned to stations corresponding to buffered data with larger payloads. RUs associated with lower channel quality values (e.g., not exceeding the channel quality threshold 930) may be assigned subsequent to assignment of RUs associated with higher channel quality values (e.g., equal to or exceeding the channel quality threshold 930). Thus, the second technique 764 may prioritize allocation of RUs associated with higher channel quality values for transmission of data having larger payloads which balances data transmission quality and latency.

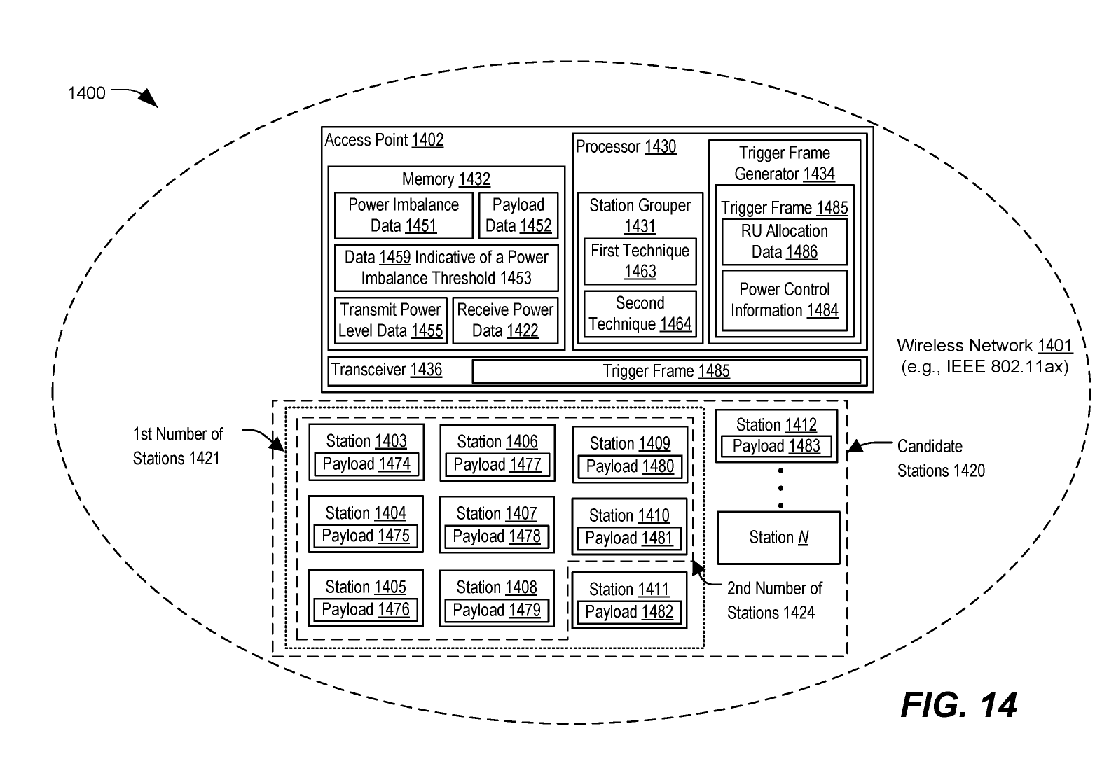

FIGS. 14-19 illustrate OFDMA grouping. Stations may be grouped for uplink transmission based on payload constraints of the stations and based on power imbalance tolerance capability of an access point. In a particular example, the station grouping is performed subsequent to selection of the OFDMA mode from a plurality of communication modes. In a particular aspect, the plurality of communication modes includes the OFDMA mode 160 and the MU-MIMO mode 162, as described with reference to FIGS. 1-6. In an alternative aspect, the plurality of communication modes includes the OFDMA mode 160, the MU-MIMO mode 162, another communication mode, or a combination thereof. In a particular example, the station grouping is performed independently of a selection of the OFDMA mode. For example, the OFDMA mode corresponds to a configuration setting, a user input, a default setting, or a combination thereof.

Referring to FIG. 14, a particular illustrative aspect of a system 1400 operable to group stations into an OFDMA station group is shown. For example, the system 1400 is operable to group stations into an OFDMA station group for uplink transmission while respecting payload constraints of the stations and power imbalance tolerance capability of an access point. The system 1400 includes a plurality of devices configured to communicate via a wireless network 1401. In FIG. 14, the system 1400 includes an access point 1402 and N stations (STAs) 1403, 1404, 1405, 1406, 1407, 1408, 1409, 1410, 1411, 1412 . . . N. The N stations 1403, 1404, 1405, 1406, 1407, 1408, 1409, 1410, 1411, 1412 . . . N may be collectively referred to as a set of candidate stations 1420. It is to be understood that in alternative aspects, the system 1400 includes a different number of electronic devices, access points, and/or stations.

The access point 1402 may include a processor 1430, a memory 1432, and a transceiver 1436 configured to communicate via the wireless network 1401. Although the transceiver 1436 is shown, in alternative aspects separate transmitter(s) and receiver(s) are included.

The use of OFDMA may enable multiple devices to, simultaneously or at least partially simultaneously, communicate data in multiple directions. In accordance with OFDMA principles, to mitigate interference, each of the devices may be assigned a specific set of frequencies on which to communicate. As an example, the access point 1402 is configured to receive an UL OFDMA transmission in which different groups of frequency subcarriers (e.g., RUs) carry data transmitted by different stations (e.g., of the set of candidate stations 1420) in an OFDMA station group.

The access point 1402 may be able to reliably process transmissions from multiple users when the received power imbalance of the transmissions from the multiple users is sufficiently low (e.g., when a variance of the received power across the multiple users is less than a particular amount). When the received power imbalance of the transmissions from the multiple users is relatively high, the access point 1402 may be unable to reliably process some of the transmissions (e.g., transmissions that have a relatively low received power). The memory 1432 may store information used by the processor 1430 to group stations of the set of candidate stations 1420 into an OFDMA station group.

For example, the information stored by the memory 1432 includes data 1459 indicative of a power imbalance threshold 1453. The power imbalance threshold 1453 may be indicative of an amount of received power imbalance (of transmissions from stations of an OFDMA station group) that the access point 1402 can tolerate, such as an amount of received power imbalance below which the access point 1402 is able to reliably process the transmissions from the stations of the OFDMA station group. For example, when the power imbalance of an OFDMA station group is greater than the power imbalance threshold 1453, the access point 1402 is unable to reliably process the transmissions from at least some stations of the OFDMA station group. Alternatively or additionally, when the power imbalance of the OFDMA station group is less than the power imbalance threshold 1453, the access point 1402 may be able to reliably process the transmissions from all stations of the OFDMA station group. Thus, the power imbalance threshold 1453 may be based on or may be indicative of an amount of power imbalance that the access point 1402 is able to tolerate (e.g., the power imbalance threshold 1453 may be based on or indicative of a power imbalance tolerance of the access point 1402).

The information stored by the memory 1432 may include payload data 1452 indicating a size of a payload of each station of the set of candidate stations 1420. For example, the payload data 1452 is indicative of a size of a payload 1474 of the station 1403, a payload 1475 of the station 1404, a payload 1476 of the station 1405, a payload 1477 of the station 1406, a payload 1478 of the station 1407, a payload 1479 of the station 1408, a payload 1480 of the station 1409, a payload 1481 of the station 1410, a payload 1482 of the station 1411, a payload 1483 of the station 1412, or a payload of the Station N. In a particular aspect, the access point 1402 has received information regarding uplink payloads of stations from the stations in one or more previous uplink communication.

The information stored by the memory 1432 may additionally include receive power data 1422 indicative of a receive power for each station of the set of candidate stations 1420. For example, the receive power data 1422 includes a receive signal strength indication (RSSI) for each station of the set of candidate stations 1420, which in some aspects is determined based on previous uplink communications received by the access point 1402 from the stations.

The information stored by the memory 1432 may additionally include transmit power level data 1455. The transmit power level data 1455 may be indicative of a transmit power used by the station.

The information stored by the memory 1432 may additionally include power imbalance data 1451. The power imbalance data 1451 may be indicative of a power imbalance of a group of stations. The power imbalance for a group of stations may be determined based on the received power data 1422. For example, the power imbalance of a particular group of stations corresponds to a range, window, or amount of variance of the received power across the particular group of stations as determined based on the received power data 1422 for the particular group of stations.

The processor 1430 include a station grouper 1431 (e.g., heuristic-based station grouper) configured to group the one or more stations of the set of candidate stations 1420 into an OFDMA station group using a first technique (e.g., an illustrative first technique 1463) or a second technique (e.g., an illustrative second technique 1464) based on whether the power imbalance of the set of candidate stations 1420 satisfies the power imbalance threshold 1453. The processor 1430 may be configured to determine a power imbalance of the set of candidate stations 1420 based on the power imbalance data 1451. The processor 1430 may compare the power imbalance of the set of candidate stations 1420 to the power imbalance threshold 1453. When the power imbalance of the set of candidate stations 1420 satisfies (e.g., is greater than) the power imbalance threshold 1453, the processor 1430 may determine the OFDMA station group using the first technique. Alternatively or additionally, when the power imbalance of the set of candidate stations 1420 does not satisfy (e.g., is less than) the power imbalance threshold 1453, the processor 1430 may determine the OFDMA station group using the second technique.

First Technique

The first technique may be performed by iterating through a set of stages/operations/steps until a particular group of stations considered (for selection as the OFDMA station group) during an iteration satisfies a power imbalance threshold check described in more detail below. Each iteration evaluates a particular group of stations having a different size (a different number of stations) than the particular group of stations of each other iteration through the stages of the first technique. The number of stations evaluated during an iteration is referred to as the “particular number” for the iteration. The particular number for a first iteration through the stages of the first technique may be referred to as a first number and a particular number for a subsequent iteration may be referred to as a second number. In some examples, the first number is greater than the second number. In some examples, each iteration through the stages of the first technique uses a lower particular number (e.g., may use a smaller prospective group size) than the preceding iterations.

In some examples, the particular number for a first iteration through the stages of the first technique, e.g., the first number, corresponds to a largest number of frequency subcarrier groups (e.g., the largest number of RUs) that a frequency channel can accommodate according to a wireless networking protocol. For example, the wireless network 1401 operates in accordance with an IEEE 802.11ax wireless networking protocol or specification. According to the IEEE 802.11ax wireless networking protocol, RU sizes may be limited to the following finite list of sizes: 26 frequency subcarriers, 52 frequency subcarriers, 106 frequency subcarriers, 242 frequency subcarriers, 484 frequency subcarriers, or 996 frequency subcarriers. A 20 megahertz (MHz) wireless channel may accommodate up to one RU-242, two RU-106s, four RU-52s, or 9 RU-26s. A 40 MHz wireless channel may accommodate up to one RU-484, two RU-242s, four RU-106s, eight RU-52s, or eighteen RU-26s. An 80 MHz wireless channel may accommodate up to one RU-996, two RU 484s, four RU-242s, eight RU-106s, sixteen RU-52s, or thirty-seven RU-26s, where the thirty-seventh RU-26 is “split” across the two 40 MHz sub-channels of the 80 MHz channel.

Thus, when the access point 1402 uses a 20 MHz wireless channel, the largest number of RUs that the 802.11ax wireless networking protocol allows is nine RUs (of size 26). In this example, the first number therefore corresponds to nine. Alternatively, when the access point 1402 uses a 40 MHz channel, the largest number of RUs that the 802.11ax wireless networking protocol allows is eighteen RUs (of size 26). In this example, the first number therefore corresponds to eighteen. Alternatively, when the access point 1402 uses an 80 MHz channel, the largest number of RUs that the 802.11ax wireless networking protocol allows is thirty seven RUs (of size 26). In this example, the first number therefore corresponds to thirty seven. The second number may correspond to the first number minus one (e.g., 9−1=8, 18−1=17, or 37−1=36).

The stages of the first technique may include an RU size determination stage. The RU size determination stage may include determining an RU size for each station of the set of candidate stations 1420 or for each station of a prospective group of stations considered during the iteration through the stages of the first technique. Determining the RU size for a station may include determining an RU size cap for the station.

In some examples, the RU size cap is determined based on the frequency channel and the particular number (corresponding to the prospective group size) for the iteration through the stages of the first technique. For example, the RU size cap corresponds to a bandwidth determined by dividing a bandwidth of the frequency channel used by the access point 1402 by the particular number (e.g., the first number, the second number . . . etc.) for the iteration.

To illustrate, the particular number (e.g., the first number) for a first iteration through the stages of the first technique when using a 20 MHz channel in an IEEE 802.11ax wireless network may correspond to nine as described above, and the RU size cap may correspond to 20 MHz divided by nine (e.g., 20 MHz/9=2.222 MHz). As another example, the first number when using a 40 MHz channel in an IEEE 802.11ax wireless network corresponds to eighteen as described above, and the RU size cap may correspond to 40 MHz divided by 18 (e.g., 40 MHz/18=2.222 MHz). As another example, the first number when using a 40 MHz channel in an IEEE 802.11ax wireless network corresponds to thirty seven as described above, and the RU size cap may correspond to 80 MHz divided by 37 (e.g., 80 MHz/37=2.16 MHz).

As another example, the particular number (e.g., the second number) for a second iteration through stages of the first technique when using a 20 MHz channel in an IEEE 802.11ax wireless network corresponds to 8 as described above, and the RU size cap corresponds to 20 MHz divided by eight (e.g., 20 MHz/8=2.5 MHz). As another example, the second number when using a 40 MHz channel in an IEEE 802.11ax wireless network corresponds to 17 as described above, and the RU size cap may correspond to 40 MHz divided by 17 (e.g., 40 MHz/17=2.353 MHz). As another example, the second number when using an 80 MHz channel in an IEEE 802.11ax wireless network corresponds to 36 as described above, and the RU size cap may correspond to 80 MHz divided by 36 (e.g., 80 MHz/36=2.222 MHz).

Alternatively or additionally, the RU size cap for a station and for a particular iteration through the stages of the first technique may be determined based on payloads of stations of the group of stations being considered for the iteration. For example, the RU size cap for a station corresponds to a portion (of the channel bandwidth) corresponding to the ratio of a payload of the station to the cumulative payloads of the other stations of the group of stations being considered. In some examples, the group of stations considered during an iteration through the stages of the first technique is identified in a prospective group identification stage described in more detail below, and the RU determination stage is performed subsequent to the prospective group identification stage.

To illustrate, the group of stations being considered for a first iteration through the stages of the first technique may correspond to the first number of stations 1421, and the RU size cap for a station of the first number of stations 1421 may correspond to the payload of the station divided by the sum of the payloads of the other stations of the first number of stations 1421. For example, the RU size cap for the station 1403 corresponds to the bandwidth of the frequency channel times the ratio of the payload 1474 to the sum of the payloads 1475, 1476, 1477, 1478, 1479, 1480, 1481, and 1482. Thus, the RU size cap may increase for each successive iteration through the first technique.

The RU size determination stage may further include determining, for each station of the set of candidate stations 1420 or for each station of the group of stations being considered during the iteration through the stages of the first technique, a smallest RU size (within the RU size cap for the station) that can support the payload for the station. The processor 1430 may determine whether a payload of a station can be supported by the smallest RU size that can be accommodated by a wireless networking protocol. When the smallest RU size can support the payload for a station, the smallest RU size is selected as the RU size of the station. When the smallest RU size cannot support the payload for a station, the processor 1430 may determine whether a next largest RU size accommodated by the wireless networking protocol is within the RU size cap. When the next largest RU size accommodated by the wireless networking protocol is not within the RU size cap, the processor 1430 may select the most recently evaluated RU size (e.g., the smallest RU size). When the next largest RU size accommodated by the wireless networking protocol is within the RU size cap, the processor 1430 may evaluate whether the next largest RU size supports the payload for the station.

In some examples, the access point 1402 determines, for each station, whether an RU size can support the payload of the station by calculating a received signal to noise ratio (SNR) based on the station's link budget and power boost associated with the RU size. For example, such a determination includes determining a data rate (or MCS index or data rate gain) for the station when using the RU size, and determining whether the determined data rate (and/or the associated data rate gains) can support the payload for the station. The data rate (or MCS index or data rate gain) for the station when using the RU size may be based on the power spectrum density boost (or power spectrum density boost gain) experienced by the station when using the RU size. Thus, the RU size may be determined for the station based on the data rate gains that the power spectrum density boost provides the station when using the RU size.

To illustrate using an 802.11ax wireless networking protocol, as explained above, the smallest RU size that can be accommodated may correspond to an RU size of 26 frequency subcarriers. Thus, the processor 1430 may determine, for each station of the set of candidate stations 1420 or for each station of the group of stations being considered during the iteration, whether an RU size of 26 can support the payload of the station.

When the RU size of 26 can support the payload for the station, the RU size for the station is determined to be 26. When the RU size of 26 cannot support the payload for the station, the processor 1430 may determine whether the next largest RU size (e.g., an RU size of 52) is within the RU size cap. For example, the RU size cap corresponds to 5 MHz as described above, and the processor 1430 may thus determine that the RU size of 52 fits within the RU size cap. Alternatively, the RU size cap may correspond to 2.222 MHz as described above, and the processor 1430 may thus determine that the RU size of 52 does not fit within the RU size cap.

When the RU size of 52 fits within the RU size cap (e.g., when the RU size cap is 5 MHz), the processor 1430 may evaluate whether the RU size of 52 supports the payload of the station. When the RU size of 52 supports the payload of the station, the RU size of 52 is selected for the station. When the RU size of 52 does not support the payload, the processor 1430 determines whether a next largest RU size (e.g., 106) fits within the RU size cap and evaluates based on the determination. For example, because the RU size of 106 cannot fit within the example RU size caps (e.g., 5 MHz or 2.222 MHz), when the processor 1430 determines that the RU size of 52 cannot support the payload, the processor 1430 selects the RU size of 52 as the RU size for the station.

The RU size determination stage may thus determine an RU size for a station based on payload considerations. The RU size determination stage attempts to identify a smallest RU size that will support the payload while also considering other stations that will use the channel (e.g., while using an RU size cap).

The stages of the first technique may further include a prospective group identification stage to identify a particular group of stations having a size corresponding to the particular number for the iteration through the stages of the first technique. The prospective group identification stage may be performed prior to or subsequent to the RU size determination stage. The prospective group identification stage may include identifying the particular number (for the iteration through the stages of the first technique) of stations that have a lowest expected receive power.

To illustrate, during a first iteration through the stages of the first technique for an upcoming 20 MHz uplink transmission, the particular number may correspond to nine as described above, and the prospective group identification stage may thus include identifying nine stations that have the lowest expected receive power. As another example, during a second iteration through the stages of the first technique, the particular number corresponds to eight and the prospective group identification stage includes identifying eight stations that have the lowest expected receive power.

The access point 1402 may be configured to identify the particular number of the set of candidate stations 1420 that have the lowest receive power based on the receive power data 1422. For example, during a first iteration through the stages of the first technique, the processor 1430 compares the receive power of each station of the set of candidate stations 1420 to identify the first number of stations that have the lowest receive power.

To illustrate, the processor 1430 may access the receive power data 1422 to determine an expected receive power for each station of the set of candidate stations 1420 and may analyze the expected receive power for each station of the set of candidate stations 1420 to identify the nine stations of the set of candidate stations 1420 that have the lowest expected receive power. In this example, the processor 1430 determines that the stations 1403, 1404, 1405, 1406, 1407, 1408, 1409, 1410, and 1411 are the nine stations having the lowest expected receive power out of the stations of the set of candidate stations 1420. Thus, in this example, the first number of stations 1421 corresponds to the nine stations 1403, 1404, 1405, 1406, 1407, 1408, 1409, 1410, and 1411.

The stages of the first technique may further include a power imbalance tolerance check stage. The power imbalance tolerance check stage may be performed subsequent to the prospective group identification stage. The power imbalance tolerance check stage may include performing one or more power imbalance tolerance checks on the particular number of stations according to Equation 2 (e.g., may be performed by determining whether the inequality of Equation 2 holds).

$${R}_{ADC}^{dB} - 10 log 10 ( 1 + {\sum }_{i \neq k}^{ } {10}^{0.1 \times {Δ RSS I}_{i , k}^{dB}} ) + 10 log 10 ( {N}_{rx} ) \geq {RSSI}_{k}^{sens .} + {TL}_{k}^{impair} + {TPC}_{k}^{dB} \qquad Equation 2$$

In Equation 2, R_{ADC}^{dB} corresponds to a dynamic range of the access point in decibels (dB), ΔRSSI_{i,k}^{dB} corresponds to a difference in RSSI for station i and station k, where station k is a station having the lowest RSSI (out of the particular number of stations being considered for the iteration), Nrx corresponds to a number of reception chains, RSSIₖ^{sens.} corresponds to an RSSI of the station k, TLₖ^{impair} corresponds to a tolerance loss impairment of the station k, and TPCₖ^{dB} corresponds to a maximum transmission power control error of the station k. In some examples, the access point 1402 uses close loop power control to offset or compensate for a TPC error observed for each station based on the RSSI measured for each station.

The power imbalance tolerance checks may be performed (e.g., according to Equation 2) on the particular number of stations identified during the prospective group identification stage using different transmit power levels until the particular number of stations identified during the prospective group identification stage satisfy the power imbalance tolerance check or until the transmit power levels cannot be further adjusted.

For example, when the particular number of stations do not satisfy the power imbalance tolerance check using first particular transmit power levels, the power imbalance tolerance check stage includes determining whether the transmit power levels can be reduced. In some examples, the transmit power level adjustment that can be applied to a station is limited based on a minimum and maximum transmit power level of the station. Alternatively or additionally, the transmit power level of a station may not be lowered beyond a transmit power level enables the station to perform at a particular MCS while having minimum interference to the other stations.

When the transmit power levels can be reduced, the power imbalance tolerance check stage may include performing an additional (e.g., a second) power imbalance tolerance check using adjusted transmit power levels. In some examples, the processor 1430 reduces the transmit power of the station having the highest RSSI. Reducing the transmit power level of a station other than the station having the lowest RSSI will reduce a value of ΔRSSI_{i,k}^{dB} of Equation 2 for that station, thereby increasing the value of the left side of the inequality of Equation 2 compared to the value of the left side of the inequality of Equation 2 using the first transmit power levels. The processor 1430 may continue to iterate through the power imbalance tolerance checks using adjusted transmit power levels of one or more stations of the particular number of stations until the particular number of stations satisfy the power imbalance tolerance check or until the transmit power levels may not be further adjusted as prescribed by the limits described above.

In a particular aspect, when the particular number of stations have not satisfied the power imbalance tolerance check and no further adjustments to the transmit power levels may be made, the processor 1430 iterates through replacing one of the particular number of stations with another station, adjusting a MCS level of one of the particular number of stations, or both. For example, the processor 1430 replaces one of the particular number of stations with another station of the set of candidate stations 1420. As another example, the processor 1430 adjusts (e.g., reduces) a MCS level of one of the particular number of stations. The processor 1430 may, subsequent to replacing a station or adjusting a MCS level, perform the power imbalance tolerance check, transmit power level adjustments, or a combination thereof.

When the particular number of stations have not satisfied the power imbalance tolerance check and no further adjustments to the transmit power levels, the stations, or the MCS levels may be made, the processor 1430 may perform a subsequent iteration of the first technique using a different particular number (e.g., corresponding to a different prospective group size). When the particular number of stations satisfy the power imbalance tolerance check, the processor 1430 may select the particular number of stations as the one or more stations of the OFDMA station group.

To illustrate, when the particular number of stations corresponds to the first number of stations 1421, the processor 1430 may perform a first power imbalance tolerance check using first transmit power levels. When the first number of stations 1421 satisfy the power imbalance tolerance check using the first transmit power levels, the first number of stations 1421 may be selected as the one or more stations of the OFDMA station group. When the particular number of stations do not satisfy the power imbalance tolerance check using the first transmit power levels, the power imbalance tolerance check stage may include determining whether the transmit power levels can be reduced. When no further adjustments may be made to the transmit power levels, a second iteration of the first technique may be performed using the second number of stations 1424. When further adjustments can be made to the transmit power levels, a second power imbalance tolerance check may be performed by reducing a transmit power level of one or more stations of the first number of stations 1421 (other than the station having the lowest RSSI, i.e., station k).

In some examples, the particular number of stations that satisfied the power imbalance tolerance check do not fill an OFDMA frame. In these examples, the first technique further includes selecting additional stations and applying transmit power reduction and MCS reduction to the additional stations. As an example, the first technique determines that the second number of stations 1424 satisfy the power imbalance tolerance check and that the second number of stations 1424 do not completely fill an OFDMA frame. In this example, the first technique includes selecting one or more remaining stations of the set of candidate stations (e.g., may select one or more of the stations 1411, 1412, or Station N) and reducing the transmit power and/or MCS level of the one or more remaining stations until the power imbalance tolerance check is satisfied. In this example, one or more stations of the OFDMA station group would include the second number of stations 1424 and the selected one or more remaining stations of the set of candidate stations 1420.

The first technique may further include generating, for example by a trigger frame generator 1434, an OFDMA trigger frame 1485 for transmission to each station of the OFDMA station group. The OFDMA trigger frame 1485 may include power control information 1484 and/or RU allocation information 1486 for each station of the OFDMA station group. The power control information 1484 may include information instructing the stations of the OFDMA station group to employ particular transmit power levels corresponding to power levels at which the stations of the OFDMA station group satisfied the power imbalance tolerance check. For example, when the stations of the OFDMA station group correspond to the first number of stations 1421, and the first number of stations 1421 satisfied the power imbalance tolerance check using the first transmit power levels, the processor 1430 generates the OFDMA trigger frame 1485 to transmit to the first number of stations 1421 and the power control information 1484 included in the OFDMA trigger frame 1485 may instruct the stations of the first number of stations 1421 to use transmit power levels corresponding to or based on the first transmit power levels. As another example, when the stations of the OFDMA station group correspond to the first number of stations 1421, and the first number of stations 1421 satisfied the power imbalance tolerance check using the one or more adjusted transmit power levels, the processor 1430 generates the OFDMA trigger frame 1485 to transmit to the first number of stations 1421 and the power control information 1484 included in the OFDMA trigger frame 1485 instructs the stations of the first number of stations 1421 to use transmit power levels corresponding to or based on the one or more adjusted transmit power levels.

Second Technique

The second technique may include performing a set of stages/operations/steps. The stages of the second technique may include an RU determination stage. The RU size determination stage may include determining an RU size for each station of the set of candidate stations 1420. Determining the RU size for a station may include determining, for each station of the set of candidate stations 1420, a smallest RU size that can support the payload for the station. The processor 1430 may determine whether a payload of a station can be supported by the smallest RU size that can be accommodated by a wireless networking protocol. When the smallest RU size can support the payload for a station, the smallest RU size is selected as the RU size of the station. When the smallest RU size cannot support the payload for a station, the processor 1430 may determine whether a next largest RU size accommodated by the wireless networking protocol will support the payload for the station. When none of the RU sizes accommodated by the wireless networking protocol support the payload of the station, the largest RU size accommodated by the wireless networking protocol is selected as the RU size for the station.

The stages of the second technique may also include a grouping stage. The grouping stage may include allocating RUs of a channel to stations of the set of candidate stations 1420 until the RUs of the channel are fully allocated. The stations of the set of candidate stations 1420 to which RUs of the channel are allocated correspond to the one or more stations of the OFDMA station group. In some examples, the RUs are allocated based on a padding level of the stations or based on a power boost gain of the stations. For example, in some aspects, the access point 1402 allocates RUs to stations that have the least padding. Alternatively or additionally, in some aspects, the access point 1402 allocates RUs to stations that have the highest power boost gain.

The stages of the second technique may further include a power imbalance tolerance check stage. The power imbalance tolerance check stage may include performing one or more power imbalance tolerance checks on the OFDMA station group (identified during the grouping stage) according to Equation 2 (e.g., may be performed by determining whether the inequality of Equation 2 holds). The power imbalance tolerance checks may be performed (e.g., according to Equation 2) on the OFDMA station group identified during the grouping stage using different transmit power levels until the OFDMA station group identified during the grouping stage satisfies the power imbalance tolerance check.

For example, when the OFDMA station group does not satisfy the power imbalance tolerance check using first particular transmit power levels, the transmit power levels are reduced and a subsequent power imbalance tolerance check is performed on the OFDMA station group using the reduced transmit power levels. In some examples, the transmit power level adjustment that can be applied to any station is limited to a reduction that enables the station to perform at its MCS while having minimum interference to the other stations, as described above with reference to the first technique. The processor 1430 may continue to iterate through the power imbalance tolerance checks using adjusted transmit power levels of one or more stations of the particular number of stations until the particular number of stations satisfy the power imbalance tolerance check.

When the particular number of stations satisfy the power imbalance tolerance check, the processor 1430 may select the transmit power levels that resulted in the OFDMA station group passing the power imbalance tolerance checks as power levels on which to base power control information of the trigger frame.

The second technique may further include generating an OFDMA trigger frame 1485 for transmission to each station of the OFDMA station group. The OFDMA trigger frame 1485 may include power control information 1484 and/or RU allocation information 1486 for each station of the OFDMA station group. The power control information 1484 may include information instructing the stations of the OFDMA station group to employ particular transmit power levels corresponding to power levels selected during the power imbalance tolerance check stage.

In some examples, the second technique includes dividing the set of candidate stations 1420 into multiple groups, and performing the second technique on stations from one of the multiple groups. In some examples, the set of candidate stations 1420 is divided into a first group having high path loss and/or little data buffered for uplink transmission and a second group having low path loss and/or large amounts of data buffered for uplink transmission. For example, the second technique divides the set of candidate stations into a first group including stations 1403, 1404, 1405, and 1406, and a second group including stations 1407, 1408, 1409, 1410, 1411, 1412, and N. In this example, the second technique allocates the RUs only to stations of one of the groups. Allocating the RUs to stations of one of the groups may reduce the chance of power imbalance.

The system 1400 of FIG. 14 may thus enable grouping stations for an uplink OFDMA transmission opportunity (TXOP) in a manner that achieves uplink power boosting while respecting power imbalance constraints at an access point and payload requirements of the individual stations. For example, the system 1400 of FIG. 14 allocates a small RU to a station to cultivate power boost gain, but not an RU that is so small that the station's payload is underserved. As another example, the stations included in the group are selected such that the RSSI of the stations at the access point after power boost are within a receive power imbalance tolerance capability of another access point. In some examples, the stations for the group can be chosen such that the transmit time required for the stations to transmit their payloads is similar, so that any uplink padding does not detract from rate gains provided by uplink power boosting. In a particular aspect, the transmit time required for a station to transmit its payload on an allocated RU corresponds to a physical layer convergence protocol (PLCP) protocol data unit (PPDU) length for that station.

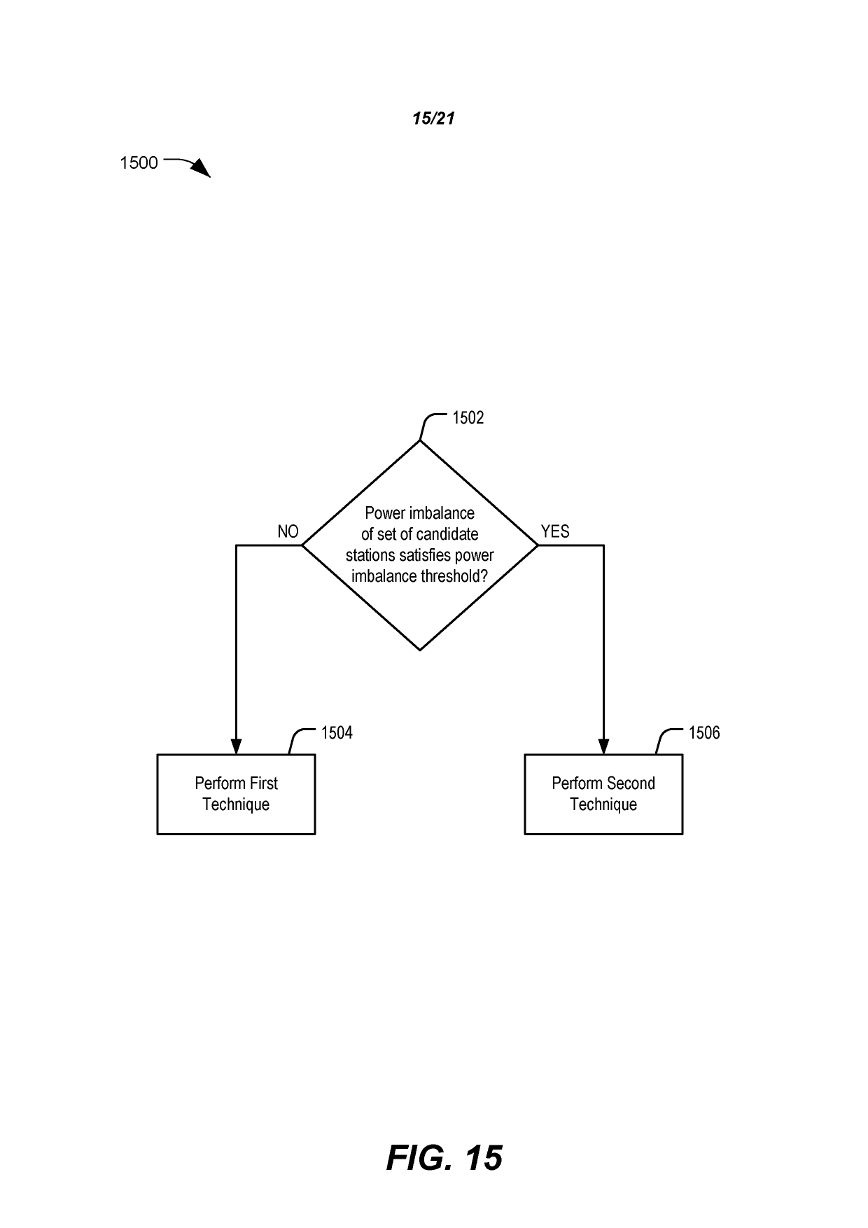

Referring to FIG. 15, a flowchart of a particular example of a method 1500 of grouping stations into an OFDMA station group is shown. The method 1500 may be performed by an access point, such as the access point 1402 of FIG. 14. The method 1500 may include determining, at 1502, whether a power imbalance of a set of candidate stations satisfies a power imbalance threshold. The set of candidate stations may correspond to the set of candidate stations 1420 of FIG. 14. The power imbalance of the set of candidate stations may be determined based on a receive power of each station of the set of candidate stations 1420 as described above with reference to FIG. 14. The power imbalance threshold may be indicative of an amount of received power imbalance (of transmissions from stations of an OFDMA station group) that the access point can tolerate (an amount of received power imbalance below which the access point 1402 is able to reliably process the transmissions from the stations of the OFDMA station group) as described above with reference to the power imbalance threshold 1453 of FIG. 14.

The method 1500 may further include performing a first technique 1504 when the power imbalance of the set of candidate stations does not satisfy the power imbalance threshold or may further include performing a second technique 1506 when the power imbalance of the set of candidate stations satisfies the power imbalance threshold. The first technique 1504 may select stations to group into the OFDMA station group based on a power imbalance as described above with reference to the first technique of FIG. 14, and the second technique 1506 may not consider power imbalance while selecting stations.

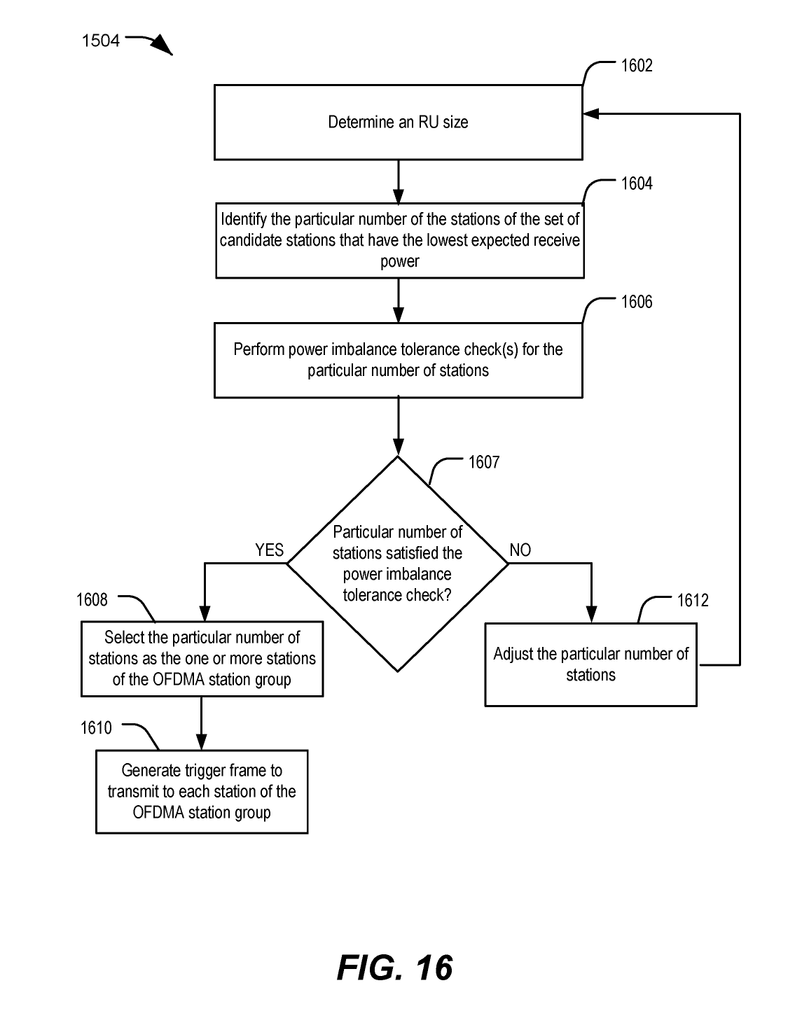

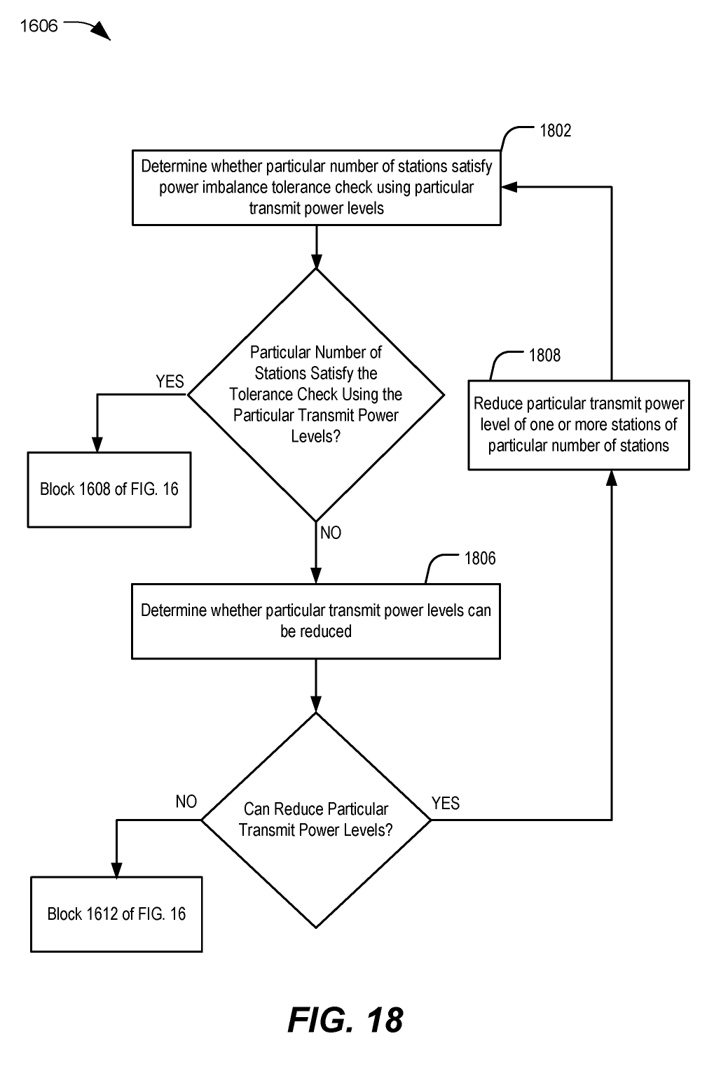

Referring to FIG. 16, a flowchart of a particular example of performing the first technique 1504 is shown. Each iteration through the first technique 1504 in FIG. 16 may employ a different particular number corresponding to a group size being considered during the iteration. For example, the particular number for a first iteration of the first technique corresponds to a largest number of RUs that a particular wireless networking protocol can accommodate using a channel having a particular bandwidth. For example, when the access point uses the 802.11ax wireless networking protocol and a 20 MHz channel, the particular number (e.g., a first number) for a first iteration through the first technique corresponds to nine, as described above with reference to FIG. 14. Alternatively, when the access point uses the 802.11ax wireless networking protocol and a 40 MHz channel, the first number may correspond to eighteen, and when the access point uses the 802.11ax wireless network and an 80 MHz channel, the first number may correspond to 37. The RU size for each station of the set of candidate stations may be determined for a particular iteration of the first technique as described in more detail below with reference to FIG. 18.

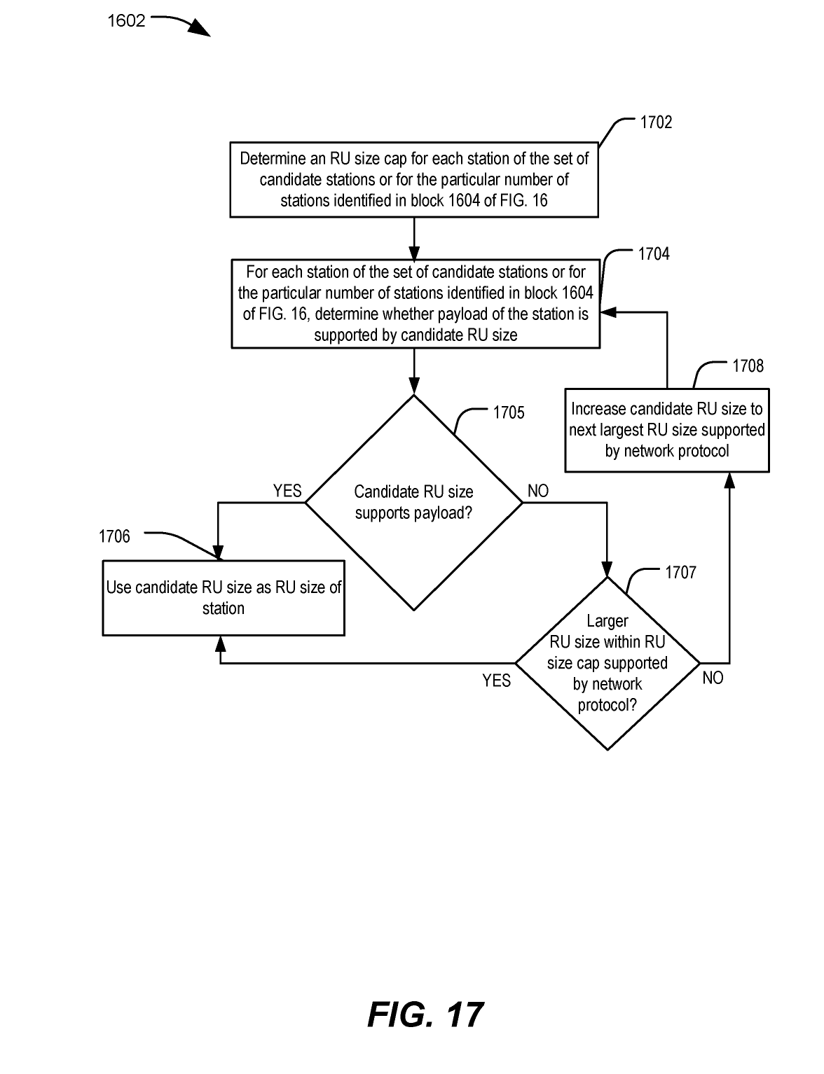

The first technique 1504 may include determining, at 1602, an RU size for each station of a set of candidate stations or for a particular number of stations being considered during an iteration through the stages of FIG. 16. Determining an RU size is described in more detail below with reference to FIG. 17.

The first technique 1504 may further include selecting or identifying, at 1604, the particular number of stations having a lowest expected receive power. For example, during a first iteration of the first technique using the 802.11ax wireless networking protocol, the particular number corresponds to the first number of nine, eighteen, or thirty seven depending on the channel bandwidth as described above, and 1604 may include selecting the first number of stations as described above with reference to FIG. 14. In alternative examples, the first technique 1504 includes performing 1604 before 1602 in order to identify the particular number of stations.

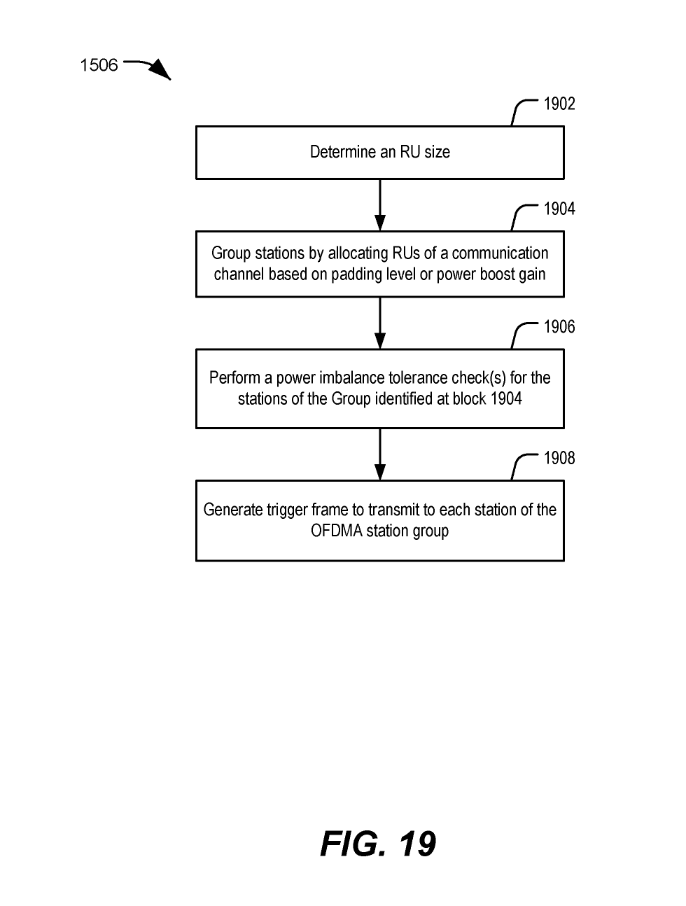

The first technique 1504 may further include performing, at 1606, one or more power imbalance tolerance checks on the particular number of stations. The one or more power imbalance tolerance checks may be performed using different transmit power levels until the particular number of stations satisfy the power imbalance tolerance check or until the power levels cannot be additionally adjusted as described in more detail below with reference to FIG. 19.

The first technique 1504 may include determining if the particular number of stations satisfied the power imbalance tolerance check, at 1607. When the particular number of stations satisfied the power imbalance tolerance check, the first technique 1504 may further include selecting the particular number of stations as the one or more stations of the OFDMA station group, at 1608, and generating a trigger frame to transmit to each station of the OFDM station group, at 1610. For example, the OFDMA trigger frame is generated for transmission to the stations of the OFDMA station group as described above with reference to the OFDMA trigger frame 1485 of FIG. 14.

Alternatively or additionally, the first technique 1504 may include, when the particular number of stations did not satisfy the power imbalance tolerance check and the transmit power levels cannot be further reduced, adjusting (e.g., decrementing) the particular number of stations, at 1612, and returning to 1602 to perform a subsequent iteration of the first technique 1504.

In a particular aspect, the first technique 1504 includes, when the particular number of stations did not satisfy the power imbalance check and the transmit power levels cannot be further reduced, iteratively replacing a station of the particular number of stations with another station, adjusting (e.g., reducing) a MCS level of one of the particular number of stations, or both. The first technique 1504 includes performing the power imbalance tolerance check subsequent to replacing the station, adjusting the MCS level, or both. In this aspect, the first technique 1504 includes adjusting (e.g., decrementing) the particular number of stations, at 1612, when the particular number of stations did not satisfy the power imbalance tolerance check, transmit power levels cannot be further reduced, additional stations are not available for replacement, MCS levels cannot be further reduced, or a combination thereof. Referring to FIG. 17, a flowchart of a particular example of a method of determining an RU size, such as in 1602 of FIG. 16 is shown. The method of FIG. 17 may include determining, at 1702, a RU size cap for each station of the set of candidate stations 1420 or for the particular number of stations identified in 1604 of FIG. 16.

The RU size cap may be determined for an iteration through the stages of the first technique 1504 based on the frequency channel and the particular number (corresponding to the prospective group size) for the iteration. For example, the RU size cap corresponds to a bandwidth determined by dividing a bandwidth of the frequency channel used by the access point 1402 by the particular number (e.g., the first number, the second number, etc.) for the iteration.

To illustrate, the particular number for a first iteration through the stages of the first technique 1504 using a 20 MHz channel and an IEEE 802.11ax wireless networking protocol may correspond to nine as described above (e.g., the first number may correspond to nine), and the RU size cap may correspond to 20 MHz divided by nine (e.g., 20 MHz/9=2.222 MHz). During a second iteration through stages of the first technique 1504 using a 20 MHz channel and an IEEE 802.11ax wireless networking protocol, the second number may correspond to 8 as described above, and the RU size cap may correspond to 20 MHz divided by eight (e.g., 20 MHz/8=2.5 MHz).

Alternatively or additionally, the RU size cap for a station of the particular number of stations identified at 1604 of FIG. 16 may be proportional to the payload of the station as compared to the sum of the payloads of the other stations of the particular number of stations. To illustrate, the particular number of stations may correspond to the first number of stations 1421, and the RU size cap for a station of the first number of stations 1421 may correspond to the payload of the station divided by the sum of the payloads of the other stations of the first number of stations 1421. For example, the RU size cap for the station 1403 corresponds to the bandwidth of the frequency channel times the ratio of the payload 1474 to the sum of the payloads 1475, 1476, 1477, 1478, 1479, 1480, 1481, and 1482.

The method of FIG. 17 may further include determining, at 1704, for each station of the set of candidate stations 1420 or for each station of the particular number of stations whether a candidate RU size supports the payload for the station as described above with reference to the RU size determination stage of the first technique (described with reference to FIG. 14). During a first iteration through the method of FIG. 17, the candidate RU size may correspond to the smallest RU size that the wireless networking protocol can support. To illustrate, in the 802.11ax wireless networking protocol, during a first iteration through the method 1602 of FIG. 17, the candidate RU size may correspond to the smallest RU size that can be accommodated by the 802.11ax wireless networking protocol. For example, as explained above, the smallest RU size that can be accommodated according to the 802.11ax wireless networking protocol corresponds to an RU size of 26 frequency subcarriers. Thus, during a first iteration through the method of FIG. 17, the method may include determining, for each station of the set of candidate stations 1420 or for each station of the particular number of stations, whether an RU size of 26 can support the payload of the station. When the RU size of 26 can support the payload for the station, the RU size for the payload is determined to be 26.

When the candidate RU size supports the payload for the station, the method of FIG. 17 further includes selecting, at 1706, the candidate RU size as the RU size of the station. As an example using the 802.11ax wireless networking protocol, during a first iteration through the method of FIG. 17, the method includes determining that the payload for a station is supported by the smallest RU size of 26, so the RU size of 26 is selected for the station.

When the candidate RU size does not support the payload for the station, the method of FIG. 17 includes determining, at 1707, whether a larger RU size supported by the wireless networking protocol fits within the RU size cap. When a next largest RU size that can be used according to the wireless networking protocol is within the RU size cap, the method of FIG. 17 further includes increasing, at 1708, the candidate RU size to a next largest RU size that can be supported by the wireless networking protocol. The method then returns to 1704. For example, during an iteration using an RU size cap of 5 MHz, the next largest available RU size that the 802.11ax wireless networking protocol can accommodate is 52, which fits within the RU size cap of 5 MHz. Therefore, the method 1602 of FIG. 17 would evaluate whether the RU size of 52 would support the payload of the station by iterating through the steps of FIG. 17 using an RU size of 52.

When the candidate RU size can support the payload for the station, or when the candidate RU size cannot support the payload for the station and a next largest RU size that can be used according to the wireless networking protocol is not within the RU size cap, the method of FIG. 17 includes selecting the candidate RU size as the RU size of the station, at 1706.

Referring to FIG. 18, a flowchart of a particular example of a method of performing power imbalance tolerance check(s), for example at 1606 of FIG. 16 for the particular number of stations identified at 1604 of FIG. 16 is shown. The method of FIG. 18 may generally perform the power imbalance tolerance check(s) using different transmit power levels until the particular number of stations satisfy the power tolerance check or until the transmit power levels can no longer be reduced.

The method of FIG. 18 may include determining, at 1802, whether the particular number of stations satisfy a power imbalance tolerance check using particular transmit power levels. For example, the power imbalance tolerance check is performed according to Equation 2 above. For example, the particular number of stations corresponds to the first number of stations 1421. In this example, a first iteration through the steps of the method of FIG. 18 includes determining whether the first number of stations 1421 satisfy the inequality of Equation 2 using first transmit power levels.

When the particular number of stations satisfy the power imbalance tolerance check using the particular transmit power levels, the method of FIG. 18 may proceed to 1608 of FIG. 16. When the particular number of stations do not satisfy the power imbalance tolerance check using the particular transmit power levels, the method of FIG. 18 may include determining, at 1806, whether the particular transmit power levels can be further reduced. For example, as described above, in some aspects the transmit power levels are not reduced beyond transmit power levels that enable the station to perform at its MCS while having minimum interference to the other stations.

When the transmit power levels cannot be further reduced, the method 1606 of FIG. 18 proceeds to 1612 of FIG. 16. When the power levels can be further reduced, the transmit power levels of one or more stations of the particular number of stations are reduced, at 1808, and a subsequent iteration of the method of FIG. 18 is performed using the reduced transmit power level(s).

Referring to FIG. 19, a flowchart of a particular example of a method of performing the second technique 1506. The second technique 1506 of FIG. 19 may be performed by an access point, such as the access point 1402 of FIG. 14. The second technique 1506 may include determining, at 1902, an RU size for each station of the set of candidate stations. For example, the RU size for each station is determined as described above with reference to the second technique of FIG. 14.

The second technique 1506 may further include grouping, at 1904, stations of the set of candidate stations into an OFDMA station group by allocating RUs of a communication channel based on padding level of the stations or based on a power boost gain of the stations. For example, in some aspects, the access point 1402 allocates RUs to stations that have the least padding. Alternatively or additionally, in some aspects, the access point 1402 allocates RUs to stations that have the highest power boost gain.

The second technique 1506 may further include performing, at 1906, one or more power imbalance tolerance checks on the OFDMA station group (identified at 1904) according to Equation 2. For example, the power imbalance checks are performed by determining whether the inequality of Equation 2 holds. The power imbalance tolerance checks may be performed (e.g., according to Equation 2) on the OFDMA station group identified at 1904 using different transmit power levels until the OFDMA station group identified at 1904 satisfies the power imbalance tolerance check.

For example, when the OFDMA station group does not satisfy the power imbalance tolerance check using first particular transmit power levels, the transmit power levels are reduced and a subsequent power imbalance tolerance check is performed on the OFDMA station group using the reduced transmit power levels. In some examples, the transmit power level adjustment that can be applied to any station is limited to a reduction that enables the station to perform at its MCS while having minimum interference to the other stations, as described above. The processor 1430 may continue to iterate through the power imbalance tolerance checks using adjusted transmit power levels of one or more stations of the particular number of stations until the particular number of stations satisfy the power imbalance tolerance check.

When the particular number of stations satisfy the power imbalance tolerance check, the processor 1430 may select the transmit power levels that resulted in the OFDMA station group passing the power imbalance tolerance checks as power levels on which to base power control information of the trigger frame. The second technique 1506 may further include generating, at 1908, an OFDMA trigger frame for transmission to each station of the OFDMA station group identified at 1904. The OFDMA trigger frame may correspond to the OFDMA trigger frame 1485 of FIG. 14. The OFDMA trigger frame may include power control information and/or RU allocation information for each station of the OFDMA station group, as described above with reference to the power control information 1484 and the RU allocation information 1486 of FIG. 14.

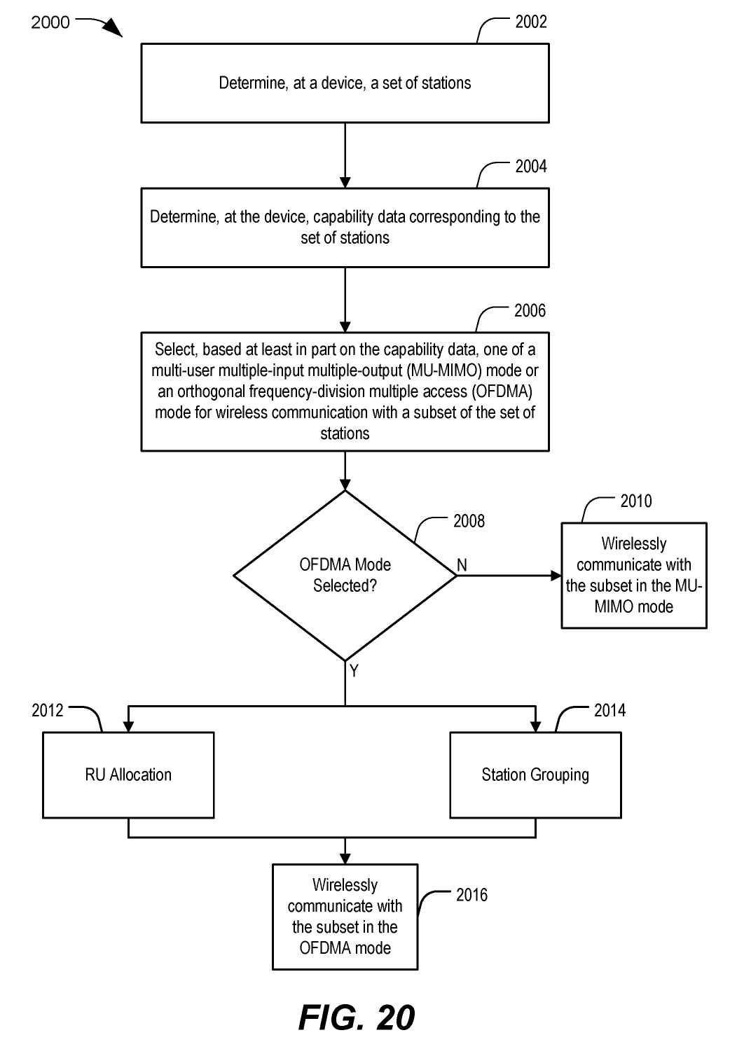

Referring to FIG. 20, a method of communication is shown and generally designated 2000. The method 2000 may be performed by an access point, such as the access point 102 of FIG. 1, the access point 702 of FIG. 7, the access point 1402 of FIG. 14, or a combination thereof.

The method 2000 includes determining, at a device, a set of stations, at 2002. For example, the mode selector 130 of FIG. 1 determines the set of scheduled stations 120, as described with reference to FIG. 1.

The method 2000 also includes determining, at the device, capability data corresponding to the set of stations, at 2004. For example, the mode selector 130 of FIG. 1 determines the capability data 150 corresponding to the set of scheduled stations 120, as described with reference to FIG. 1.

The method 2000 further includes selecting, based at least in part on the capability data, one of a multi-user multiple-input multiple-output (MU-MIMO) mode or an orthogonal frequency-division multiple access (OFDMA) mode for wireless communication with a subset of the set of stations, at 2006. For example, the mode selector 130 of FIG. 1 selects, based at least in part on the capability data 150, one of the MU-MIMO mode 162 or the OFDMA mode 160 as the selected mode 170 for wireless communication with the subset 123 of the set of scheduled stations 120, as described with reference to FIG. 1.

The method 2000 includes, in response to determining that the OFDMA mode is not selected, at 2008, wirelessly communicate with the subset in the MU-MIMO mode, at 2010. For example, the transceiver 134 of FIG. 1 exchanges at least one of the first data 154 or the second data 174 with the subset 123 in the MU-MIMO mode 162, as described with reference to FIG. 1.

The method 2000 includes, in response to determining that the OFDMA mode is selected, at 2008, performing RU allocation, at 2012. For example, the resource allocator 730 allocates RUs to stations, as described with reference to FIGS. 7-13, in response to determining that the OFDMA mode 160 is selected. The stations may correspond to the subset 123. The method 2000 proceeds to 2016.

The method 2000 includes, in response to determining that the OFDMA mode is selected, at 2008, performing station grouping, at 2014. For example, the station grouper 1431 groups stations, as described with reference to FIGS. 14-19, in response to determining that the OFDMA mode 160 is selected. In a particular aspect, the candidate stations 1420 of FIG. 14 correspond to the set of scheduled stations 120, the subset 123, the CG 124 of FIG. 1, or a combination thereof.

The method 2000 also includes wirelessly communicating with the subset in the OFDMA mode, at 2016. For example, the transceiver 134 of FIG. 1 exchanges at least one of the first data 154 or the second data 174 with the subset 123 in the OFDMA mode 160, as described with reference to FIG. 1.

The method 2000 thus enables selection of one of the MU-MIMO mode 162 or the OFDMA mode 160 as the selected mode 170 based on the capability data 150. The method 2000 may enable use of a communication mode (e.g., the selected mode 170) that is supported by stations of the subset 123 and that is suited for exchanging data buffered for communication with at least one of the stations of the subset 123. The method 2000 may enable resource allocation when the OFDMA mode 160 is selected. The method 2000 may enable station grouping when the OFDMA mode 160 is selected.

Various processes described herein, such as the processes shown in the methods of FIGS. 3-6, 10-13, and 15-20, may be controlled by a processing unit such as a central processing unit (CPU), a controller, a field-programmable gate array (FPGA) device, an application-specific integrated circuit (ASIC), another hardware device, firmware device, or any combination thereof. As an example, the method 1500 of FIG. 15, the method 1900 of FIG. 19, or a combination thereof, can be performed by one or more processors that execute instructions to determine an unusable channel time. Additionally, a first portion of one of the methods of FIGS. 3-6, 10-13, and 15-20 may be combined with at least a second portion of the same or another one of the methods of FIGS. 3-6, 10-13, and 15-20. Moreover, in particular aspects, steps are performed in a different order than shown in FIGS. 3-6, 10-13, and 15-20.

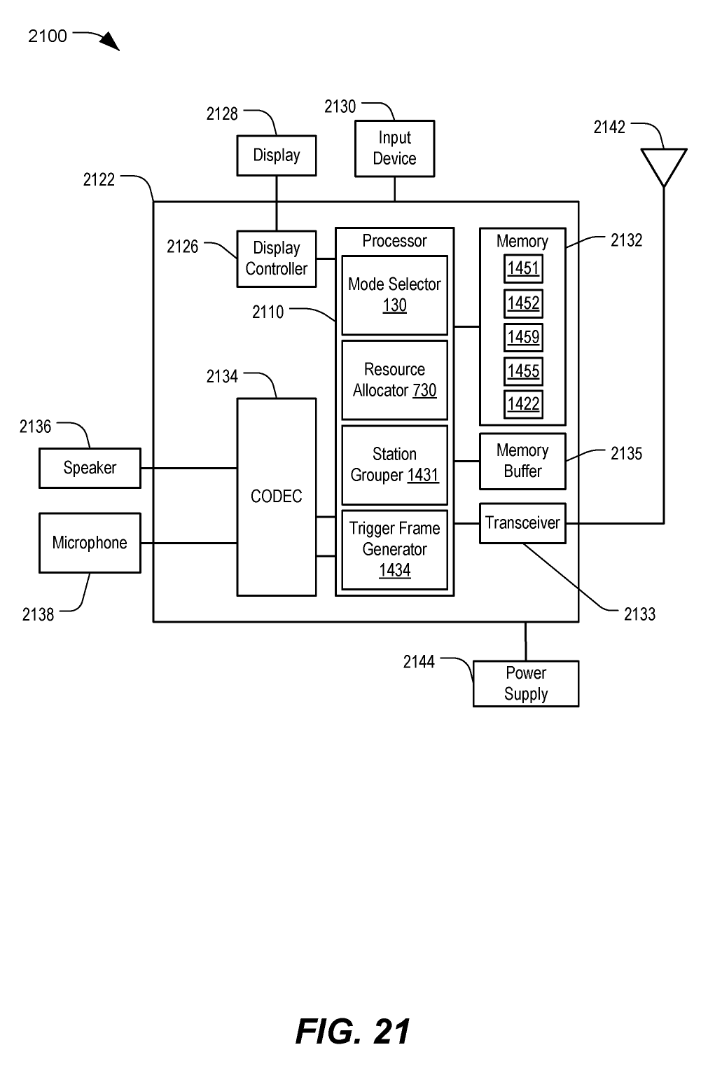

Referring to FIG. 21, a block diagram of a particular illustrative aspect of an electronic device is depicted and generally designated 2100. The device 2100 includes a processor, such as a processor 2110 (e.g., a digital signal processor (DSP)), coupled to a memory 2132, a memory buffer 2135, or both. The processor 2110 may include the mode selector 130, the resource allocator 730, the station grouper 1431, the trigger frame generator 1434, or a combination thereof. The memory 2132 may include the memory 132 of FIG. 1, the memory 732 of FIG. 7, the memory 1432 of FIG. 14, or a combination thereof. The memory buffer 2135 may include the memory buffer 136 of FIG. 1, the memory buffer 736 of FIG. 7, or both. The processor 2110 may be configured to perform one or more operations described with reference to FIGS. 1-20. For example, as described with reference to FIGS. 1-6, the mode selector 130 is configured to determine the selected mode 170. As described with reference to FIGS. 7-13, the resource allocator 730 may be configured to allocate RUs to one or more of the stations 703-705 based on the CQIs 750.

In a particular aspect, the resource allocator 730 allocates the RUs in response to determining that the mode selector 130 has designated the OFDMA mode 160 as the selected mode 170. In an alternative aspect, the resource allocator 730 allocates the RUs independently of a selection by the mode selector 130. For example, the resource allocator 730 allocates the RUs in response to determining that the OFDMA mode 160 is to be used. To illustrate, the resource allocator 730 may determine that a configuration setting, a default value, a user input, or a combination thereof, indicates that the OFDMA mode 160 is to be used.

In a particular aspect, the station grouper 1431 groups stations in response to determining that the mode selector 130 has designated the OFDMA mode 160 as the selected mode 170. In an alternative aspect, the station grouper 1431 allocates the RUs independently of a selection by the mode selector 130. For example, the station grouper 1431 groups the stations in response to determining that the OFDMA mode 160 is to be used. To illustrate, the station grouper 1431 may determine that a configuration setting, a default value, a user input, or a combination thereof, indicates that the OFDMA mode 160 is to be used.

FIG. 21 also shows a display controller 2126 that is coupled to the processor 2110 and to a display 2128. A coder/decoder (CODEC) 2134 can also be coupled to the processor 2110. A speaker 2136 and a microphone 2138 can be coupled to the CODEC 2134.

FIG. 21 also indicates that a transceiver 2133 can be coupled to the processor 2110 and to a wireless antenna 2142. The transceiver 2133 may include the transceiver 134 of FIG. 1, the transceiver 734 of FIG. 7, the transceiver 1436 of FIG. 14, or a combination thereof. In a particular aspect, the processor 2110, the display controller 2126, the memory 2132, the CODEC 2134, the memory buffer 2135, and the transceiver 2133 are included in a system-in-package or system-on-chip device 2122. In a particular aspect, an input device 2130 and a power supply 2144 are coupled to the system-on-chip device 2122. Moreover, in a particular aspect, as illustrated in FIG. 21, the display 2128, the input device 2130, the speaker 2136, the microphone 2138, the wireless antenna 2142, and the power supply 2144 are external to the system-on-chip device 2122. However, each of the display 2128, the input device 2130, the speaker 2136, the microphone 2138, the wireless antenna 2142, and the power supply 2144 can be coupled to a component of the system-on-chip device 2122, such as an interface or a controller. The device 2100 may include at least one of an access point, a station, a communication device, a navigation device, a computer, a music player, a video player, an entertainment unit, a personal digital assistant (PDA), or a set top box.

In conjunction with described implementations, an apparatus includes means for storing capability data corresponding to a set of stations. For example, the means for storing includes the memory 132, the access point 102, the system 100 of FIG. 1, the memory 2132, the device 2100, one or more devices configured to store capability data, or a combination thereof.

The apparatus also includes means for selecting one of a multi-user multiple-input multiple-output (MU-MIMO) mode or an orthogonal frequency-division multiple access (OFDMA) mode for wireless communication with a subset of the set. For example, the means for selecting includes the mode selector 130, the access point 102, the system 100 of FIG. 1, the processor 2110, the device 2100, one or more devices configured to select one of a MU-MIMO mode or an OFDMA mode, or a combination thereof. The one of the MU-MIMO mode or the OFDMA mode may be selected based at least in part on the capability data.

The apparatus further includes means for wirelessly communicating with the subset in the one of the MU-MIMO mode or the OFDMA mode. For example, the means for exchanging includes the transceiver 134, the access point 102, the system 100 of FIG. 1, the processor 2110, the transceiver 2133, the wireless antenna 2142, the device 2100, one or more devices configured to wirelessly communicate, or a combination thereof.

Also in conjunction with described implementations, an apparatus includes means for storing channel quality indicators (CQIs) of a plurality of stations. For example, the means for storing includes the memory 732, the access point 702, the system 700 of FIG. 7, the memory 2132, the device 2100, one or more devices configured to store CQIs, or a combination thereof. The CQIs 750 may include the CQI 755 of the station 704. The CQI 755 may indicate the channel quality value 756 associated with the RU 761 and the channel quality value 757 associated with the RU 762.

The apparatus also includes means for allocating a RU of the plurality of RUs to the station based at least in part on a channel quality variation across the plurality of RUs. For example, the means for allocating includes the resource allocator 730, the access point 702, the system 700 of FIG. 7, the processor 2110, the device 2100, one or more devices configured to allocate a RU, or a combination thereof. The channel quality variation 722 may be based at least in part on the channel quality value 756 and the channel quality value 757.

Further in conjunction with the described aspects, an apparatus includes means for storing data configured to store data indicative of a power imbalance threshold based on a power imbalance tolerance of an access point and configured to store data indicative of a power imbalance of a set of candidate stations. The means for storing data may correspond to the memory 1432 of FIG. 14, the memory 2132 of FIG. 21, one or more devices configured to store the data, or a combination thereof. The power imbalance threshold may correspond to the power imbalance threshold 1453 of FIG. 14 and the data indicative of a power imbalance of a set of candidate stations may correspond to the power imbalance data 1451.

The apparatus also includes means for grouping one or more stations of the set of candidate stations into an OFDMA station group based on the power imbalance threshold and the power imbalance of the set of candidate stations. For example, the means for grouping one or more stations corresponds to the station grouper 1431, the processor 1430 of FIG. 14, the processor 2110 of FIG. 21, one or more devices configured to group one or more stations, or a combination thereof. For example, the means for grouping one or more stations is configured to perform the first technique described above or the second technique described above based on whether the power imbalance of the set of candidate stations satisfies a power imbalance threshold, as described above.

Those of skill would further appreciate that the various illustrative logical blocks, configurations, modules, circuits, and algorithm steps described in connection with the embodiments disclosed herein may be implemented as electronic hardware, computer software executed by a processing device such as a hardware processor, or combinations of both. Various illustrative components, blocks, configurations, modules, circuits, and steps have been described above generally in terms of their functionality. Whether such functionality is implemented as hardware or executable software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in a memory device, such as random access memory (RAM), magnetoresistive random access memory (MRAM), spin-torque transfer MRAM (STT-MRAM), flash memory, read-only memory (ROM), programmable read-only memory (PROM), erasable programmable read-only memory (EPROM), electrically erasable programmable read-only memory (EEPROM), registers, hard disk, a removable disk, or a compact disc read-only memory (CD-ROM). An exemplary memory device (e.g., a computer-readable storage device) is coupled to the processor such that the processor can read information from, and write information to, the memory device. In the alternative, the memory device may be integral to the processor. In a particular example, the memory device corresponds to a computer-readable storage device storing instructions that, when executed by a processor, cause the processor to perform one or more operations described with reference to FIGS. 1-21. The processor and the storage medium may reside in an application-specific integrated circuit (ASIC). The ASIC may reside in a computing device or a user terminal. In the alternative, the processor and the storage medium may reside as discrete components in a computing device or a user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store capability data corresponding to a set of stations;
a processor configured to select, based at least in part on the capability data, one of a multi-user multiple-input multiple-output (MU-MIMO) mode or an orthogonal frequency-division multiple access (OFDMA) mode for wireless communication with a subset of the set of stations; and
a transceiver configured to wirelessly communicate with the subset in the selected one of the MU-MIMO mode or the OFDMA mode.

2. The device of claim 1, further comprising a memory buffer, wherein the processor is configured to determine that a station is included in the set of stations in response to determining that the memory buffer has first data to transmit to the station, that the station has second data to transmit to the transceiver, or both.

3. The device of claim 1, wherein the processor is configured to:
determine that the capability data indicates a payload size and a modulation and coding scheme (MCS) associated with a station of the set of stations;
in response to determining that the payload size is less than a payload size threshold, that the MCS is less than a MCS threshold, or both, determine that the station is included in a OFDMA candidate group; and
in response to determining that the payload size is greater than or equal to the payload size threshold and that the MCS is greater than or equal to the MCS threshold, determine that the station is included in at least one MU-MIMO candidate group.

4. The device of claim 3, wherein the processor is further configured, in response to determining that the payload size is greater than or equal to the payload size threshold and that the MCS is greater than or equal to the MCS threshold, to determine that the capability data indicates a MU-MIMO level associated with the station, wherein each of the at least one MU-MIMO candidate group is associated with a particular MU-MIMO level that is less than or equal to the MU-MIMO level associated with the station.

5. The device of claim 1, wherein the processor is configured to determine priority stations of the set of stations based on priority data.

6. The device of claim 1, wherein the processor is further configured to:
determine a plurality of candidate groups of the set of stations based on the capability data; and
select a particular candidate group from the plurality of candidate groups based on at least one of a count of priority stations included in the particular candidate group or a MU-MIMO level associated with the particular candidate group,
wherein the subset includes at least the particular candidate group.

7. The device of claim 6, wherein the processor is configured, in response to determining that the particular candidate group is a MU-MIMO candidate group, to:
select the MU-MIMO mode; and
determine that the subset is the same as the particular candidate group.

8. The device of claim 6, wherein the processor is configured, in response to determining that the particular candidate group is a OFDMA candidate group, to:
select the OFDMA mode; and
determine that the subset includes at least the particular candidate group.

9. The device of claim 8, wherein the processor is configured, in response to determining that the particular candidate group is the OFDMA candidate group, to:
determine that the OFDMA candidate group includes a first count of stations; and
in response to determining that the transceiver is capable of exchanging traffic in the OFDMA mode with a higher count of stations than the first count, select at least one additional station of one or more MU-MIMO candidate groups of the plurality of candidate groups and include the at least one additional station in the subset.

10. The device of claim 1, wherein the transceiver is further configured to transmit a mode identifier to the subset, the mode identifier indicating the selected one of the MU-MIMO mode or the OFDMA mode.

11. The device of claim 1, wherein the processor, the memory, and the transceiver are integrated into an access point device.

12. The device of claim 1, wherein the memory is further configured to store channel quality indicators (CQIs) of the set of stations, wherein the CQIs include a CQI of a station, wherein the CQI indicates a first channel quality value associated with a first resource unit (RU) of a plurality of RUs and a second channel quality value associated with a second RU of the plurality of RUs, and wherein the processor is configured, in response to determining that the OFDMA mode is selected, to allocate a RU of the plurality of RUs to the station based at least in part on a channel quality variation across the plurality of RUs, the channel quality variation based at least in part on the first channel quality value and the second channel quality value.

13. The device of claim 12, wherein the RU corresponds to frequency subcarriers of an orthogonal frequency-division multiple access OFDMA wireless channel.

14. The device of claim 1, wherein the memory is further configured to store data indicative of a power imbalance threshold based on a power imbalance tolerance of an access point and configured to store data indicative of a power imbalance of the set of stations, and wherein the processor is further configured, in response to determining that the OFDMA mode is selected, to group the subset of the set of stations into an OFDMA station group based on data rate gains that different power spectrum density boosts provide for each station of the set of stations using different resource unit (RU) sizes, the power imbalance threshold, and the power imbalance of the set of stations.

15. A method of communication comprising:
determining, at a device, a set of stations;
determining, at the device, capability data corresponding to the set of stations;
selecting, based at least in part on the capability data, one of a multi-user multiple-input multiple-output (MU-MIMO) mode or an orthogonal frequency-division multiple access (OFDMA) mode for wireless communication with a subset of the set of stations; and
wirelessly communicating with the subset in the selected one of the MU-MIMO mode or the OFDMA mode.

16. The method of claim 15, further comprising transmitting a mode identifier to the subset prior to wirelessly communicating with the subset in the selected one of the MU-MIMO mode or the OFDMA mode, the mode identifier indicating the selected one of the MU-MIMO mode or the OFDMA mode.

17. The method of claim 15, further comprising:
receiving a mode identifier from a second device, the mode identifier indicating one of the MU-MIMO mode or the OFDMA mode; and
transmitting particular data to the second device in the one of the MU-MIMO mode or the OFDMA mode in response to receipt of the mode identifier.

18. The method of claim 15, further comprising:
receiving, at the device, channel quality indicators (CQIs) from the set of stations, the CQIs including a CQI of a station of the subset of the set of stations, wherein the CQI indicates a first channel quality value associated with a first resource unit (RU) of a plurality of RUs and a second channel quality value associated with a second RU of the plurality of RUs; and
in response to determining that the OFDMA mode is selected, allocating a RU of the plurality of RUs to the station based at least in part on a channel quality variation across the plurality of RUs, the channel quality variation based at least in part on the first channel quality value and the second channel quality value.

19. The method of claim 15, further comprising, in response to determining that the OFDMA mode is selected, grouping the subset of the set of stations into an OFDMA station group based on data rate gains that different power spectrum density boosts provide for each station of the set of stations using different resource unit (RU) sizes, a power imbalance tolerance of an access point, and a power imbalance of the set of stations.

20. A computer-readable storage device storing instructions that, when executed by a processor, cause the processor to perform operations comprising:
determining a set of stations;
determining capability data corresponding to the set of stations;
selecting, based at least in part on the capability data, one of a multi-user multiple-input multiple-output (MU-MIMO) mode or an orthogonal frequency-division multiple access (OFDMA) mode for wireless communication with a subset of the set of stations; and
wirelessly communicating with the subset in the selected one of the MU-MIMO mode or the OFDMA mode.

21. The computer-readable storage device of claim 20, wherein the operations further comprise:
determining that the capability data indicates a payload size, a modulation and coding scheme (MCS), and a MU-MIMO level associated with a station of the set of stations; and
in response to determining that the payload size is greater than or equal to a payload size threshold and that the MCS is greater than or equal to a MCS threshold, determining that the station is included in at least one MU-MIMO candidate group, wherein each of the at least one MU-MIMO candidate group is associated with a particular MU-MIMO level that is less than or equal to the MU-MIMO level.

22. The computer-readable storage device of claim 20, wherein the operations further comprise:
determining that the capability data indicates a payload size and a modulation and coding scheme (MCS) associated with a station of the set of stations; and
in response to determining that the payload size is less than a payload size threshold, that the MCS is less than a MCS threshold, or both, determining that the station is included in a OFDMA candidate group.

23. The computer-readable storage device of claim 20, wherein the operations further comprise:
determining priority stations of the set of stations based on priority data;
determining a plurality of candidate groups of the set of stations based on the capability data, wherein the plurality of candidate groups includes a OFDMA candidate group and at least one MU-MIMO candidate group; and
selecting a particular candidate group from the plurality of candidate groups based on at least one of a count of priority stations included in the particular candidate group or a MU-MIMO level associated with the particular candidate group,
wherein the subset includes at least the particular candidate group.

24. The computer-readable storage device of claim 20, wherein the operations further comprise:
receiving channel quality indicators (CQIs) from the set of stations, the CQIs including a CQI of a station of the set of stations, wherein the CQI indicates a first channel quality value associated with a first resource unit (RU) of a plurality of RUs and a second channel quality value associated with a second RU of the plurality of RUs; and
in response to determining that the OFDMA mode is selected, allocating a RU of the plurality of RUs to the station based at least in part on a channel quality variation across the plurality of RUs, the channel quality variation based at least in part on the first channel quality value and the second channel quality value.

25. The computer-readable storage device of claim 24, wherein the operations further comprise, in response to determining that the channel quality variation is greater than or equal to a variation threshold:
determining channel quality gains corresponding to allocations of one or more RUs of the plurality of RUs to the set of stations, the channel quality gains including a channel quality gain corresponding to an allocation of the RU to the station,
wherein the RU is assigned to the station in response to determining that the channel quality gain is highest among the channel quality gains.

26. The computer-readable storage device of claim 24, wherein the operations further comprise, in response to determining that the channel quality variation is less than a variation threshold:
determining payload sizes of particular data buffered for transmission to the set of stations;
determining requested RU sizes based on the payload sizes and a modulation and coding scheme (MCS) level, the requested RU sizes including a first requested RU size of the station;
selecting the station from the set of stations in response to determining that the first requested RU size is highest among the requested RU sizes; and
selecting the RU from the plurality of RUs based at least in part on determining that a channel quality value indicated by the CQI satisfies a channel quality threshold.

27. The computer-readable storage device of claim 20, wherein the operations further comprise, in response to determining that the OFDMA mode is selected, grouping the subset of the set of stations into an OFDMA station group based on data rate gains that different power spectrum density boosts provide for each station of the set of stations using different resource unit (RU) sizes, a power imbalance tolerance of an access point, and a power imbalance of the set of stations.

28. The computer-readable storage device of claim 27, wherein the subset of the set of stations are grouped into the OFDMA station group using a first technique or a second technique based on whether the power imbalance of the set of stations satisfies a power imbalance threshold.

29. An apparatus comprising:
means for storing capability data corresponding to a set of stations;
means for selecting one of a multi-user multiple-input multiple-output (MU-MIMO) mode or an orthogonal frequency-division multiple access (OFDMA) mode for wireless communication with a subset of the set of stations, the one of the MU-MIMO mode or the OFDMA mode selected based at least in part on the capability data; and
means for wirelessly communicating with the subset in the one of the MU-MIMO mode or the OFDMA mode.

30. The apparatus of claim 29, wherein the means for storing, the means for selecting, and the means for wirelessly communicating are integrated into at least one of an access point, a communication device, a navigation device, a computer, a music player, a video player, an entertainment unit, a personal digital assistant (PDA), or a set top box.
